(19) United States
(12) Patent Application Publication
(10) Pub. No.: US 2015/0213411 A1
(43) Pub. Date: Jul. 30, 2015

(54) Collaborative Meeting Planning

(71) Applicant: T Minus 5 LLC, Wisconsin Rapids, WI (US)

(72) Inventors: Mark R. Swanson, Wisconsin Rapids, WI (US); William L. Moss, Jr., Boerne, TX (US)

(73) Assignee: T MINUS 5 LLC, Wisconsin Rapids, WI (US)

(21) Appl. No.: 14/605,800

(22) Filed: Jan. 26, 2015

Related U.S. Application Data
(60) Provisional application No. 61/931,089, filed on Jan. 24, 2014.

(51) Int. Cl. G06Q 10/10

(52) U.S. Cl. CPC G06Q 10/103

(57) ABSTRACT

A method including: providing a workspace user interface to one or more users for the meeting; receiving from the one or more users a first input though the workspace user interface to create a plurality of topic items in the two or more lists; displaying on the workspace user interface the plurality of topic items in each of the two or more lists simultaneously; receiving from the one or more users a second input through the workspace user interface to move a first selected topic item of the plurality of topic items from a first list of the two or more lists to a second list of the two or more lists; updating at least one of the two or more lists based on the second input; and displaying on the workspace user interface the two or more lists simultaneously as updated based on the second input. Other embodiments are provided.

### CROSS-REFERENCE TO RELATED APPLICATIONS

This application claims the benefit of U.S. Provisional Application No. 61/931,089, filed Jan. 24, 2014. U.S. Provisional Application No. 61/931,089 is incorporated herein by reference in its entirety.

### TECHNICAL FIELD

This disclosure relates generally to automated meeting systems, and relates more particularly to systems for facilitating efficient workflow planning, collaboration, execution, recording, and analysis.

### BACKGROUND

Many individuals, especially in business environments, plan and participate in meetings. Meetings often are used to deliver information, formulate ideas, discuss issues, assign tasks, track progress, make decisions, and so forth. Meetings can be expensive, based on the value of each participant's time, yet meetings remain a largely unmonitored process with few controls to manage cost. Although various applications are available for planning or participating in meetings, many of these applications are limited in their functionality and focus on limited aspects of planning, conducting, or participating in a meeting, such as scheduling, telepresence, or agenda management. Such applications can require a user to inefficiently switch between multiple applications when planning, conducting, or participating in a meeting.

Moreover, various applications provide cumbersome user interfaces for planning, preparing, conducting, or following up after a meeting. These user interfaces generally do not organize information, or allow manipulation of information, in natural and useful ways. Further, these applications generally include a significant number of data fields that require data entry in order to be operational, rather than allowing for operation with minimal data entry and the option of entering additional data if desired. For example, reordering agenda items or changing rights and/or functionality to an agenda item can be complex and disruptive tasks. Consequently, use of these applications routinely interferes with and delays the planning, preparing, and/or flow of meetings as well as the follow up and continuing discussion before and after meetings. Ultimately, individuals often resist using and adopting such complex, unintuitive, and disruptive applications.

Additionally, although a topic of discussion in a meeting will often naturally recur in one or more later meetings, existing applications do not facilitate management of discussion topics in comprehensive, useful, and efficient ways. For example, information related to topics discussed in prior meetings often is spread across multiple software applications or multiple tools within a software application, or is accessible in a repository that is not readily accessible when planning a follow-up meeting. As a result, the context of earlier discussions on the topic is often unavailable when planning or participating in the later meetings, or is available only through cumbersome, time-consuming, and disruptive methods.

Furthermore, various applications fail to record useful information regarding the planning and execution of meetings. Alternatively, various other applications provide for the creation of such records largely through manual data entry methods, but such methods are cumbersome and interfere with planning, conducting, and participating in meetings. As such, these applications fail to provide a rich set of analyzable artifacts with minimal user disruption.

Accordingly, a need or potential for benefit exists for a system or method that addresses one or more of the problems or shortcomings noted above.

### BRIEF DESCRIPTION OF THE DRAWINGS

To facilitate further description of the embodiments, the following drawings are provided in which:

FIG. 1 illustrates a block diagram of a system that can be employed for meeting management, according to an embodiment;

FIG. 2 illustrates an exemplary user interface display of the meeting management application including a workspaces listing accessed through a user device of FIG. 1, according to an embodiment;

FIG. 3A illustrates an exemplary user interface display of the meeting management application including a collaborative planner with a past meeting list hidden, as accessed through the user device of FIG. 1, according to an embodiment;

FIG. 3B illustrates an exemplary user interface display of the meeting management application include the collaborative planner of FIG. 3A with a past meeting list shown, as accessed through the user device of FIG. 1, according to an embodiment;

FIG. 4 illustrates an exemplary user interface display of the meeting management application including the collaborative planner of FIG. 3A and a team listing accessed through the user device of FIG. 1, according to an embodiment;

FIG. 5 illustrates an exemplary user interface display of the meeting management application including a new topic item form accessed through the user device of FIG. 1, according to an embodiment;

FIG. 6 illustrates an exemplary user interface display of the meeting management application including moving of a topic item in the collaborative planner of FIG. 3A accessed through the user device of FIG. 1, according to an embodiment;

FIG. 7 illustrates an exemplary user interface display of the meeting management application including a topic item view accessed through the user device of FIG. 1, according to an embodiment;

FIG. 8 illustrates an exemplary user interface display of the meeting management application including an add tool selection list accessed through the user device of FIG. 1, according to an embodiment;

FIG. 9 illustrates an exemplary user interface display of the meeting management application including a presenter notes form accessed through the user device of FIG. 1, according to an embodiment;

FIG. 10 illustrates an exemplary user interface display of the meeting management application including a go round form accessed through the user device of FIG. 1, according to an embodiment;

FIG. 11 illustrates an exemplary user interface display of the meeting management application including a go round event accessed through the user device of FIG. 1, according to an embodiment;

FIG. 12 illustrates an exemplary user interface display of the meeting management application including a pulse selection list accessed through the user device of FIG. 1, according to an embodiment;

FIG. 13 illustrates an exemplary user interface display of the meeting management application including a pulse form accessed through the user device of FIG. 1, according to an embodiment;

FIG. 14A illustrates an exemplary user interface display of the meeting management application including a pulse event with a user prompted to vote, as accessed through the user device of FIG. 1, according to an embodiment;

FIG. 14B illustrates an exemplary user interface display of the meeting management application including the pulse event of FIG. 14A with user voting statistics, as accessed through the user device of FIG. 1, according to an embodiment;

FIG. 15 illustrates an exemplary user interface display of the meeting management application including the collaborative planner of FIG. 3A and an add event form accessed through the user device of FIG. 1, according to an embodiment;

FIG. 16 illustrates an exemplary user interface display of the meeting management application including the collaborative planner of FIG. 3A and an add agenda item selection list accessed through the user device of FIG. 1, according to an embodiment;

FIG. 17 illustrates an exemplary user interface display of the meeting management application including a new break item form accessed through the user device of FIG. 1, according to an embodiment;

FIG. 18A illustrates an exemplary user interface display of the meeting management application including the collaborative planner of FIG. 3A in a live meeting mode with the past meeting list of FIG. 3B hidden, as accessed through the user device of FIG. 1, according to an embodiment;

FIG. 18B illustrates an exemplary user interface display of the meeting management application including the collaborative planner of FIG. 3A in a live meeting mode with the past meeting list of FIG. 3B shown, as accessed through the user device of FIG. 1, according to an embodiment;

FIG. 19 illustrates an exemplary user interface display of the meeting management application including a topic item view in a live meeting mode, as accessed through the user device of FIG. 1, according to an embodiment;

FIG. 20 illustrates an exemplary user interface display of the meeting management application including an agenda item reuse listing, as accessed through the user device of FIG. 1, according to an embodiment;

FIG. 21 illustrates an exemplary user interface display of the meeting management application including the past meeting list of FIG. 3B, as accessed through the user device of FIG. 1, according to an embodiment;

FIG. 22 illustrates an exemplary user interface display of the meeting management application, including a navigation return bar in the live meeting mode, as accessed through the user device of FIG. 1, according to an embodiment;

FIG. 23 illustrates an exemplary user interface display of the meeting management application, including a navigation return bar in the live meeting mode during a break, as accessed through the user device of FIG. 1, according to an embodiment;

FIG. 24 illustrates an exemplary user interface display of the meeting management application including a preview of a formatted document and a content settings list, as accessed through the user device of FIG. 1, according to an embodiment;

FIG. 25 illustrates a computer that is suitable for implementing an embodiment of the user device of FIG. 1 and/or a server of the system of FIG. 1;

FIG. 26 illustrates a representative block diagram of an example of elements included in circuit boards inside a chassis of the computer of FIG. 25;

FIG. 27 illustrates a flow chart for a method of collaboratively planning a meeting, according to an embodiment;

FIG. 28 illustrates a flow chart for a method of managing a meeting, according to an embodiment;

FIG. 29 illustrates a flow chart for a method of tracking a meeting, according to an embodiment; and

FIG. 30 illustrates a block diagram of the user device of FIG. 1.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### DESCRIPTION OF EXAMPLES OF EMBODIMENTS

Various embodiments include a method for collaboratively planning a meeting. The method can include providing a workspace user interface to one or more users for the meeting. The workspace user interface can include two or more lists. The two or more lists can include a queue and an agenda list. The method also can include receiving from the one or more users a first input though the workspace user interface to create a plurality of topic items in the two or more lists. Each of the plurality of topic items can include a topic description for a meeting topic. Each of the plurality of topic items can be in at least one of the two or more lists. The method further can include displaying on the workspace user interface the plurality of topic items in each of the two or more lists simultaneously. The method additionally can include receiving from the one or more users a second input through the workspace user interface to move a first selected topic item of the plurality of topic items from a first list of the two or more lists to a second list of the two or more lists. The first list can be different from the second list. The second list can be one of the queue or the agenda list. The method also can include updating at least one of the two or more lists based on the second input. The method further can include displaying on the workspace user interface the two or more lists simultaneously as updated based on the second input.

A number of embodiments can include a system for collaboratively planning a meeting. The system can include one or more processing modules and one or more non-transitory memory storage modules storing computing instructions configured to run on the one or more processing modules and perform one or more acts. The one or more acts can include providing a workspace user interface to one or more users for the meeting. The workspace user interface can include two or more lists. The two or more lists can include a queue and an agenda list. The one or more acts also can include receiving from the one or more users a first input though the workspace user interface to create a plurality of topic items in the two or more lists. Each of the plurality of topic items can include a topic description for a meeting topic. Each of the plurality of topic items can be in at least one of the two or more lists. The one or more acts further can include displaying on the workspace user interface the plurality of topic items in each of the two or more lists simultaneously. The one or more acts additionally can include receiving from the one or more users a second input through the workspace user interface to move a first selected topic item of the plurality of topic items from a first list of the two or more lists to a second list of the two or more lists. The first list can be different from the second list. The second list can be one of the queue or the agenda list. The one or more acts also can include updating at least one of the two or more lists based on the second input. The one or more acts further can include displaying on the workspace user interface the two or more lists simultaneously as updated based on the second input.

Some embodiments can include a method for managing a meeting. The method can include providing a workspace user interface to one or more users for the meeting. The workspace user interface can include a plurality of topic items in an agenda list. The workspace user interface can include a planning mode and a meeting mode. The method also can include displaying on the workspace user interface of each of the one or more users in the planning mode the plurality of topic items in the agenda list. The method further can include receiving from the one or more users through the workspace user interface in the planning mode a first input to reorder the plurality of topic items in the agenda list. The method additionally can include displaying on the workspace user interface of each of the one or more users in the planning mode the plurality of topic items in the agenda list as reordered by the first input. The method also can include receiving from one of the one or more users a second input though the workspace user interface in the planning mode to activate the meeting mode. The method further can include displaying on the workspace user interface of each of the one or more users in the meeting mode the plurality of topic items in the agenda list with a budgeted time for each of the plurality of topic items. The method additionally can include receiving from one of the one or more users through the workplace user interface in the meeting mode successive selections of first selected topic items from among the plurality of topic items in the agenda list to activate discussion regarding the first selected topic items according to an order of the successive selections of the first selected topic items. The method also can include displaying on the workspace user interface of each of the one or more users in the meeting mode each of the first selected topic items individually in the order of the successive selections of the first selected topic items along with at least one of an amount of budgeted time remaining or actual times spent on discussions related to each of the first selected topic items.

Many embodiments can include a system for managing a meeting. The system can include one or more processing modules and one or more non-transitory memory storage modules storing computing instructions configured to run on the one or more processing modules and perform one or more acts. The one or more acts can include providing a workspace user interface to one or more users for the meeting. The workspace user interface can include a plurality of topic items in an agenda list. The workspace user interface can include a planning mode and a meeting mode. The one or more acts also can include displaying on the workspace user interface of each of the one or more users in the planning mode the plurality of topic items in the agenda list. The one or more acts further can include receiving from the one or more users through the workspace user interface in the planning mode a first input to reorder the plurality of topic items in the agenda list. The one or more acts additionally can include displaying on the workspace user interface of each of the one or more users in the planning mode the plurality of topic items in the agenda list as reordered by the first input. The one or more acts also can include receiving from one of the one or more users a second input though the workspace user interface in the planning mode to activate the meeting mode. The one or more acts further can include displaying on the workspace user interface of each of the one or more users in the meeting mode the plurality of topic items in the agenda list with a budgeted time for each of the plurality of topic items. The one or more acts additionally can include receiving from one of the one or more users through the workplace user interface in the meeting mode successive selections of first selected topic items from among the plurality of topic items in the agenda list to activate discussion regarding the first selected topic items according to an order of the successive selections of the first selected topic items. The one or more acts also can include displaying on the workspace user interface of each of the one or more users in the meeting mode each of the first selected topic items individually in the order of the successive selections of the first selected topic items along with at least one of an amount of budgeted time remaining or actual times spent on discussions related to each of the first selected topic items.

Further embodiments can include a method for tracking a meeting. The method can include providing a workspace user interface to one or more users for the meeting. The workspace user interface can include a plurality of topic items in one or more lists. The workspace user interface can include a planning mode and a meeting mode. The method also can include automatically recording first data including a join time and a leave time associated with each of the one or more users when the workspace user interface is in the meeting mode. The method further can include automatically recording second data including a topic creation time and a topic creation user of the one or more users for each of the plurality of topic items when the workspace user interface is in either the planning mode or the meeting mode. The method additionally can include automatically recording third data including an order in which the plurality of topic items were discussed when the workspace user interface is in the meeting mode. The method also can include automatically recording fourth data including a start discussion time and a discussion timer for each of the plurality of topic items that were discussed when the workspace user interface is in the meeting mode. The method further can include automatically recording fifth data including a note creation time, a note creation user of the one or more users, and a note topic item of the plurality of topic items for each of one or more notes created by the one or more users when the workspace user interface is in either the planning mode or the meeting mode and associated with the note topic item. The method additionally can include automatically recording sixth data including a meeting tool creation time, a meeting tool creation user of the one or more users, one or more meeting tool activity times, one or more meeting tool results, and a meeting tool topic item of the plurality of topic items for each of one or more meeting tools created by the one or more users and associated with the meeting tool topic item. The method also can include generating a report. The report can include at least a portion of the first, second, third, fourth, fifth, and sixth data. The method further can include providing the report to at least one of the one or more users.

Still further embodiments can include a system for tracking a meeting. The system can include one or more processing modules and one or more non-transitory memory storage modules storing computing instructions configured to run on the one or more processing modules and perform one or more acts. The one or more acts can include providing a workspace user interface to one or more users for the meeting. The workspace user interface can include a plurality of topic items in one or more lists. The workspace user interface can include a planning mode and a meeting mode. The one or more acts also can include automatically recording first data including a join time and a leave time associated with each of the one or more users when the workspace user interface is in the meeting mode. The one or more acts further can include automatically recording second data including a topic creation time and a topic creation user of the one or more users for each of the plurality of topic items when the workspace user interface is in either the planning mode or the meeting mode. The one or more acts additionally can include automatically recording third data including an order in which the plurality of topic items were discussed when the workspace user interface is in the meeting mode. The one or more acts also can include automatically recording fourth data including a start discussion time and a discussion timer for each of the plurality of topic items that were discussed when the workspace user interface is in the meeting mode. The one or more acts further can include automatically recording fifth data including a note creation time, a note creation user of the one or more users, and a note topic item of the plurality of topic items for each of one or more notes created by the one or more users when the workspace user interface is in either the planning mode or the meeting mode and associated with the note topic item. The one or more acts additionally can include automatically recording sixth data including a meeting tool creation time, a meeting tool creation user of the one or more users, one or more meeting tool activity times, one or more meeting tool results, and a meeting tool topic item of the plurality of topic items for each of one or more meeting tools created by the one or more users and associated with the meeting tool topic item. The one or more acts also can include generating a report. The report can include at least a portion of the first, second, third, fourth, fifth, and sixth data. The one or more acts further can include providing the report to at least one of the one or more users.

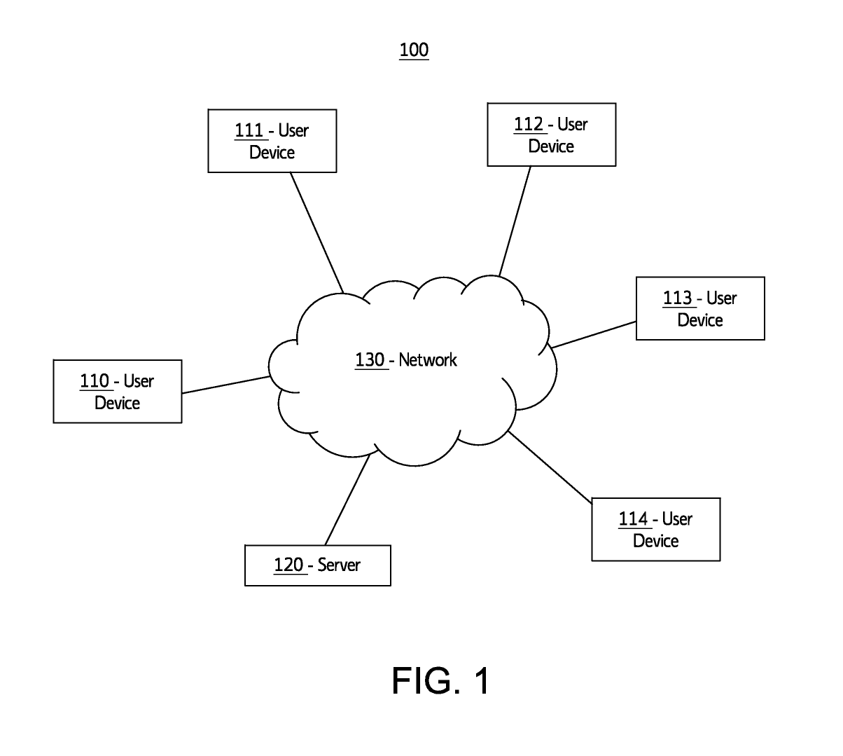

Turning to the drawings, FIG. 1 illustrates a block diagram of a system 100 that can be employed for meeting management, according to an embodiment. System 100 is merely exemplary, and embodiments of the system are not limited to the embodiments presented herein. The system can be employed in many different embodiments or examples not specifically depicted or described herein. In some embodiments, certain elements or modules of system 100 can perform various procedures, processes, and/or activities. In other embodiments, the procedures, processes, and/or activities can be performed by other suitable elements or modules of system 100. In many embodiments, system 100 can include one or more user devices (e.g., 110, 111, 112, 113, 114). User devices 110-114 can be tablet computing devices, smart phones, laptop computers, desktop computers, and/or other endpoint devices. User devices 110-114 can be used to facilitate planning, preparing, conducting, and participating in meetings, as well as following up on the results of a meeting through a meeting management application, as described below. The number of user devices (e.g., 110-114) in system 110 can vary according to the needs and resources of the users. For example, in some instances, each meeting participant can use a separate user device (e.g., 110-114) during a meeting. In other instances, two or more meeting participants can share a user device (e.g., 110-114) during a meeting.

In a number of embodiments, user devices 110-114 can be in data communication with each other through a network 130. Network 130 can be a local area network (LAN), a wireless LAN, a wide area network (WAN), a mobile telecommunications wireless data network, the Internet, another suitable network, or a combination thereof.

In various embodiments, user devices 110-114 can be in data communication through network 130 with a server 120. Server 120 can be a single computer, a single server, a cluster or collection of computer or servers, or a cloud of computer or servers. In certain embodiments, server 120 can facilitate certain communications among user devices 110-114 and can host certain application data, such as data to be shared among user devices 110-114. In other embodiments, server 120 can be included within a user device (e.g., 110-114). In yet other embodiments, system 100 does not include a server 120, and user devices 110-114 can communicate and share data as a distributed system.

In many embodiments, each of user devices 110-114 can present a user interface of a meeting management application. In certain embodiments, the meeting management application can reside on the user device (e.g., 110-114) in the form of a stand-alone application, such as a mobile application. In certain other embodiments, the meeting management application can be presented on the user device (e.g., 110-114) through a network based service, such as through a web browser. The user interface on the user device (e.g., 110-114) can be displayed on a visual display of the user device (e.g., 110-114), such as a touch screen.

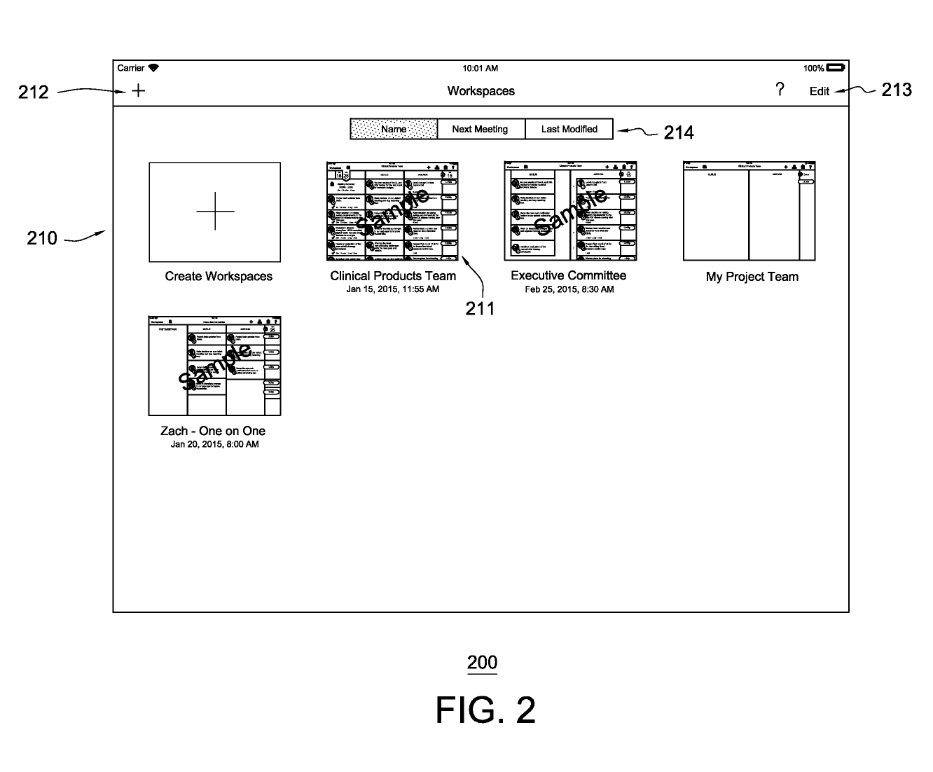

Turning ahead in the drawings, FIG. 2 illustrates an exemplary user interface display 200 of the meeting management application including a workspaces listing 210 accessed through a user device (e.g., 110-114 (FIG. 1)), according to an embodiment. User interface display 200 is merely exemplary, and embodiments of the meeting management application can be employed in many different embodiments or examples not specifically depicted or described herein. In many embodiments, the meeting management application can include workspaces as overall organizational units that can allow related topics to be categorized together. For example, a Clinical Product Team workspace can be used for discussion topics that are relevant to a company's clinical product team. Workspaces can advantageously provide a natural and logical organization for managing multiple meetings.

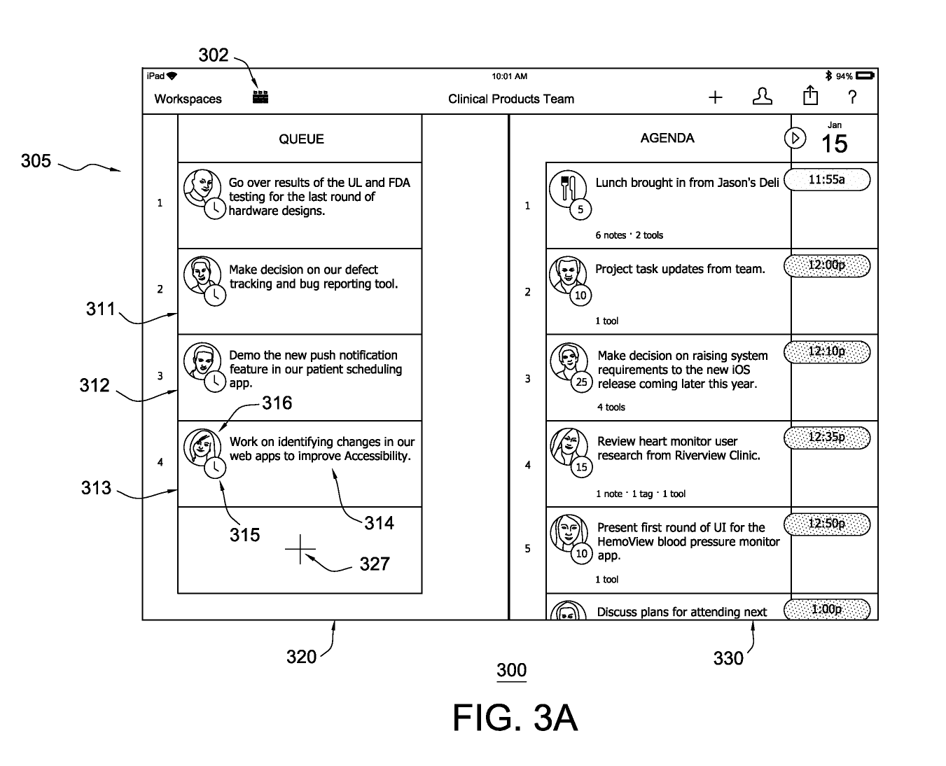

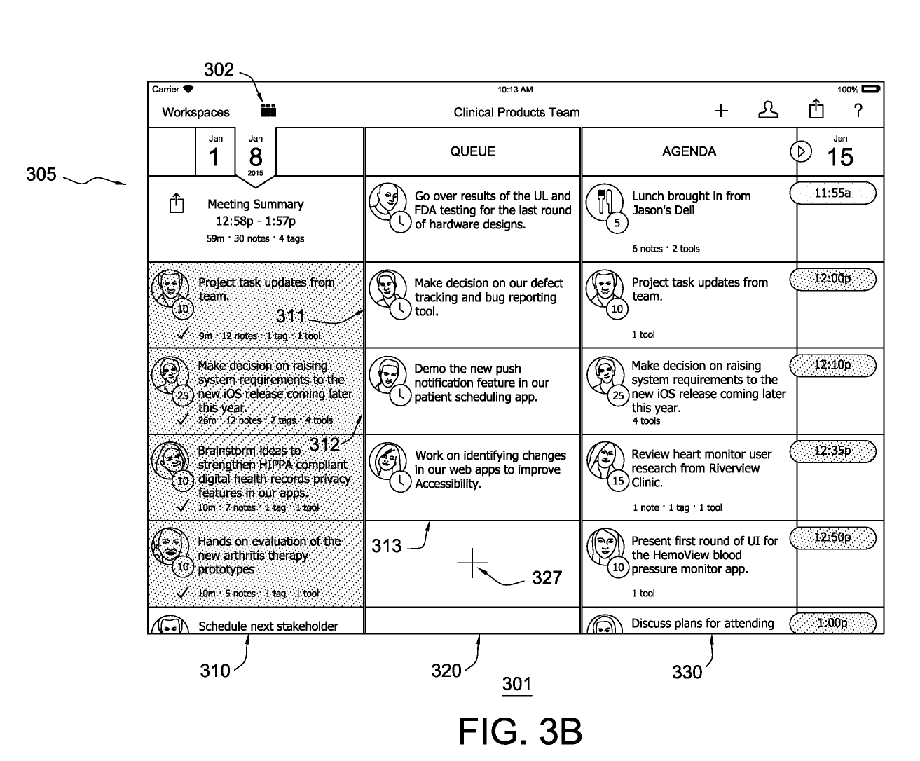

In many embodiments, workspaces listing 210 can provide a listing of the workspaces available to the user through the meeting management application. For example, as shown in FIG. 2, workspaces listing 210 can include a number of icons representing workspaces, such as icon 211, representing the Clinical Product Team workspace. As shown in FIG. 2, each icon can be a miniaturized or other suitable representation of the workspace's collaborative planner, which is shown in FIGS. 3A and 3B, and described below.

In a number of embodiments, a user can open a workspace's collaborative planner within workspaces listing 210 by selecting the icon representing the workspace desired. In several embodiments, the user can create a new workspace in workspaces listing 210 by selecting a create workspaces button 212. In several embodiments, the meeting management application can automatically designate a creator of a workspace as the workspace owner. The workspace owner can have certain access rights and/or privileges, such as the ability to add or remove users in the workspace team and/or to control the agenda, as described in greater detail below.

In various embodiments, workspace listing 210 can include an edit workspaces button 213, which can allow the user to perform various actions, such as renaming or deleting, to one or more workspaces simultaneously. In another embodiment, edit workspaces button 213 can allow the user to edit the workspaces simultaneously. As shown in FIG. 2, workspaces listing 210 can include a list option bar 214, which can allow the user to select one of various different ways of sorting the listing of the workspaces in workspaces listing 210. For example, the workspaces can be sorted in alphabetical order of the workspace name, by chronological order of the next meeting time of each workspace, by chronological order of when each workspace was last updated, or in another suitable order.

Turning ahead in the drawings, FIG. 3A illustrates an exemplary user interface display 300 of the meeting management application including a collaborative planner 305 with a past meeting list hidden, as accessed through a user device (e.g., 110-114 (FIG. 1)), according to an embodiment. FIG. 3B illustrates an exemplary user interface display 301 of the meeting management application include collaborative planner 305 with a past meeting list 310 shown, as accessed through a user device (e.g., 110-114 (FIG. 1)), according to an embodiment. User interface displays 300 and 301 are merely exemplary, and embodiments of the meeting management application can be employed in many different embodiments or examples not specifically depicted or described herein. In many embodiments, the meeting management application can include topic items as basic organizational units. For example, each topic item can represent a different item for possible discussion in a meeting. Each topic item can be defined as a set of information, such as a description, a time budget, and/or a presenter. In a number of embodiments, each workspace can include a varying number of topic items. Each topic item can be displayed in a graphical representation in a collaborative planner, such as collaborative planner 305. For example, the Clinical Product Team workspace can include several topic items, which can be represented in collaborative planner 305 as topic items 311, 312, and 313.

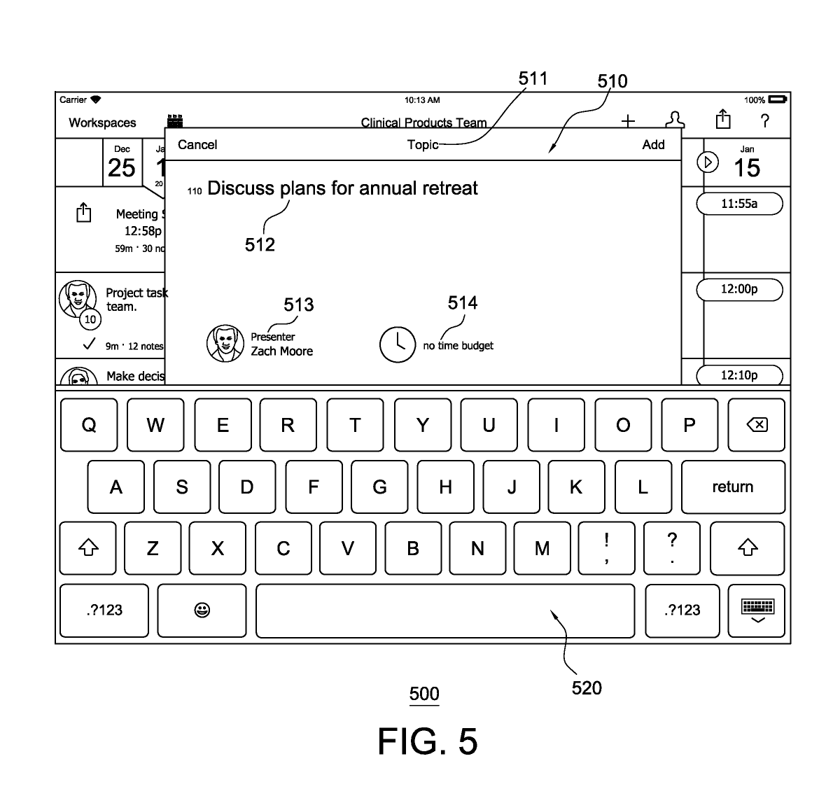

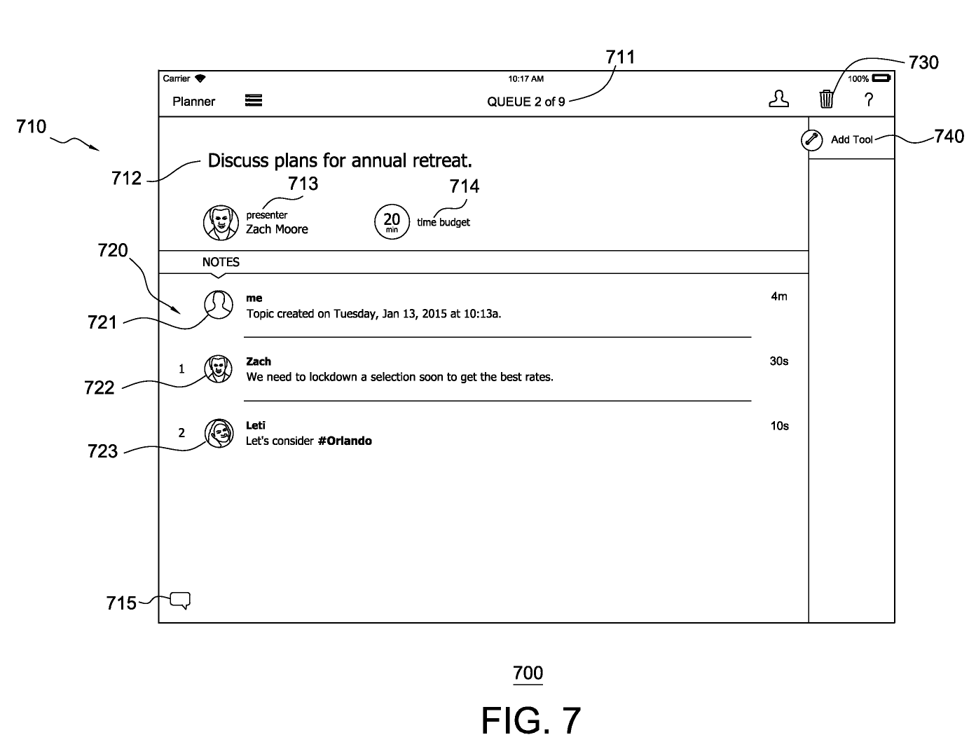

In several embodiments, collaborative planner 305 can display each topic item, such as topic item 313, with a topic description 314, a topic time budget 315, and/or a topic presenter 316, which can be defined in a topic item form, such as topic item form 510 (as shown in FIG. 5 and described below), or edited in a topic item view, such as topic item view 710 (as shown in FIG. 7 and described below). For example, if a time limit for discussion of topic item 313 has not yet been set, topic time budget 315 can display a clock. If instead a time budget of 10 minutes has been set as a projected time for discussion of the topic item, topic time budget 315 can display “10” to represent 10 minutes. In certain embodiments, topic presenter 316 can include a picture of the user who is designated to be the presenter for the topic item, as shown in topic presenter 316 in FIG. 3A.

In a number of embodiments, the topic items (e.g., 311-313) in a workspace can be organized into lists. Based on the list a topic item resides within, the meeting management application can automatically determine the rights and/or functionality of the topic item, the features available when accessing or manipulating the topic item, and the information related to the topic item that is presented in the user interface. In many embodiments, the meeting management application can include a past meeting list, a queue, and/or an agenda list. One or more of these lists can be graphically displayed in collaborative planner 305. For example, as shown in FIG. 3B, collaborative planner 305 can include past meeting list 310, a queue 320, and an agenda list 330. In various embodiments of collaborative planner 305, one or more of the lists can be hidden, which can beneficially simplify and/or add clarity to collaborative planner 305. For example, as shown in FIG. 3A, collaborative planner 305 can include queue 320 and agenda list 330, but past meeting list 310 can be hidden. In a number of embodiments, a past meeting list display button 302 can be used to toggle between displaying and hiding past meeting list 310. Each list displayed in collaborative planner 305 can include a varying number of topic items, according to the number of topic items categorized in that particular list. The meeting management application can allow topic items to be easily re-categorized into a different list, as described in greater detail below.

In various embodiments, collaborative planner 305 can facilitate rapid creation and organization of topic items (e.g., 311-313) in a manner that allows for private and/or collaborative planning for a meeting. Collaborative planner 305 can display a high-level summary view of all the topic items as they are categorized into each list (e.g., past meeting list 310, queue 320, agenda list 330). In several embodiments, each workspace can include a workspace team, which can include one or more users with access to that workspace. For example, the workspace team for the Clinical Product Team workspace can include each member of the company's clinical product team. As a member of the workspace team, each user has access to the workspace's collaborative planner (e.g., collaborative planner 305), with varying access to topic items, depending on which lists the topic items are categorized within.

In a number of embodiments, the queue, such as queue 320, can include topic items (e.g., 311-313) that are accessible by all users in the workspace team. In certain embodiments, each user in the workspace team can add new topic items to queue 320. For example, the user can create a new topic item by selecting a new queue topic item button 327. In many embodiments, the ordering of topic items in the queue (e.g., queue 320) can be unique to each user and reflect the position in which the user last ordered the topic item. In other words, all users in the workspace team can see the same topic items in the queue (e.g., queue 320), but the ordering of topic items in the queue (e.g., queue 320) can be different for each user who has accessed the collaborative planner for the workspace through the meeting management application on a user device (e.g., 110-114 (FIG. 1)). The queue (e.g., queue 320) can advantageously allow a workspace team to collaborate regarding topic items for possible inclusion on a meeting agenda. In various embodiments, the meeting management application can provide certain information regarding each user's queue (e.g., queue 320) to the workspace owner. For example, in certain embodiments meeting management application can display to the workspace owner the ordering of topic items in each user's queue (e.g., queue 320), the popularity of each topic item, and/or other relevant statistical information.

In several embodiments, the agenda list, such as agenda list 330, can include topic items (e.g., 311-313) that can be viewed by each user in workspace team. In certain embodiments, only the workspace owner can add, remove, and/or reorder topic items on agenda list 330. In certain embodiments, the workspace owner can create a new topic item or move a topic item from another list, such as queue 320, to agenda list 330, as described in greater detail below. Agenda list 330 can allow a workspace owner to plan the agenda for a meeting and allow other users in the workspace team to view the topic items included in the meeting agenda. In a number of embodiments, the workspace owner can use the collaborative planner (e.g., collaborative planner 305) to schedule a meeting and/or conduct a live meeting based on the topic items included in the agenda list (e.g., agenda list 330), as described below in greater detail.

In various embodiments, the past meeting list, such as past meeting list 310, can include topic items (e.g., 311-313) that were previously discussed in a live meeting. In certain embodiments, all users in the workspace team can view the topic items in past meeting list 310. In a number of embodiments, past meeting list 310 can beneficially provide a record of a previously held meeting, and as such, in many embodiments, the topic items in past meeting list 310 cannot be added, removed, or reordered. In various embodiments, as shown in FIG. 3B, the topic items on past meeting list 310 that were discussed in the past meeting can be grayed out, and the topic items that were not discussed (e.g., the topic items that were skipped) in the past meeting can be not grayed out. In some embodiments, topic items in past meeting list 310 can be reused, such as by copying the topic item to the agenda list (e.g., agenda list 330). For example, after a topic item from past meeting list 310 is copied to agenda list 330, the topic item on agenda list 330 can be separate from, but linked to, the topic item on past meeting list 310. Specifically, each topic item can share a common artifact stream (as described below), yet certain data (e.g., topic description, presenter, time budget, etc., as described below) in each topic item can be unique, which can beneficially preserve the historical record of the topic item in past meeting list 310 and allow modifications and additions to the topic item in agenda list 330 as discussions evolve going forward.

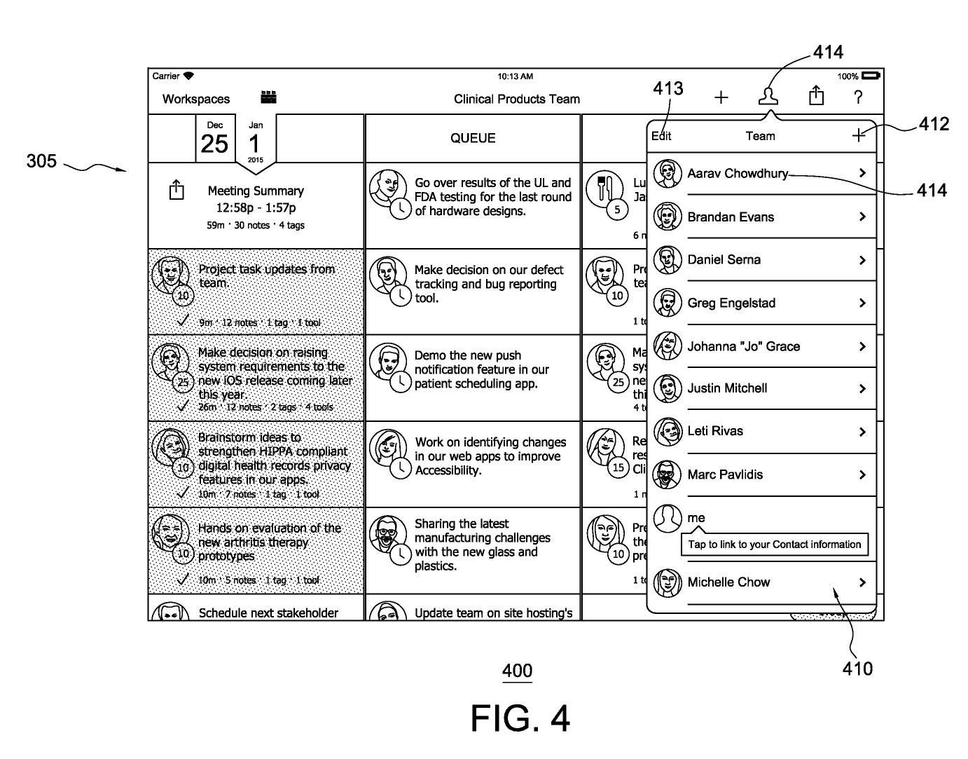

Turning ahead in the drawings, FIG. 4 illustrates an exemplary user interface display 400 of the meeting management application including collaborative planner 305 and a team listing 410 accessed through a user device (e.g., 110-114 (FIG. 1)), according to an embodiment. User interface display 400 is merely exemplary, and embodiments of the meeting management application can be employed in many different embodiments or examples not specifically depicted or described herein. In many embodiments, such as shown in FIG. 4, collaborative planner 305 can include a team button 411, which can be selected by the user to display a team listing 410 of each user (e.g., user 414) in the workspace team. In some embodiments, team listing 410 can include an add user button 412, which can allow a workspace owner to add additional users to the workspace team. In a number of embodiments, team listing 410 can include an edit team button 413, which can allow a workspace owner to remove users from the workspace team. In various embodiments, the user of the meeting management application can select a user from team listing 410, such as user 414, to view additional information about a particular user, such as job title, email address, other contact information, etc. In several embodiments, the meeting management application can integrate each user (e.g., user 414) with contact records in a separate address book application and/or the address book of the operating system of the user device (e.g., 110-114 (FIG. 1)). For example, a unique identifier can be added to the contact records, which, when selected, can allow the meeting management application to be directly launched. As another example, the meeting management application can integrate the users (e.g., user 414) with the contact records such that the edits made to the information of a particular user (e.g., user 414) in the meeting management application can be stored in the contact records, and/or the edits made to the contact records outside the meeting management application can be stored in the information of one or more of the user (e.g., user 414) in the meeting management application.

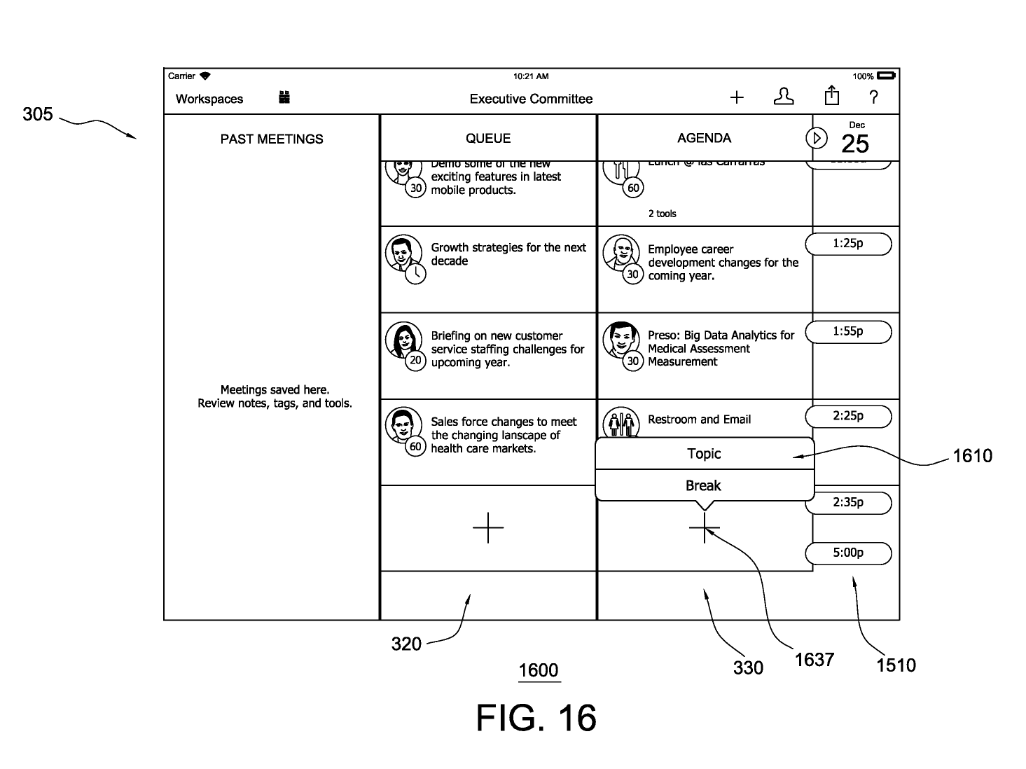

Turning ahead in the drawings, FIG. 5 illustrates an exemplary user interface display 500 of the meeting management application including a new topic item form 510 accessed through a user device (e.g., 110-114 (FIG. 1)), according to an embodiment. User interface display 500 is merely exemplary, and embodiments of the meeting management application can be employed in many different embodiments or examples not specifically depicted or described herein. In a number of embodiments, the user can create a new topic item (e.g., 311-313 (FIGS. 3A, 3B)) in the collaborative planner by selecting a button to create a new queue topic (e.g., by selecting new queue topic item button 327 (FIGS. 3A, 3B)) or a new agenda topic (e.g., selecting new agenda item button 1637, as shown in FIG. 16 and described below).

In certain embodiments, new topic item form 510 can display a heading 511, indicating whether the new topic item is for a queue topic or an agenda topic. In a number of embodiments, new topic item form 510 can include a description field 512, which can display and allow the user to input a topic description (e.g., 314) for the new topic item. For example, the user can utilize an input method, such as a virtual keyboard 520, to input a discussion topic, such as “discuss plans for annual retreat.” In many embodiments, new topic item form 510 can include a presenter selection field 513, which can display the current presenter for the topic item. In certain embodiments, the current presenter for the topic item can default to the current user who accessed new topic item form 510. In many embodiments, the user can modify the current presenter for the new topic item by selecting presenter selection field 513, which can allow the user to select a presenter from the users in the workspace team. In various embodiments, new topic item form 510 can include a topic time budget field 514, which can display, and allow selection of, a time budget. For example, in some embodiments, the user can select topic time budget field 514 to select an scheduled time for discussion from between 5 and 90 minutes in 5 minutes intervals. In other embodiments, other ranges and/or intervals can be used. The selected time budget can display in topic time budget field 514. For example, if the user selected 20 minutes, topic time budget field 514 can display “20.” In certain embodiments, if no time budget is selected, a clock can be displayed in topic time budget field 514. In many embodiments, selecting a presenter in presenter selection field 513 and selecting a time budget in topic time budget field 514 can be optional, which can allow a user to quickly create a new topic item simply by entering a description.

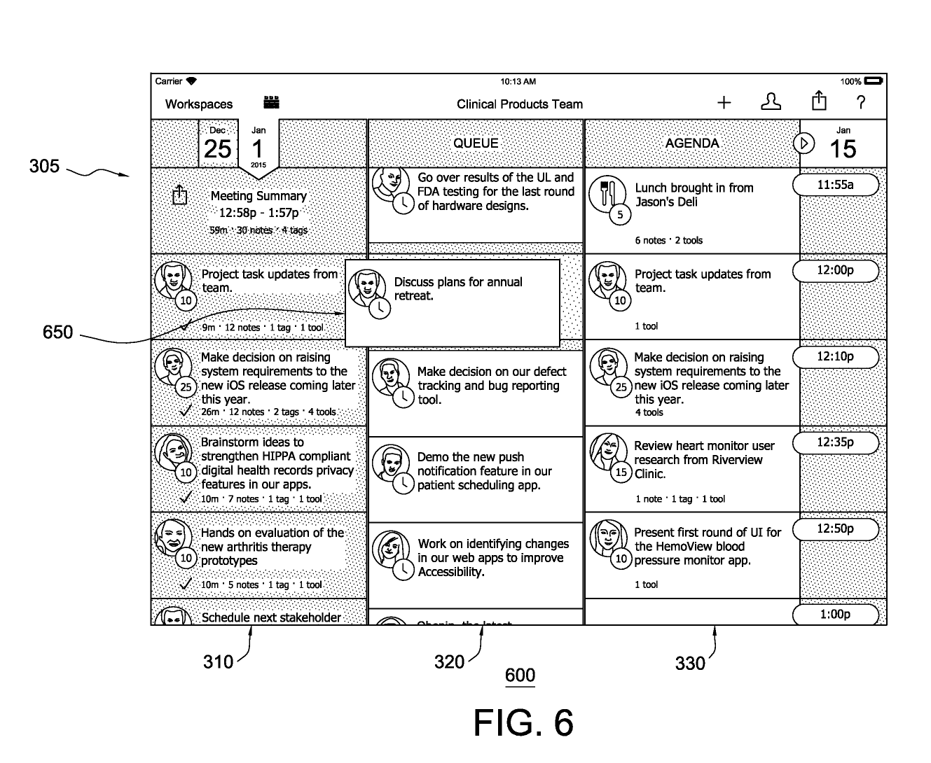

Turning ahead in the drawings, FIG. 6 illustrates an exemplary user interface display 600 of the meeting management application including moving of a topic item in collaborative planner 305 accessed through a user device (e.g., 110-114 (FIG. 1)), according to an embodiment. User interface display 600 is merely exemplary, and embodiments of the meeting management application can be employed in many different embodiments or examples not specifically depicted or described herein. In many embodiments, after a topic item (e.g., 311-313 (FIGS. 3A, 3B)) has been added to a list, the topic item can be moved to a different ordering within the same list, or to a different list. For example, after completing new topic item form 510 (FIG. 5) as described above, collaborative planner can create a new topic item, such as topic item 650, in queue 320 of collaborative planner 305. The user can readily reorder topic item 650 within queue 320 by dragging the item up or down within queue 320. The ordering of the topic items can be used such as to signify the importance or urgency of the topic item. Similarly, the user can readily move topic item 650 from queue 320 to another list, such as agenda list 330, by dragging topic item 650 to agenda list 330, as shown in FIG. 6. Upon movement of a topic item, such as topic item 650, to a new list, the meeting management application can automatically modify the rights and/or functionality of the topic item, as described above. For example, once topic item 650 has been moved from queue 320 to agenda list 330, topic item 650 can be on a meeting agenda and be used in a meeting. By automatically modifying the rights and/or functionality of the topic item based on the list in which the topic item is categorized, the meeting management application can advantageously allow the user to quickly modify rights and/or functionality to topic items without disruptive interference when planning and/or conducting a meeting. The limited number of predetermined lists (e.g., queue 320, agenda list 330, and past meeting list 310) with predefined functionality and behavior can beneficially allow for simple rights management and eliminate traditional rights management by a system administrator.

As shown in FIGS. 5-6, the meeting management application provides a very simple and straight-forward user interface, such that, in a number of embodiments, users need only understand two basic concepts: (1) creating a topic by entering a description, as shown in FIGS. 5, and (2) organizing topics by dragging them up and down and between lists, as shown in FIG. 6. Although the user interface can provide additional capability in many embodiments, advanced features can build upon, rather than interfere with, these two basic concepts of creating and manipulating topic items. The meeting management application can thus provide useful functionality with minimal data entry, and the user can provide additional data to access additional functionality. The simplicity of the user interface provided by the meeting management application can allow users to quickly learn and operate the meeting management application without disruptive interference when planning, conducting, or participating in a meeting. The user interface can advantageously facilitate rapid adoption based on its intuitive, natural, and logical organization. The user interface can beneficially allow users to use the meeting management application at a very basic level for simple tasks, but grow into the advanced features without the need to change software or discard data. The ease of use provided by the meeting management application can advantageously encourage use of the meeting management application by more meeting participants rather than just a limited number of “experts.” Use of the meeting management application by more meeting participants can advantageously result in higher quality meetings.

In many embodiments, collaborative planner 305 (FIGS. 3A, 3B) can be the primary user interface of the meeting management application during all phases of information flow for each topic, such as the creation phase, the planning phase, the meeting phase, and the review phase. By using the same primary user interface for all phases of information flow, the meeting management application can allow the user to leverage their learning of the simple interface for many aspects of information management, rather than needing to learn a new interface for each phase.

Turning ahead in the drawings, FIG. 7 illustrates an exemplary user interface display 700 of the meeting management application including a topic item view 710 accessed through a user device (e.g., 110-114 (FIG. 1)), according to an embodiment. User interface display 700 is merely exemplary, and embodiments of the meeting management application can be employed in many different embodiments or examples not specifically depicted or described herein. In several embodiments, the user can select a topic item (e.g., 311-313 (FIGS. 3A, 3B) from one of the lists (e.g., past meeting list 310 (FIG. 3B), queue 320 (FIGS. 3A, 3B), agenda list 330 (FIGS. 3A, 3B)) in collaborative planner 305 (FIGS. 3A, 3B) in order to display a topic item view, such as topic item view 710. In many embodiments, topic item view 710 can include a heading 711, which can indicate whether the topic item is for a queue topic or an agenda topic, and can indicate the ordering of the topic item within the list. For example, as shown in FIG. 7, heading 711 can indicate that the topic item is a queue topic, and that the topic item is ordered second among nine topic items. In a number of embodiments, topic item view 710 can include a description field 712, a presenter selection field 713, and/or a topic time budget field 714. Description field 712 can be identical or similar to description field 512 (FIG. 5), and can display and/or allow a user to edit the description for the topic item displayed in topic item view 710. Presenter selection field 713 can be identical or similar to presenter selection field 513 (FIG. 5), and topic time budget field 714 can be the same or similar to topic time budget field 514 (FIG. 5), and can display, and allow the user to edit, the presenter and topic, respectively.

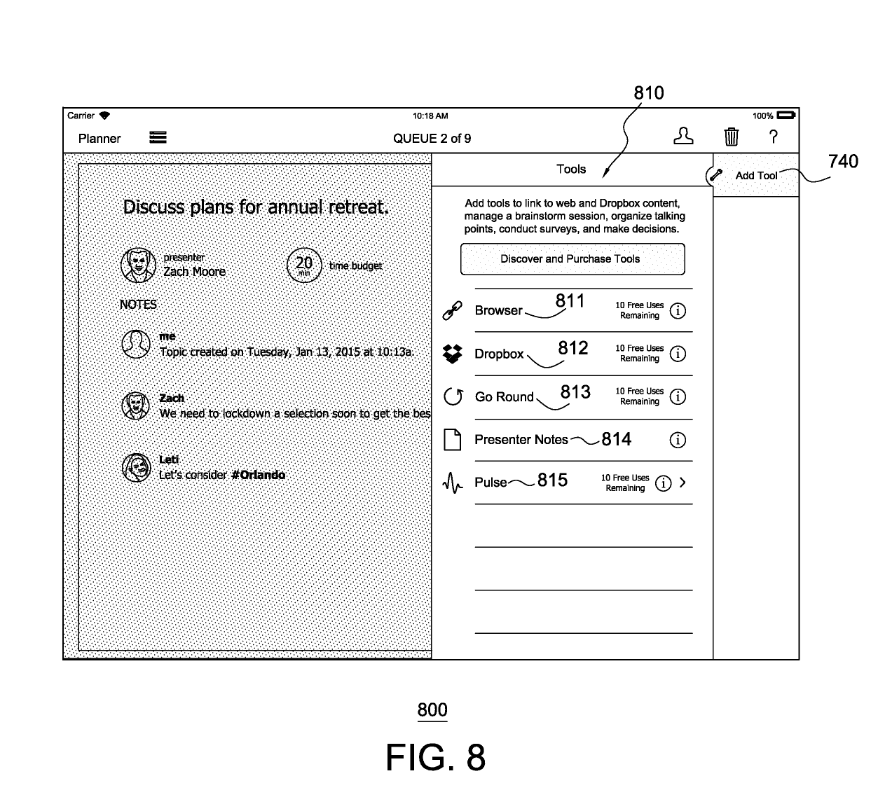

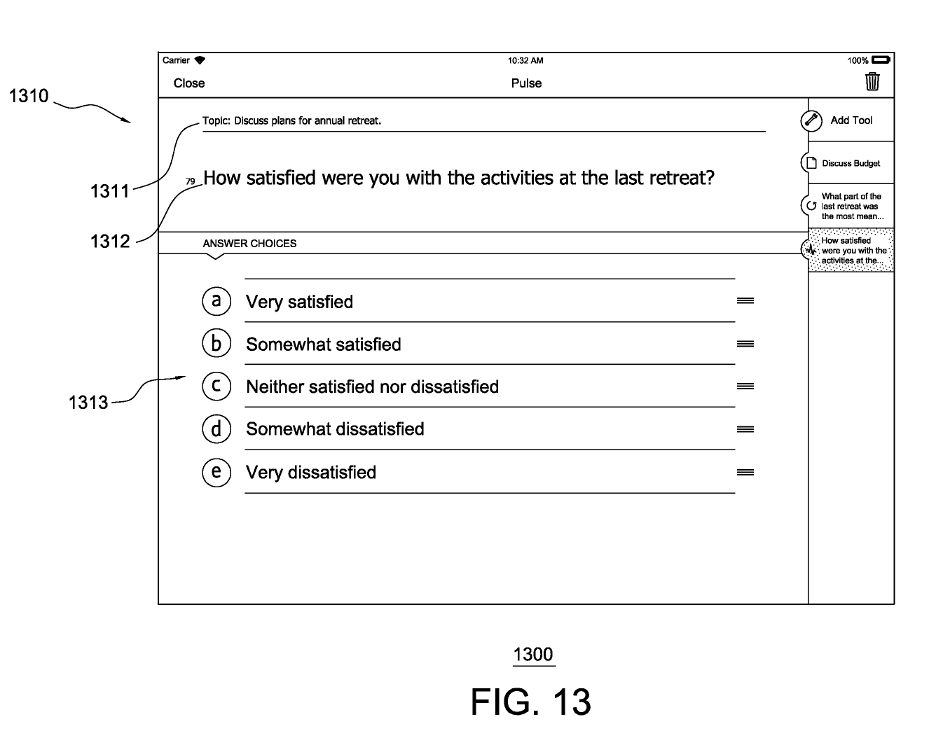

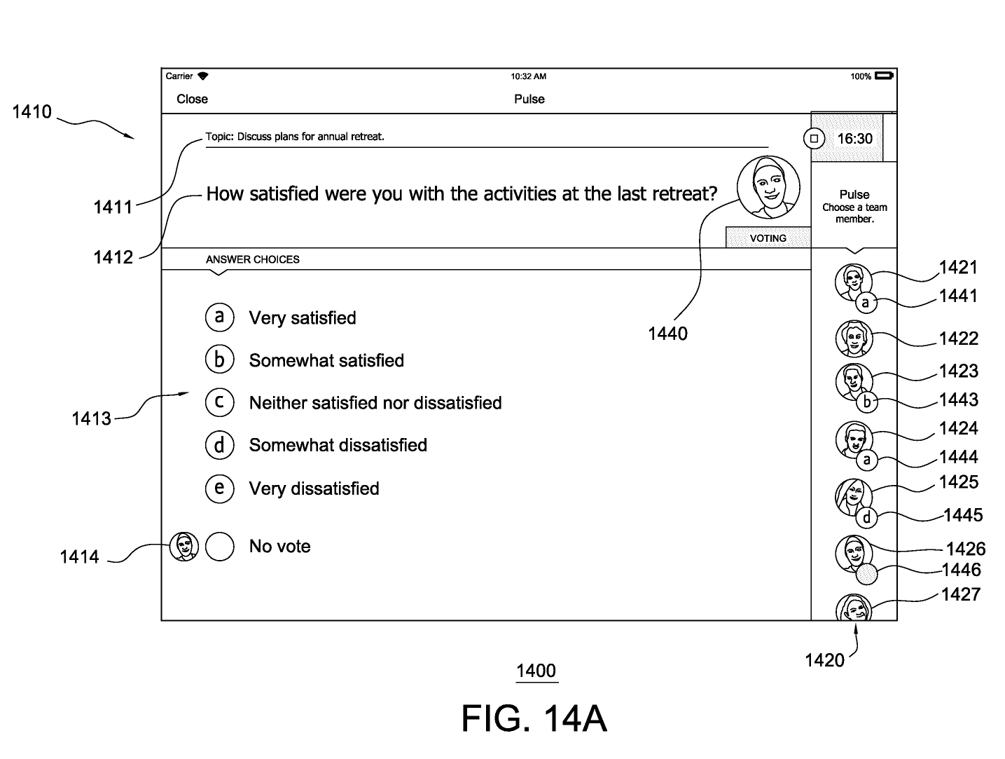

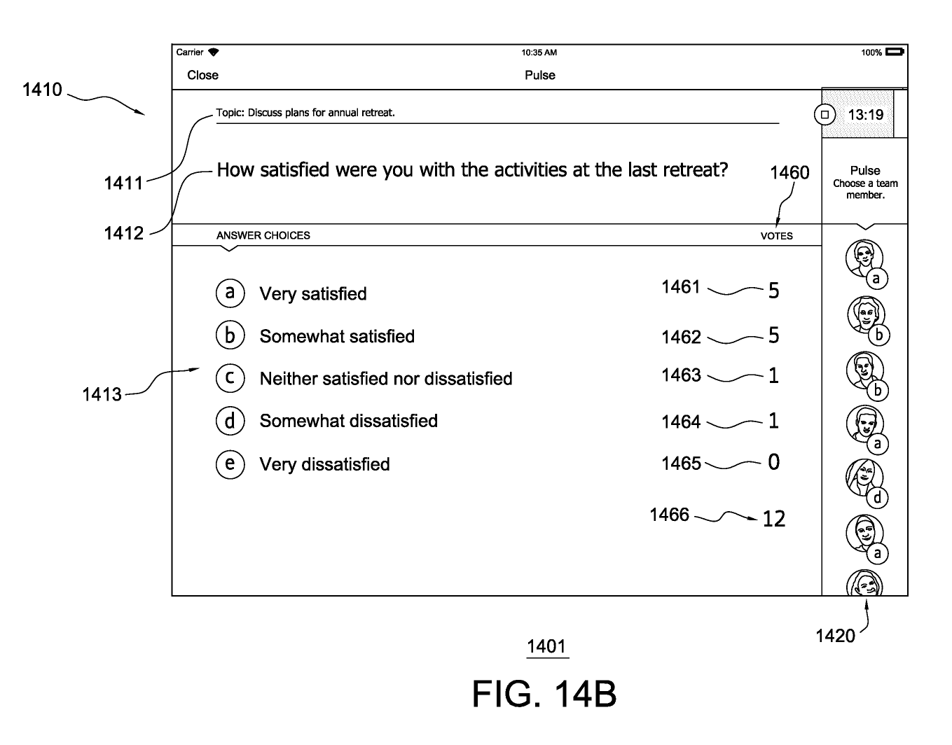

In various embodiments, topic item view 710 can include a delete item button 730, which can allow the user to delete the topic item. In a number of embodiments, topic item view 710 can include an add meeting tool button 740, which can allow the user to select among meeting tools to add to the topic item, as shown in FIG. 8 and described below. Meeting tools can be added to topic items to assist with the presentation, discussion, and feedback collection of topic items. In many embodiments, meeting tools can provide a mechanism to allow additional functionality without leaving the context of the topic item and notes and without switching between software applications. In a number of embodiments, meeting tools can inject items into the artifact stream of a topic (as described below in further detail). By connecting meeting tools to topic items, all information related to the topic item can be organized within the meeting management application around the topic item, which can conveniently organize all information related to a topic and can eliminate the need to interact with other software tools when discussing a topic. In some embodiments, the meeting management application can allow a user to add and/or utilize meeting tools with topics over time, according to the user's preferences. In many embodiments, any number of tools can be created and attached to a topic item. In several embodiments, meeting tools can have (1) a preparation mode, which can allow a user to prepare the meeting tool for later use, such as for use in a meeting (e.g., pulse form 1310 (as shown in FIG. 13, described below) can be used to prepare the pulse tool); and (2) a deployment mode, which can allow the tool to be used, such as in a meeting (e.g., pulse event 1410 (as shown in FIGS. 14A and 14B, and described below) can be used to deploy the pulse tool). In certain embodiments, the meeting management application can allow additional functionality of new meeting tools to be added to the meeting management application over time in an extensible manner, such as through in-app purchases, which can advantageously allow users to add functionality and value over time as required by the needs of the users, rather than requiring a large upfront investment in an entirely new meeting management tool. This extensible design to meeting tools can extend the utility of the meeting management application over time and leverage the time and money invested in the meeting management application. Moreover, this extensible design can ease the learning curve for new users.

In a number of embodiments the meeting management application can facilitate the creation of notes for one or more topic items, herein referred to as group notes. Group notes can be added to an artifact stream that records the interactions occurring through the meeting management application, as described below in further detail. Group notes can be text messages, images, audio, video, etc., created by users and attached to specific topic items. In many embodiments, any user can create group notes in topic items that are accessible to the user, based on the automatically defined rights described above. In some embodiments, such as shown in FIG. 7, group notes can be created automatically, such as group note 721, which can be logged upon automatically to create topic item 710. In the same or other embodiments, the user can create a group note in a topic item by selecting a group notes button 715, which can allow the user to input and post a group note, such as group note 722 and 723, which can be displayed in an artifact stream display 720. Artifact stream display 720 can display all or a portion of the artifact stream that is related to the topic item. In certain embodiments, the meeting management application can store the group note, the creation time, and the author or user that effected the creation of the group note, which can allow the meeting management application to provide a natural time-based stream of group notes within the topic item view, such as topic item view 710. Group notes can advantageously allow users to collaborate in an asynchronous manner within the context of topic items and/or meeting tools. For example, if a topic time budget is adjusted to a shortened topic time budget at a time two days in advance of a meeting, the user can comment by adding a group note stating, “I don't think that is enough time to adequately cover the topic.” Other users can comment in agreement or disagreement through group notes, which can beneficially lead to a resolution of the time budget prior to the valuable live meeting time.

In several embodiments, the meeting management application can allow the user to enter group notes with a hash tag, which can allow a user to tag a note with a term by entering a “#” (hash/pound) character before the term the user desires to tag. For example, as shown in group note 723 in FIG. 7, the user can enter “#ORLANDO” to tag the group note in a topic item with the term “Orlando.” Hash tagging can beneficially allow users to use any suitable taxonomy or terminology when tagging a group note rather than being limited to a predetermined set of possible tags. This flexible tagging taxonomy can allow tags that match the organization's terminology, and can change over time as terminology and/or priorities change. In many embodiments, hashtags can be displayed in the topic item view, such as topic item view 710, with a special formatting to facilitate rapid visual identification, such as shown in group note 723. In certain embodiments, the meeting management application can index the hashtags entered in the group notes in order to facilitate searching by useful terms.

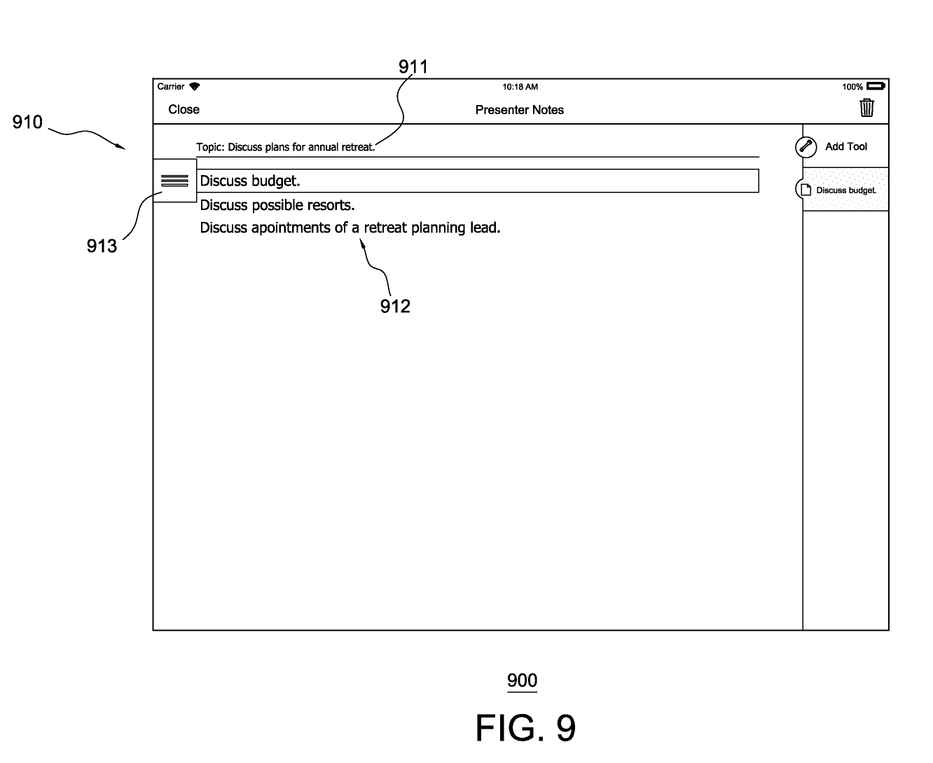

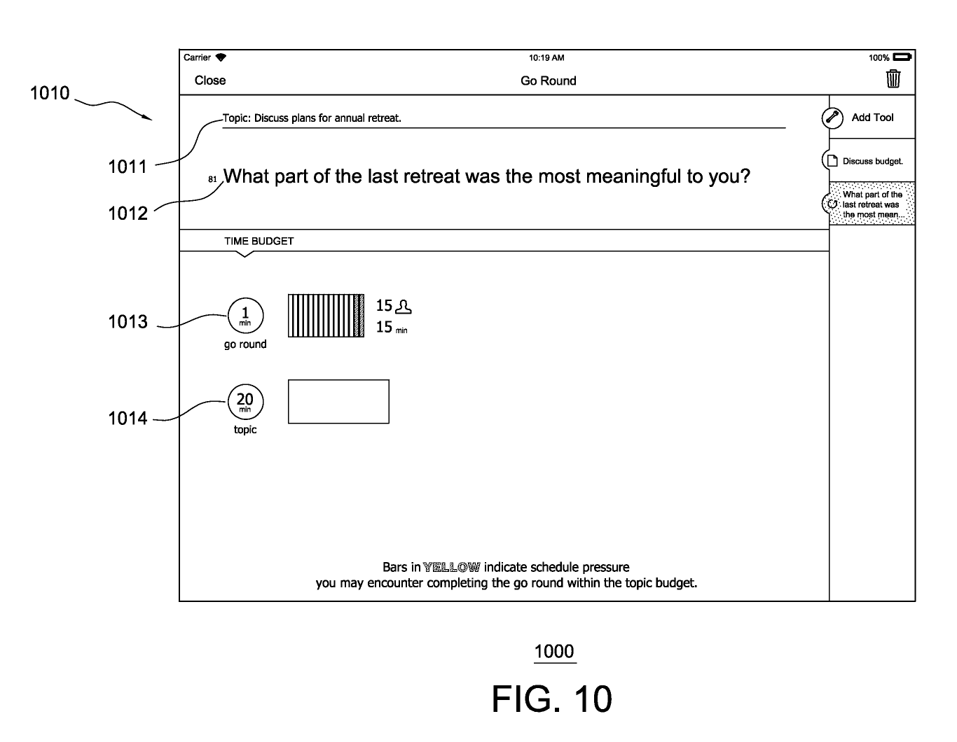

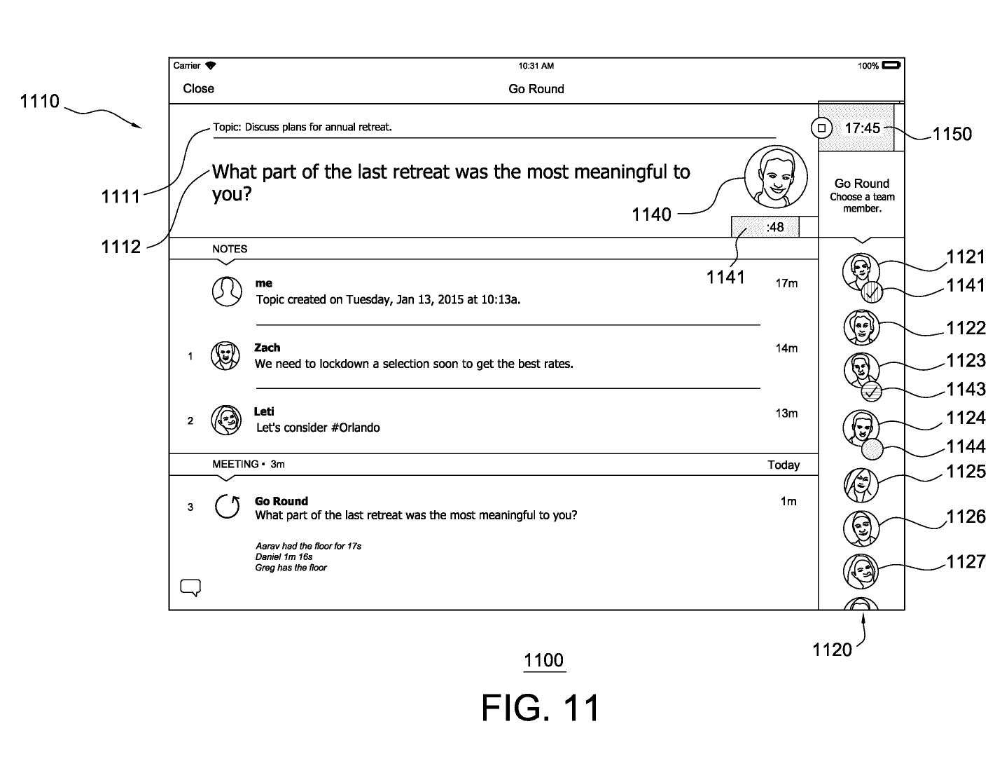

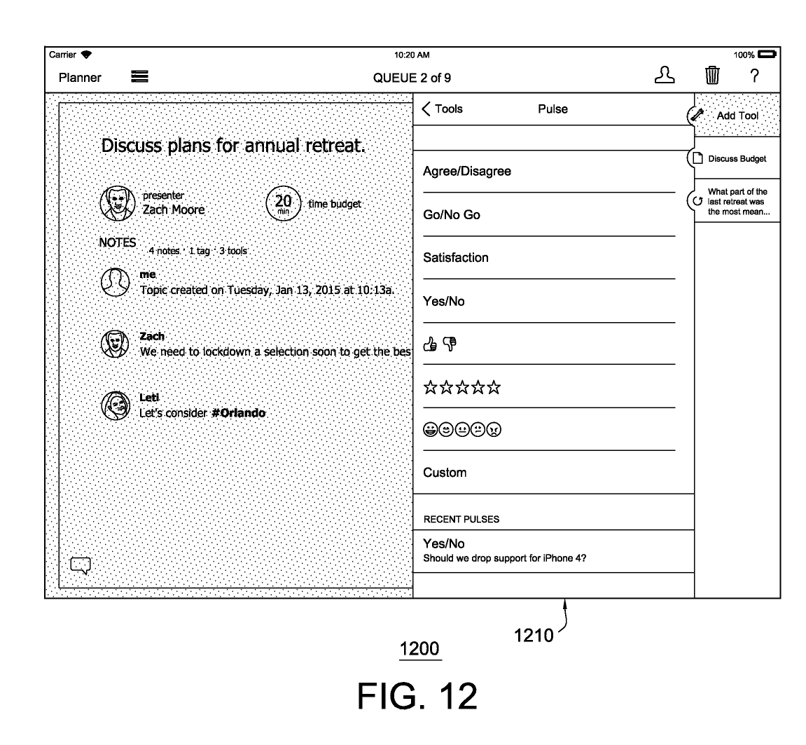

Turning ahead in the drawings, FIG. 8 illustrates an exemplary user interface display 800 of the meeting management application including an add tool selection list 810 accessed through a user device (e.g., 110-114 (FIG. 1)), according to an embodiment. User interface display 800 is merely exemplary, and embodiments of the meeting management application can be employed in many different embodiments or examples not specifically depicted or described herein. In a number of embodiments, additional meeting tools can be added to a topic item by selecting add meeting tool button 740, which can result in the meeting management application displaying add tool selection list 810. Add tool selection list 810 can allow a user to select from any number of meeting tools that can be added to a topic item, such as a meeting tool selection 811 for a browser tool, a meeting tool selection 812 for a Dropbox tool, a meeting tool selection 813 for a go round tool (as shown in FIGS. 10-11 and described below), a meeting tool selection 814 for a presenter notes tool (as shown in FIG. 9 and described below), and a meeting tool selection 815 for a pulse tool (as shown in FIGS. 12-14B and described below).

In many embodiments, additional tools can be selected through add tool selection list 810. For example, in some embodiments, an external resources tool can be added to a topic item, which can allow the user to reference and/or view external resources, such as documents, spreadsheets, presentations, slides, images, movies, records, websites, or other suitable external resources from within the meeting management application. In some embodiments, the external resources tool can be implemented through the Dropbox tool or other cloud-based resource, which can be added via meeting tool selection 812, and can be used to access such resources in a Dropbox account or other cloud-based resource. The external resources tool can advantageously eliminate the need to launch and navigate other software tools. In several embodiments, the user can create an external resource item by providing a link, such as a uniform resource locator (URL) to the electronic file of the external resource to be accessed. For example, in some embodiments, the browser tool, which can be selected via meeting tool selection 811, can be used to input and access a URL. In certain embodiments, the browser tool can automatically record all of the URLs visited for later recall or replay. As with other tools, external resource items can be attached to the topic item and can follow the topic item. The external resources tool can beneficially eliminate the need to email attachments or links to other users in the workspace team, as the external resource item can reference the most up-to-date file. Examples of other meetings tools that can be added to a topic item include a telepresence tool, which can provide a live video and/or audio stream of the user; a ranking tool, which can allow users to rank ideas presented in a topic item during a collaboration or discussion; a whiteboard tool, which can allow one or more users to sketch and share ideas. Other suitable meeting tools can be added to topic items through the meeting management application.

Turning ahead in the drawings, FIG. 9 illustrates an exemplary user interface display 900 of the meeting management application including a presenter notes form 910 accessed through a user device (e.g., 110-114 (FIG. 1)), according to an embodiment. User interface display 900 is merely exemplary, and embodiments of the meeting management application can be employed in many different embodiments or examples not specifically depicted or described herein. In a number of embodiments, presenter notes form 910 can be displayed when the user selects the presenter notes tool, such as by selecting meeting tool selection 814 (FIG. 8). Presenter notes form 910 can be used to attach presenter notes to a topic item. In a number of embodiments, presenter notes form 910 can include a topic heading 911, which can indicate the topic item with which the presenter notes are associated. In various embodiments, presenter notes form 910 can allow the user to type one or more presenter notes, such as presenter notes 912. In certain embodiments, presenter notes form 910 can include a slider 913, which can allow the user to move slider 913 up or down to highlight different individual notes from among presenter notes 912. In certain embodiments, presenter notes can be text notes. In several embodiments, presenter notes can be recorded before, during, or after a meeting. In many embodiments, any user can create presenter notes in a topic item to which the user has access. In some embodiments, presenter notes can advantageously allow a meeting presenter to prepare speaker notes for use during a meeting without needing a separate software application to prepare such notes, and/or can advantageously allow meeting participants to record private notes.

Turning ahead in the drawings, FIG. 10 illustrates an exemplary user interface display 1000 of the meeting management application including a go round form 1010 accessed through a user device (e.g., 110-114 (FIG. 1)), according to an embodiment. User interface display 1000 is merely exemplary, and embodiments of the meeting management application can be employed in many different embodiments or examples not specifically depicted or described herein. In many embodiments, go round form 1010 can be displayed when the user selects the go round tool, such as by selected meeting tool selection 813 (FIG. 8). Go round form 1010 can be used to attach a go round tool to a topic item. The go round tool can provide a mechanism to give each user an allotted time to speak or present during a meeting. In a number of embodiments, go round form 1010 can include a topic heading, 1011, which can indicate the topic item with which go round tool 1010 is associated. In various embodiments, go round form 1010 can include a prompt 1012, which the user can input to describe the purpose of a go round event created by go round form 1010. For example, the prompt (e.g., prompt 1012) can ask each user to introduce themselves or, as shown in FIG. 10, can ask each user to comment on the most meaningful part of the last retreat.

In a number of embodiments, go round form 1010 can include a speaker time budget field 1013 and/or a topic time budget field 1014. Speaker time budget field 1013 can allow the user to select how much time each speaker will be allotted during the go round event in the meeting, and can show how much total time is budgeted for the go round event. For example, if each of nine users is allotted one minute, the go round event would take nine minutes, as shown in FIG. 10. Topic time budget field 1014 can be the same or similar to topic time budget field 714 (FIG. 7), and can show the total time budget allotted to the topic item. In a number of embodiments, go round form 1010 can provide visual feedback to indicate if the go round event will fit within the time budged for the topic item. For example, speaker time budget field 1013 and topic time budget field 1014 can graphically represent the amount of time the go round event is planned to take with respect to the total time budgeted for the topic item, as shown in FIG. 10. When using go round form 1010 to plan a go round during in a live meeting, the meeting management application can show whether the planned go round event will fit within the remaining time budgeted for the topic item.

Turning ahead in the drawings, FIG. 11 illustrates an exemplary user interface display 1100 of the meeting management application including a go round event 1110 accessed through a user device (e.g., 110-114 (FIG. 1)), according to an embodiment. User interface display 1100 is merely exemplary, and embodiments of the meeting management application can be employed in many different embodiments or examples not specifically depicted or described herein. During a live meeting facilitated by the meeting management application, a user, such as the workspace owner or the topic presenter, can access a go round event created by a go round form, such as go round form 1010 (FIG. 10). While in a topic item during a meeting, the user can start a go round event, such as go round event 1110. In a number of embodiments, go round event 1110 can include a topic heading 1111, which can indicate the topic item with which go round event 1110 is associated. In various embodiments, go round event 1110 can include a prompt 1112, which can be based on prompt 1012 (FIG. 12), as created in go round form 1010 (FIG. 10), and which can describe to the users in the workspace team the purpose of go round event 1110.

In a number of embodiments, go round event 1110 can include a speaker list 1120 of all users in the workspace team or, alternatively, the users in the workspace team that are currently participating in the live meeting. The user that is directing go round event 1110, such as the workspace owner or the topic presenter, can select a user (e.g., 1121-1127) from speaker list 1120 to give that speaker the time allotted in speaker time budget field 1013 (FIG. 10). When a user (e.g., 1121-1127) has been selected from speaker list 1120, go round event 1110 can display the active speaker in speaker field 1140 and can display the active speaker's remaining time in timer field 1141 for each user to see on their user device (e.g., 110-114 (FIG. 1). In many embodiments, timer field 1141 can show a numeric and/or graphical representation of the remaining or the time by which the speaker has exceeded the time allotted. For example, a graphical timer bar in time field 1141 can change colors from green to red when the speaker reaches the time allotted. In some embodiments, the user that is directing go round event 1120 can select another user (e.g., 1121-1127) at any time within go round event 1120.

In several embodiments, after a user (e.g., 1121-1127) is selected from speaker list 1120, a status indicator (e.g., 1141, 1143, 1144) can indicate that the user (e.g., 1121-1127) has participated in go round event 1110. Each status indicator (e.g., 1141, 1143, 1144) can include indicators, such as a check mark and/or color indicators, to represent whether the speaker is currently speaking, has already spoken, has kept within the time allotted, and/or has exceeded the time allotted. In many embodiments, a user (e.g., 1121-1127) can be selected more than once and the time allotted to a user (e.g., 1121-1127) can be noncontiguous. In certain embodiments, timer field 1141 can display the total time elapsed for a user (e.g., 1121-1127) over multiple speaking selections. In several embodiments, the meeting management application can add the time taken by each user to the artifact stream, which can be displayed in an artifact stream display, such as artifact stream display 720 (FIG. 7). Go round event 1110 can display a topic timer 1150, which can indicate the time remaining of the topic time budget, such as the topic time budget selected in topic time budget field 514 (FIG. 5) and topic time budget field 714 (FIG. 7).

Turning ahead in the drawings, FIG. 12 illustrates an exemplary user interface display 1200 of the meeting management application including a pulse selection list 1210 accessed through a user device (e.g., 110-114 (FIG. 1)), according to an embodiment. User interface display 1200 is merely exemplary, and embodiments of the meeting management application can be employed in many different embodiments or examples not specifically depicted or described herein. In many embodiments, pulse selection list 1210 can be displayed when the user selects the pulse tool, such as by selecting meeting tool selection 815 (FIG. 8) from add tool selection list 810 (FIG. 8). In some embodiments, a pulse tool can be attached to a topic item to facilitate creating a survey to gather responses from team members during a meeting. Pulse events can include a text based prompt and a series of possible responses. In certain embodiments, the meeting management application can include pulse selection list 1210, which can allow the user to create a new pulse event based on a predetermined format, such as yes/no, go/no go, agree/disagree, satisfaction levels, etc.; based on the user's customized preferences; and/or based on previously created pulse events. Pulse selection list can advantageously allow a user to rapidly prepare a pulse tool, which can beneficially allow a pulse event to be quickly created and used during a meeting.

Turning ahead in the drawings, FIG. 13 illustrates an exemplary user interface display 1300 of the meeting management application including a pulse form 1310 accessed through a user device (e.g., 110-114 (FIG. 1)), according to an embodiment. User interface display 1300 is merely exemplary, and embodiments of the meeting management application can be employed in many different embodiments or examples not specifically depicted or described herein. Pulse form 1310 can be used to create a pulse based on the format selected by the user with pulse selection list 1210 (FIG. 12). For example, if the user selected a pulse event with a predetermined satisfaction format in pulse selection list 1210 (FIG. 12), pulse form 1310 can include answer choices 1313 with predetermined answers for various satisfaction levels. Similarly, other pulse events with predetermined formats can include answer choices (e.g., answer choices 1313) with predetermined answers. In many embodiments, pulse events with predetermined formats can be used in the form provided, or can be customized according to the user's preferences. If the user selected a custom pulse event in pulse selection list 1210 (FIG. 12), the pulse form (e.g., pulse form 1310) can allow the user to create answer choices (e.g., answer choices 1313) with customized answers. In various embodiments, pulse form 1310 can include a topic heading 1311, which can indicate the topic item with which pulse form 1310 is associated. In various embodiments, pulse form 1310 can include prompt 1312, which the user can input to describe the purpose of a pulse event created by pulse form 1310. For example, the prompt (e.g., prompt 1312) can ask each user how satisfied they were with the activities at the last retreat, as shown in FIG. 13.

Turning ahead in the drawings, FIG. 14A illustrates an exemplary user interface display 1400 of the meeting management application including a pulse event 1410 with a user prompted to vote, as accessed through a user device (e.g., 110-114 (FIG. 1)), according to an embodiment. FIG. 14B illustrates an exemplary user interface display 1401 of the meeting management application including pulse event 1410 with user voting statistics, as accessed through a user device (e.g., 110-114 (FIG. 1)), according to an embodiment. User interface displays 1400 and 1401 are merely exemplary, and embodiments of the meeting management application can be employed in many different embodiments or examples not specifically depicted or described herein. In many embodiments, a user, such as the workspace owner or the topic presenter, can access a pulse event created by a pulse form, such as pulse form 1310 (FIG. 13). For example, while accessing a topic item during a meeting, the user can start a pulse event, such as pulse event 1410. In a number of embodiments, pulse event 1410 can include a topic heading 1411, which can indicate the topic item with which pulse event 1410 is associated. In various embodiments, pulse event 1410 can include a prompt 1412, which can be based on prompt 1312 (FIG. 13), as created in pulse form 1310 (FIG. 13), and which can describe to the users in the workspace team the purpose of pulse event 1410. Pulse event 1410 can include answer choices 1413, which can be based on answer choices 1313 (FIG. 13).

In several embodiments, pulse event 1410 can include a voter list 1420 of all users in the workspace team or, alternatively, the users in the workspace team that are currently participating in the live meeting. In some embodiments, the user that is directing pulse event 1410, such as the workspace owner or the topic presenter, can select users (e.g., 1421-1427) one at a time from voter list 1420 to allow that user (e.g., 1421-1427) to vote by selecting one of answer choices 1413, as shown in FIG. 14A. When a user (e.g., 1421-1427) is selected as the active voter from voter list 1420, pulse event 1410 can display the active voter in voter field 1440, as shown in FIG. 14A. In other embodiments, each user (e.g., 1421-1427) can vote simultaneously by each selecting an answer choice on the user device (e.g., 110-114 (FIG. 1)) of the individual user, which can eliminate the need for user that is directing pulse event 1410 to select users one at a time.

In several embodiments, after a user (e.g., 1421-1427) has voted, a vote indicator (e.g., 1441, 1443, 1444, 1445, 1446) can indicate that the user (e.g., 1421-1427) has participated in pulse event 1410, as shown in FIG. 14A. Each vote indicator (e.g., 1441, 1443, 1444, 1445, 1446) can include indicators, such as a letter representing the answer chosen from answer choices 1413 by the user (e.g., 1421-1427). In a number of embodiments, vote indicators (e.g., 1441, 1443, 1444, 1445, 1446) are displayed only to the topic presenter and/or workspace owner. In other embodiments, all users can view the vote indicators (e.g., 1441, 1443, 1444, 1445, 1446). Alternatively, or in addition to, the answer choices chosen by each user can be displayed by selecting a user (e.g., 1421-1427) and a user vote indicator can by displayed in pulse event 1410 next to the answer chosen in answer choices 1413. In many embodiments, the meeting management application can record each answer chosen by each user (e.g., 1421-1427) with the time the answer was selected. For example, if a user (e.g., 1421-1427) selected a first answer and then changed to a second answer selection, each of the answers can be recorded along with the time each answer was selected.

In certain embodiments, when no user is selected and/or when a pulse event (e.g., pulse event 1410) has ended, a summary of the response choices and/or pulse voting totals can be displayed and/or recorded. For example, the current user (e.g., 1421-1427) that is selected can be deselected by selecting the current user (e.g., 1421-1427) or voter field 1440, which can result in no user being selected, as shown in FIG. 14B. Pulse event 1410 can include pulse totals list 1460, which can list the number of votes received (e.g., 1461-1465) for each of answer choices 1413 and/or a total number of votes 1466, as shown in FIG. 14B. In many embodiments, the meeting management application can add a summary of the voting activity to the artifact stream, and the summary can be displayed in an artifact stream display, such as artifact stream display 720.

In many embodiments, one or more meeting tools, such as the meeting tools shown in FIGS. 7-14B and described above, can be added to a topic item before, during, and/or after a meeting. For example, in certain embodiments the user can add a go round tool to a topic item before a meeting by using a go round form (e.g., go round form 1010 (FIG. 10)), and can initiate a go round event (e.g., go round event 1110 (FIG. 11)) during the meeting. As another example, the user can add a pulse tool to the topic item during a discussion in the course of a live meeting, such as to determine whether a tentative decision is supported by the team, such as by using pulse selection list 1210 (FIG. 12), pulse form 1310 (FIG. 13), and pulse event 1410 (FIGS. 14A, 14B). In several embodiments, one or more meeting tools, such as the meeting tools shown in FIGS. 7-14B and described above, can be deployed any number of times and record unique data on each deployment. For example, a pulse tool prepared through pulse form 1310 (FIG. 13) can be deployed both before and after a discussion in a topic item.

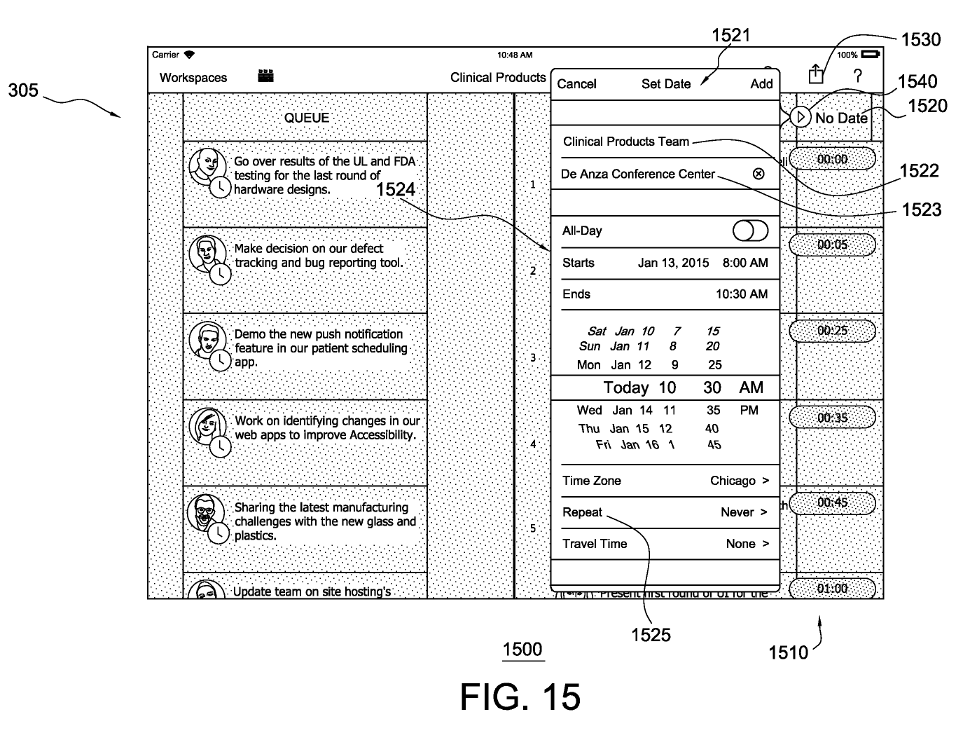

Turning ahead in the drawings, FIG. 15 illustrates an exemplary user interface display 1500 of the meeting management application including collaborative planner 305 and an add event form 1521 accessed through a user device (e.g., 110-114 (FIG. 1)), according to an embodiment. User interface display 1500 is merely exemplary, and embodiments of the meeting management application can be employed in many different embodiments or examples not specifically depicted or described herein. In many embodiments, a user, such as the workspace owner, can use the meeting management application to set an agenda and schedule a meeting. In a number of embodiments, collaborative planner 305 can include a scheduling button 1520, which can be used to access add event form 1521. In several embodiments, add event form 1521 can be provided by the user interface of the user device (e.g., 110-114 (FIG. 1)). In a number of embodiments, add event form 1521 can include a meeting description field 1522, which can allow the user to provide a title for the meeting. Add event form 1521 can include a location description field 1523, which can allow the user to provide a meeting location. In some embodiments, add event form 1521 can include time selection fields 1524, which can allow the user to schedule starting and/or end dates and times for the meeting. Add event form 1521 can include repeat fields 1525, which can allow the user to schedule additional meeting if the meeting is a recurrent. In certain embodiments, add event form 1521 can include alert fields (not shown), which can allow the user to schedule alerts that can integrate with calendars on the user device (e.g., 110-114 (FIG. 1)) to remind the users of an upcoming meeting. In many embodiments, add event form 1521 can include a unique identifier (not shown), which can connect the workspace with external applications. In a number of embodiments, add event form 1521 can be integrated with a calendar in a separate software application and/or a calendar provided by the operating system of the user device (e.g., 110-114 (FIG. 1)), and the unique identifier can be used to launch the meeting management application and navigate the user to the appropriate workspace. In some embodiments, add event form 1521 can include a notes field (not shown) to allow the user to add notes regarding the scheduled meeting.

By using add event form 1521, a user can schedule a meeting in the meeting management application. In many embodiments after a meeting is scheduled, an agenda status bar 1510 (which can include information regarding the status or schedule of topic items in agenda list 330 (FIGS. 3A, 3B)) can be updated to show the actual time at which each topic item on agenda list 330 (FIGS. 3A, 3B) is scheduled, as shown in FIG. 16, described below. In various embodiments, collaborative planner 305 can include a send button 1530, which can allow the user to send a meeting invitation, a meeting agenda, topic notes, or a record of a past meeting to others, such as other users in the workspace team, explained below in greater detail. In many embodiments, a user, such as the workspace owner, can start the meeting by selecting a start button 1540. In certain embodiments, a meeting can be started with or without being scheduled through add event form 1521.

Turning ahead in the drawings, FIG. 16 illustrates an exemplary user interface display 1600 of the meeting management application including collaborative planner 305 and an add agenda item selection list 1610 accessed through a user device (e.g., 110-114 (FIG. 1)), according to an embodiment. User interface display 1600 is merely exemplary, and embodiments of the meeting management application can be employed in many different embodiments or examples not specifically depicted or described herein. In many embodiments, a user, such as the workspace owner, can set the agenda for a meeting by selecting and/or ordering topic items in agenda list 330. In a number of embodiments, the meeting management application can allow the user to readily set the agenda before a meeting and/or to easily set or alter the agenda during a meeting. For example, as described above, topic items (e.g., 311-313 (FIGS. 3A, 3B)) in queue 320 and/or past meeting list 310 (FIG. 3B) can be added to agenda list 330. In a number of embodiments, collaborative planner 305 can include a new agenda item button 1637, which can display add agenda item selection list 1610, which can allow the user to create a new agenda item, such as a new topic item or a new break item. New topic items for agenda list 330 can be created similarly as shown in FIG. 5 and described above. Break items can allow for scheduled breaks during the meeting.

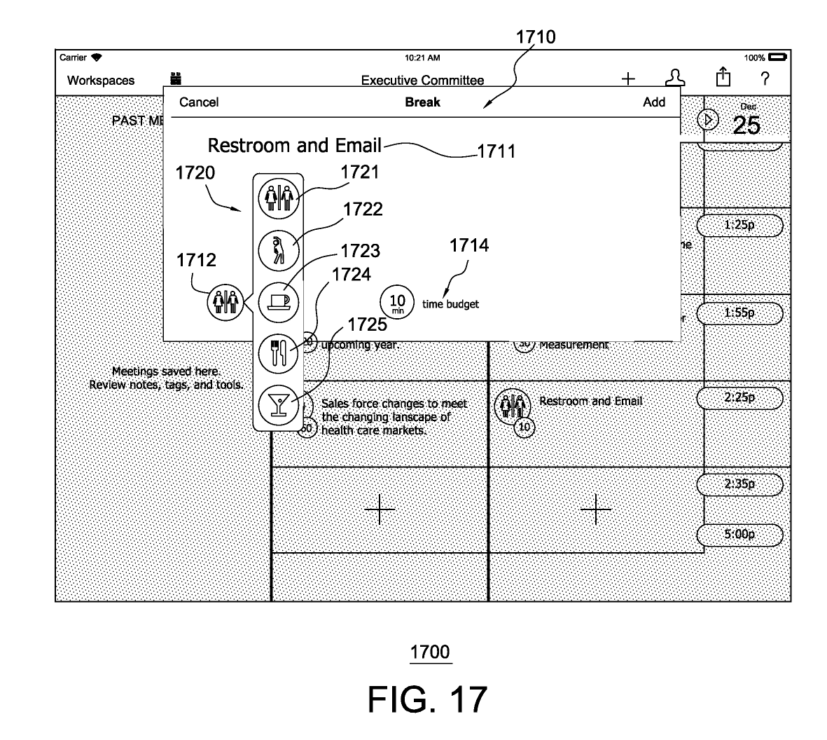

Turning ahead in the drawings, FIG. 17 illustrates an exemplary user interface display 1700 of the meeting management application including a new break item form 1710 accessed through a user device (e.g., 110-114 (FIG. 1)), according to an embodiment. User interface display 1700 is merely exemplary, and embodiments of the meeting management application can be employed in many different embodiments or examples not specifically depicted or described herein. In some embodiments new break item form 1710 can include a break description 1711, which the user can input to describe the purpose of the break item. For example, break description 1711 can indicate that the break scheduled in the agenda is for using the restroom and checking email. In various embodiments, break item form 1710 can include a break type field 1712, which can display and allow the user to update the break type. For example, the break type can be selected from a break type list 1720, which can be displayed upon selected break type field 1712. For example, break type list 1720 can include a restroom break type 1721, a stretch break type 1722, a snack break type 1723, a meal break type 1724, a drink break type 1725, or other suitable break types. In many embodiments, new break item form 1710 can include a break time budget field 1714, which can display and allow selection of a time budget for the break in the agenda created by the break item. For example, in some embodiments, the user can select break time budget field 1714 to select a scheduled break time from between 5 and 90 minutes in 5 minutes intervals. In other embodiments, other ranges and/or intervals can be used.

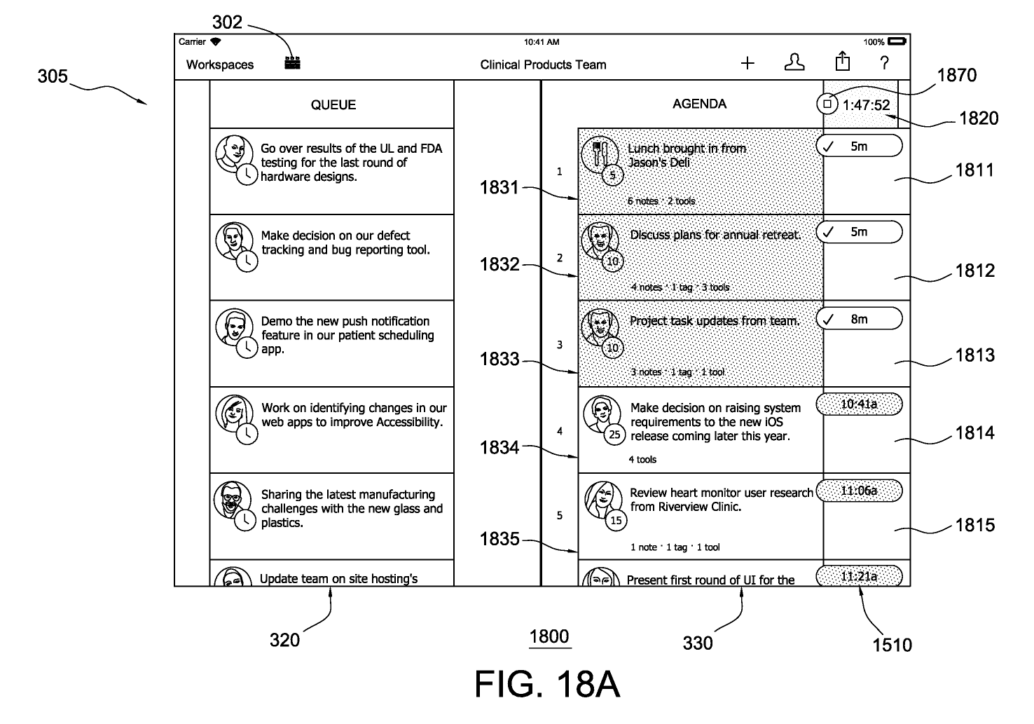

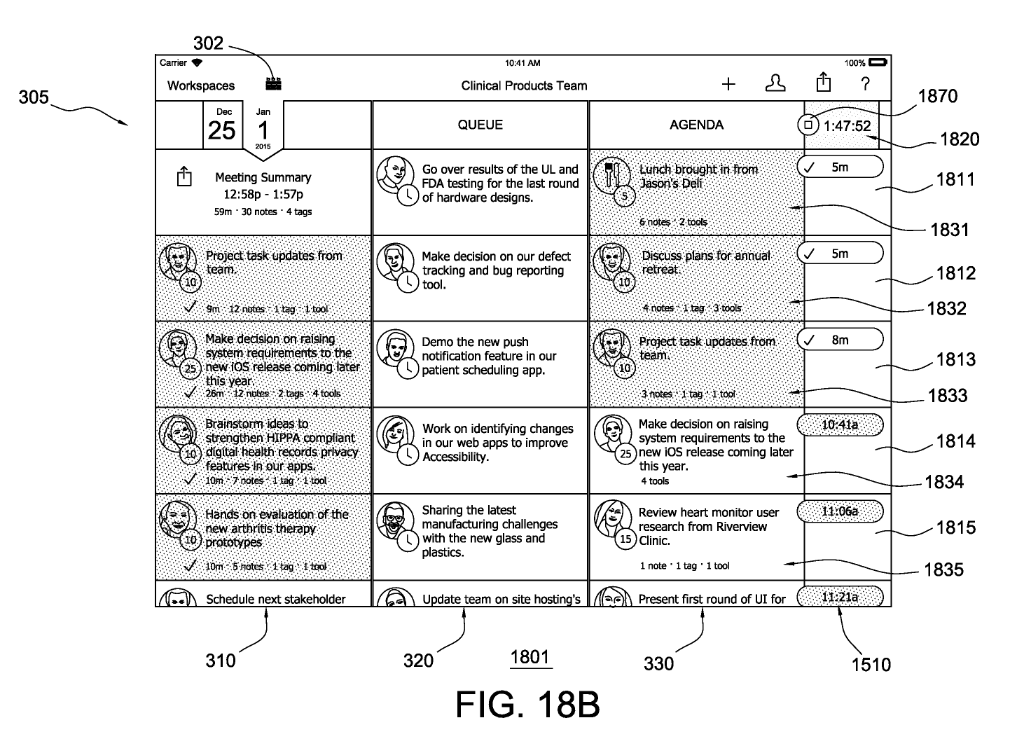

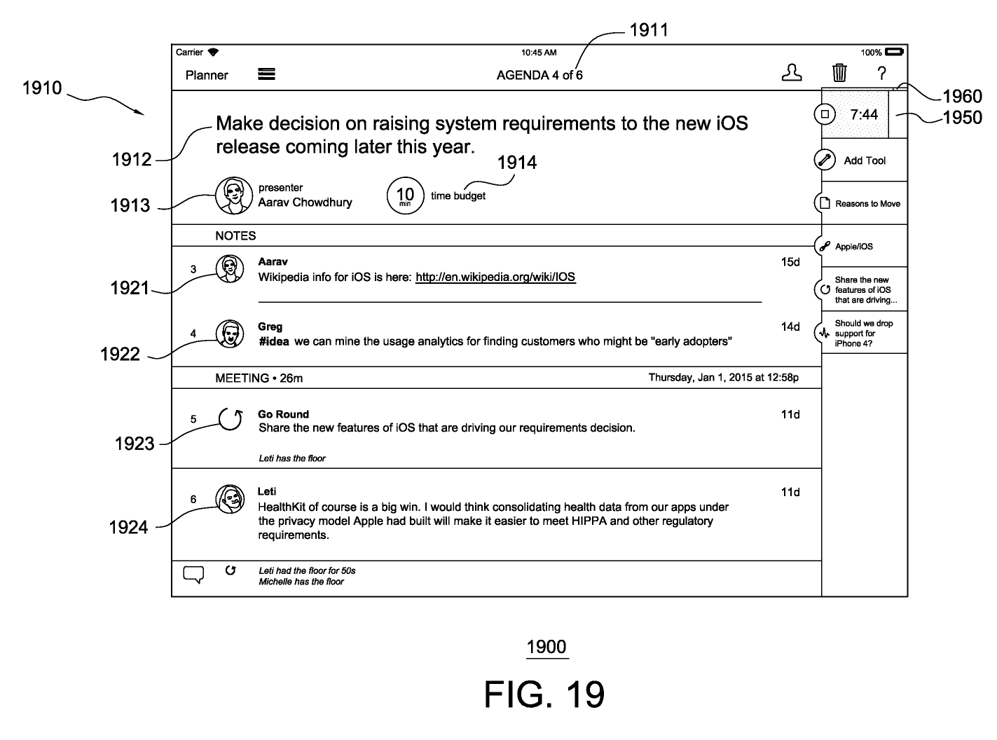

Turning ahead in the drawings, FIG. 18A illustrates an exemplary user interface display 1800 of the meeting management application including collaborative planner 305 in a live meeting mode with past meeting list 310 hidden, as accessed through a user device (e.g., 110-114 (FIG. 1)), according to an embodiment. FIG. 18B illustrates an exemplary user interface display of the meeting management application including collaborative planner 305 in a live meeting mode with past meeting list 310 shown, as accessed through a user device (e.g., 110-114 (FIG. 1)), according to an embodiment. User interface displays 1800 and 1801 are merely exemplary, and embodiments of the meeting management application can be employed in many different embodiments or examples not specifically depicted or described herein. In many embodiments, the meeting management application can include a live meeting mode to facilitate conducting and participating in meetings. For example, the workspace owner can begin enter the live meeting mode by selecting start button 1540 (FIG. 15). In a number of embodiments, the meeting management application can display agenda list 330, which can include any number of agenda items, such as topic items (e.g., 1832, 1833, 1834, 1835) and/or break items (e.g., 1831). In certain embodiments, the meeting management application can facilitate administering the meeting by allowing the workspace owner can select an agenda item agenda list 330. In many embodiments, upon selection of an agenda item from agenda list 330 in the live meeting mode, the meeting management application can display a topic item view, such as topic item view 710 (FIG. 7) or topic item view 1910 (shown in FIG. 19 and described below); or a break item view, which can be similar to topic item view 710 (FIG. 7). In several embodiments, when in the live meeting mode, the meeting management application can change the behavior or topic items and/or meeting tools to allow for deployment, automated recording, and/or bookkeeping of meeting activity. For example, in several embodiments, the meeting tools (such as shown in FIGS. 7-14B and described above) can be deployed while in the live meeting mode.

In a number of embodiments, collaborative planner 305 can include a meeting timer 1820, which can indicate the total time remaining in the scheduled meeting. For example, meeting timer 1820 can show a numeric and/or graphical representation of the time remaining as allocated by the agenda items that have not yet been accessed, or by the time remaining before the end of the meeting as scheduled by add event form 1521 (FIG. 15). In various embodiments, the meeting management application can provide a visual indication of which agenda items have been and have not yet been addressed in the meeting. For example, as shown in FIGS. 18A and 18B, break item 1831 and topic items 1832-1833 are grayed out to indicate that those agenda items have been previously addressed, while topic items 1834-35 are not grayed out, so as to indicate that those agenda items have not yet been addressed in the meeting. In many embodiments, the workspace owner can select any agenda item at any time, even if it is not ordered as the next agenda item in agenda list 330. The agenda item that is selected out of order can be reordered automatically in agenda list 330 to reflect the actual ordering of discussion topics. In a number of embodiments, an agenda item can be selected and addressed on multiple occasions during a single meeting. For example, a single topic item can be addressed in the morning, and then addressed again later in the afternoon in the same meeting after discussing other topic items in the interim. In certain embodiments, new agenda items can be added during the meeting, as shown in FIG. 16 and described above, or by dragging topic items into agenda list 330 from one of the other lists (e.g., past meeting list 310 and/or queue 320). For example, as shown in FIG. 6 and described above, a topic item can be moved from queue 320 to agenda list 330 to add an agenda item. Similarly, a new agenda item can be added during the meeting by dragging a topic item into agenda list 330 from past meeting list 310, which can be accessed through past meeting list display button 302. In a number of embodiments, the meeting can be ended by selecting an end meeting button 1870.

In many embodiments, agenda status bar 1510 can include information regarding the status or schedule of agenda items in agenda list 330. In certain embodiments, agenda status bar 1510 can include a status indicator, such as status indicators 1811-1815, for each agenda item, such as agenda items 1831-1835. In various embodiments, the status indicators (e.g., 1811-1815) can include the scheduled start time for each agenda item, based on the current ordering of the agenda items in agenda list 330. In a number of embodiments, the status indicator (e.g., 1811-1815) can include a visual indication of whether the agenda item as currently scheduled will go beyond the scheduled end time of the meeting, such as scheduled by add event form 1521 (FIG. 15). In some embodiments, the status indicators (e.g., 1811-1815) can include summary information for agenda items that have already been addressed in the meeting. For example, as shown in FIGS. 18A and 18B, status indicator 1813 can include an indication that topic item 1833 was actively discussed for eight minutes.

Turning ahead in the drawings, FIG. 19 illustrates an exemplary user interface display 1900 of the meeting management application including a topic item view 1910 in a live meeting mode, as accessed through a user device (e.g., 110-114 (FIG. 1)), according to an embodiment. User interface display 1900 is merely exemplary, and embodiments of the meeting management application can be employed in many different embodiments or examples not specifically depicted or described herein. In several embodiments, as explained above, the workspace owner can select an agenda item from agenda list 330 (FIGS. 3A, 3B, 18A, 18B) in order to select and access an agenda item. Topic item view 1910 can include a heading 1911, which can indicate that the topic item is a meeting topic and can indicate the ordering of the topic item within the meeting. In a number of embodiments, topic item view 1910 can include a description field 1912, which can be identical or similar to description field 712 (FIG. 7); a presenter selection field 1913, which can be identical or similar to presenter selection field 713 (FIG. 7); and/or a topic time budget field 1914, which can be identical or similar to topic time budget field 714 (FIG. 7).

In several embodiments, topic item view 1910 can include a topic timer 1950, which can indicate the time remaining of the time budgeted (as shown in topic time budget field 1914). Topic timer 1950 can be similar to topic timer 1150 (FIG. 11). In a number of embodiments, topic timer 1950 can show a numeric and/or graphical representation of the time remaining or the time by which the agenda item has exceeded the time allotted. For example, topic timer 1950 can change colors from green to red when the time spent exceed the topic time planned, after which topic timer 1950 can display the amount of time by which the time planned has been exceeded. In many embodiments, topic item view 1910 can include a meeting timer 1960, which can indicate the total time remaining in the scheduled meeting. In many embodiments, meeting timer 1960 can be similar or identical to meeting timer 1820 (FIGS. 18A, 18B).

In a number of embodiments, when a topic item is open to display the topic item view (e.g., 1910) in live meeting mode, the meeting management application can automatically begin the timers (e.g., topic timer 1950 and/or meeting timer 1960). For example, the timers can begin without a user explicitly starting a timer. When the topic item is closed, such as by closing the topic item view (e.g., 1910), the meeting management application can automatically end the timers (e.g., topic timer 1950 and/or meeting timer 1960). For example, the timers can begin without a user explicitly starting a timer. In a number of embodiments, after the topic item has been opened to display the topic item view (e.g., 1910), the timers (e.g., topic timer 1950 and/or meeting timer 1960) can wait for a pre-roll period before starting. For example, the pre-roll period can be 3, 5, 8, or 10 seconds, or another suitable amount of time. In several embodiments, if a user takes an action within the topic item when the topic item view (e.g., 1910) is open during the pre-roll period, the pre-roll period can end immediately upon that action, such that times can be immediately started upon receiving the action. By delaying the beginning of topic timers for a pre-roll period, the meeting management application can beneficially allow users to peek at topics briefly during a live meeting without starting a timer. In many embodiments, a group note indicating the discussion began (e.g., group notes 721-723 (FIG. 7), 1921-1924 (FIG. 19)) can be logged automatically after the pre-roll period ends and the timers begin. In some embodiments, the pre-roll delay can similarly be applied to other timers, such as topic timer 1150 (FIG. 11) in go round event 1110 (FIG. 11). In other embodiments, one or more of the timers could start immediately without a pre-roll period, and/or the pre-roll period can vary in the amount of time for different timers.

In many embodiments, when a topic item is opened to display the topic item view (e.g., 1910) in live meeting mode and the timers (e.g., topic timer 1950 and/or meeting timer 1960) have started after the pre-roll period, if the topic item view (e.g., 1910) is closed within an undo period, the meeting management application can remove the record of that discussion period (e.g., a group note (e.g., group notes 721-723 (FIG. 7), 1921-1924 (FIG. 19)) that logs that discussion had begun) and revert the timers as though the discussion had not been started. For example, the undo period can be 5, 10, 15, 20, 25, or 30 seconds, or another suitable amount of time. In a number of embodiments, the undo period can be greater than the pre-roll period. In several embodiments, if a user takes an action within the topic item when the topic item view (e.g., 1910) is open during the undo period, the undo period can end immediately upon that action, such that closing the topic item view (e.g., 1910), even within the undo period, would not undo any record of the discussion or revert any timers. By reverting the timers and undoing the record of the discussion for the undo period, the meeting management application can beneficially provide a record of events that eliminates records of mistakes or clutter. For example, if a topic item is opened for discussion and the team notices that a team member that is critical to that discussion is not in the meeting at the time, the topic item can be closed without creating a permanent record of that brief open and close event and/or without adjusting the timers. In many embodiments, a group note indicating the discussion began (e.g., group notes 721-723 (FIG. 7), 1921-1924 (FIG. 19)) can be logged automatically after the pre-roll period ends and the timers begin. In some embodiments, the undo delay can be applied in a similar manner to other timers, such as topic timer 1150 in go round event 1110. In other embodiments, one or more of the timers could not have an undo period, and/or the undo period can vary in the amount of time for different timers.

By displaying the agenda item that is currently active on the user device (e.g., 110-114 (FIG. 1)) of each user in the workspace team that is participating in the meeting, the meeting management application can assist each user to know the current topic, the current time budget, and the remaining topic time, which can beneficially help to keep the focus on the topic and/or to eliminate the need for additional paper or electronic agendas. Because the flow of the meeting can be a result of organization of topic items, the need to prepare a meeting agenda can be eliminated.

By displaying timers, such as topic timer 1950 and meeting timer 1960, the meeting management application can advantageously help keep the meeting on track as planned and increase meeting efficiency. In many embodiments, timers do not enforce the time budgets, but rather simply display feedback that allows meeting participants to adjust accordingly.

In many embodiments, topic items can be reused in later meetings. All information recorded for a particular topic item can be connected across each meeting in which the topic item is addressed. For example, as shown in FIG. 19, topic item view 1910 can include one or more group notes, such as group notes 1921, 1922, 1923, and 1924. Groups notes 1921-1924 can be similar to group notes 721-722 (FIG. 7). The meeting management application can show a live feed of group notes that are added to the topic item, and can, in many embodiments, include a historical feed of all group notes added to the topic item. For example, as shown in FIG. 19, group notes 1921 and 1922 were each added to topic item view 1910 before the meeting, and group notes 1923 and 1924 were added to topic item view 1910 in the current live meeting.

In many embodiments, the meeting management application can include a broadcast functionality, which can allow the meeting management application to send similar and/or unique display information to an external display device, such as a television (TV) screen. For example, in some embodiments, the current topic item that is displayed on all of the user devices (e.g., 110-114 (FIG. 1)) utilized by the users in the workspace team can be displayed on a TV screen. In various embodiments, certain users, such as the topic presenter or the workspace owner, can view additional information relevant to running the meeting or presenting which is not viewed on other user devices or external display devices. For example, in certain embodiments the topic presenter can view presenter notes (e.g., presenter notes prepared as shown in FIG. 9 and described above) while the topic item is active and being discussed. By broadcasting certain information, such as topic item view 1910, to the other user devices (e.g., 110-114 (FIG. 1)) and/or external display devices, the meeting management application can beneficially help users stay focused on the important information while simultaneously allowing the topic presenter or workspace owner to efficiently run the meeting.

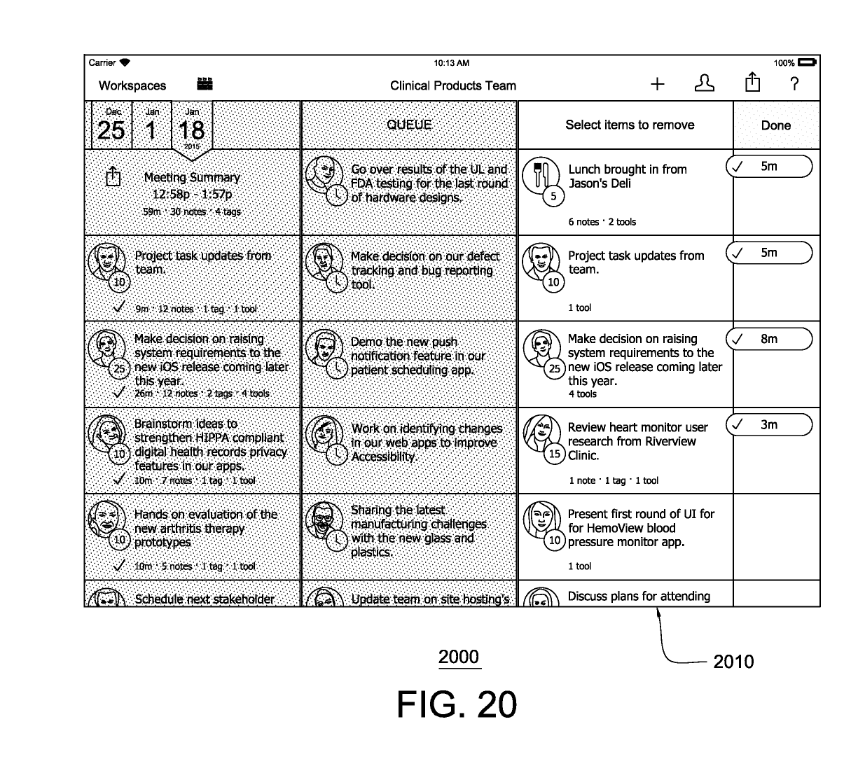

Turning ahead in the drawings, FIG. 20 illustrates an exemplary user interface display 2000 of the meeting management application including an agenda item reuse listing 2010, as accessed through a user device (e.g., 110-114 (FIG. 1)), according to an embodiment. User interface display 2000 is merely exemplary, and embodiments of the meeting management application can be employed in many different embodiments or examples not specifically depicted or described herein. In many embodiments, the meeting management application can provide an ability to readily reuse agenda items after a meeting is completed. For example, after the meeting has ended, such as by selecting end meeting button 1870 (FIGS. 18A, 18B), the meeting management application can display agenda item reuse listing 2010, which can display each agenda item addressed in the completed meeting and can allow the workspace owner to select when agenda items should or should not continue to be on agenda list 330 (FIGS. 3A, 3B, 18A, 18B). Agenda item reuse listing can facilitate simple and straight-forward reuse of agenda items, which can beneficially facilitate continuing discussions of topics in natural ways.

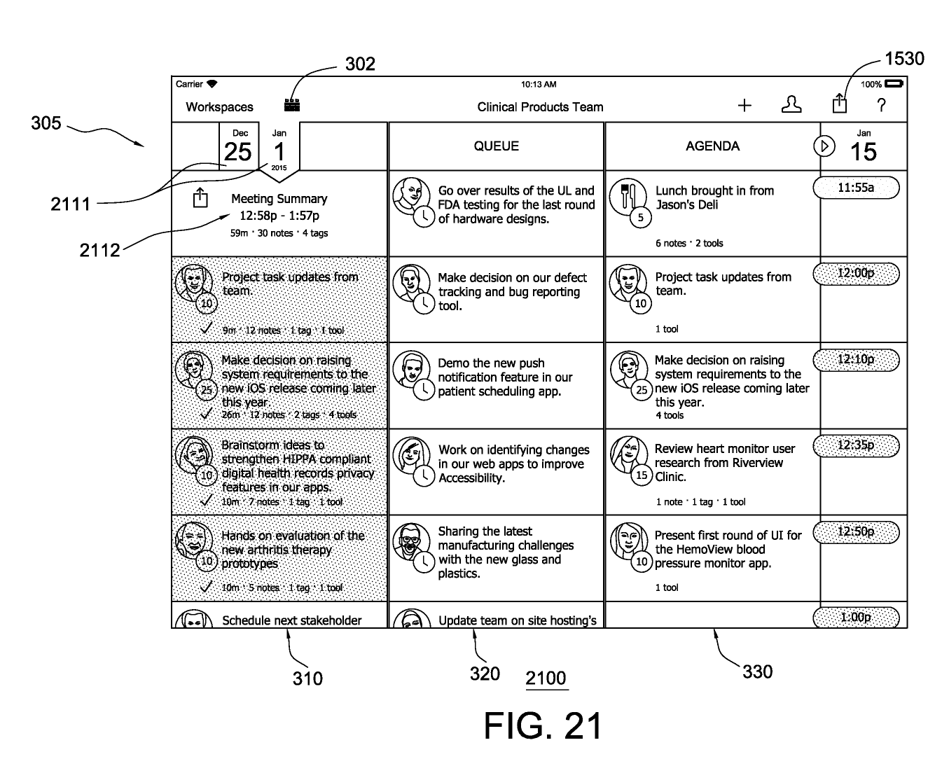

Turning ahead in the drawings, FIG. 21 illustrates an exemplary user interface display 2100 of the meeting management application including an past meeting list 310, as accessed through a user device (e.g., 110-114 (FIG. 1)), according to an embodiment. User interface display 2100 is merely exemplary, and embodiments of the meeting management application can be employed in many different embodiments or examples not specifically depicted or described herein. In several embodiments, the meeting management application can automatically create a record and display a summary of past meetings in past meeting list 310. In many embodiments, past meeting list 310 can be accessed by selecting past meeting list display button 302. Past meeting list 310 can include one or more meeting tabs 2111, which can each represent a complete meeting in the workspace. In a number of embodiments, a user can select one of meeting tab 2111 to display meeting summary information 2112 and/or a listing of the agenda items from the past meeting.

In some embodiments, past meeting list 310 can include a record of all agenda items that were addressed in the meeting. In many embodiments, the meeting management application can allow the user to perform searching on agenda items, group notes, hashtags, and/or other items, such as text in the artifact stream. In certain embodiments, each agenda item can be available to be viewed to see a record of the topic item view or break item view, including such information as total discussion times and which users in the workspace team participated in the discussion. In many embodiments, agenda items in past meeting list 310 can be reused and copied onto queue 320, or agenda list 330. In various embodiments, meeting summary information 2112 can include details of the live meeting, such as time elapsed, the time and place of the meeting, the number of comments, etc.

In many embodiments, the meeting management application can record information in the artifact stream as users interact with the meeting management application. For example, the meeting management application can record when a topic was created and which user created the topic. As additional examples, the meeting management application can record when meetings were held, which users were in attendance (including when each user joined or left the meeting), which topics were discussed, in what order the topics were discussed, how long the meeting lasted, and/or the scheduled and actual start and end times of each agenda item and the entire meeting. As yet additional examples, the meeting management application can record which tools were created and used, by which users they were created, at what time each tool was created and/or used, and the results from the tools (such as which users voted for which answers in a pulse event, and the time at which the users voted). In many embodiments, the record can include the information regarding which user performed each interaction and at what time the action was performed, which can allow the meeting management application to readily create a complete and accurate timeline of the what actions were performed. In many embodiments, the meeting management application can automatically capture the artifact stream as a result of the natural actions of each user, which can beneficially provide rich historical information without requiring manual creation or data entry.

In several embodiments, the meeting management application can include an analytics module that can provide analytical information based on the data stored in the artifact stream. For example, the meeting management application can provide answers to questions such as the following, among many others:
What are my meetings today about?
What items am I responsible for and need to prepare for?
Who does (or does not) plan meetings in advance?
What does the group think about a certain issue?
Who attends meetings promptly (or is tardy)?
What topics are people talking about the most (or the least)?
What did a certain meeting cost the company?
What was discussed in the meeting and where are the notes?
What topics keep coming back for discussion over and over?
Who is (or is not) participating and contributing to meetings and topics?
How can I participate or catch up if I cannot attend the meeting?
How can we collaborate and reduce the number and duration of meetings?

In many embodiments, artifacts in the artifact stream can be variable, ranging from simple text-based notes to PowerPoint presentations and user survey results. In some embodiments, artifacts can each share common base data, such as a record of the topic item, the time of the interaction, and the user performing the interaction. This commonality of base data can beneficially allow the artifacts recorded in the artifact stream to be viewed and/or mined in context. For example, the artifact stream can make it possible to see if the group opinion on a topic changed after 30 minutes of discussion.

In various embodiments, send button 1530 of collaborative planner 305 can allow the user to generate a formatted document from system and/or user generated data contained within the meeting management application. In many embodiments, the document can be provided in a human-readable form that can be shared with others. For example, in a number of embodiments, the document can be in a form that can be read by others who do not have the meeting management application, such as an industry standard format (e.g., a portable document format (PDF) document). In several embodiments, the user can select a document type to create, such as a queue document, an agenda document, or a past meeting document. The different document types can have different structure and contents that can be suited to the type of data included in the document.

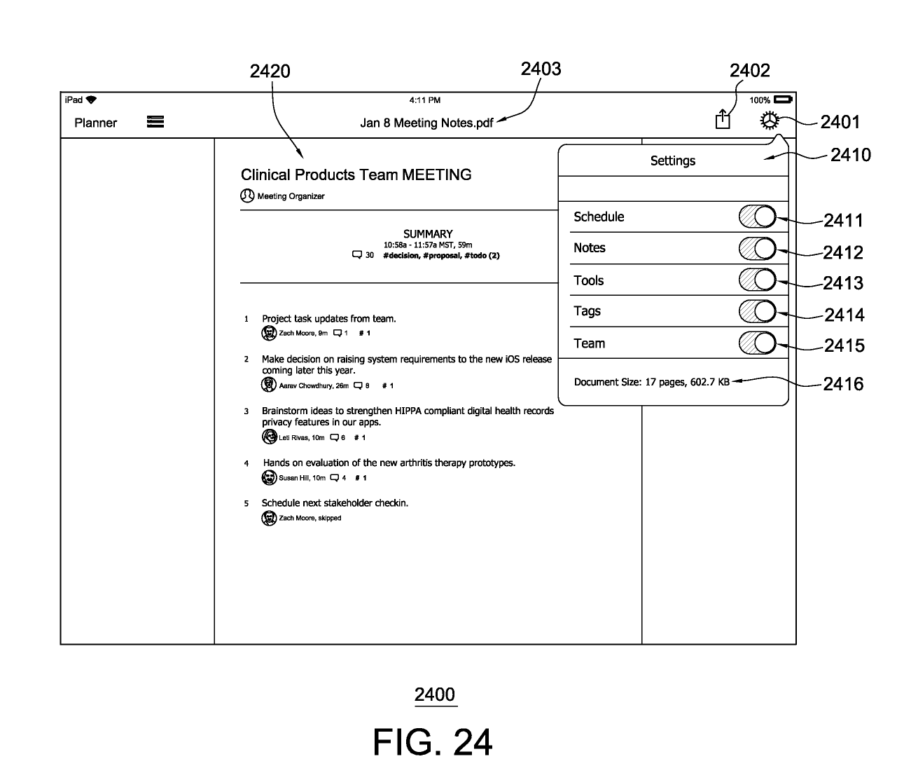

For example, in some examples, the past meeting document can include topic items that were discussed in a certain past meeting. In many examples, the past meeting document can be limited to including the notes that occurred just before, during and just after the time of a certain past meeting (i.e., when the past meeting occurred), but can exclude other notes for topic items in the past meeting when such notes occurred outside the context of the certain past meeting. In the same of other examples, the past meeting document can include summary data, such as the number of notes that were entered, or the amount of time in which a topic was discussed in that specific meeting. In a number of embodiments, the summary data can include meeting summary information 2112 (FIG. 21). In certain embodiments, when a meeting is completed, the meeting management application can prompt the user to create a past meeting document for the meeting that was just completed. In some examples, the agenda document can include a meeting agenda that indicates that time at which each topic item in the agenda list is planned to be discussed. In a number of examples, the queue document can include the topic items that are in the queue and the notes and/or the other records that are associated with those topic items. In some examples, the formatted documents can include additional information and/or the content included in the formatted documents can be selected by the user, as shown in FIG. 24, and described below.

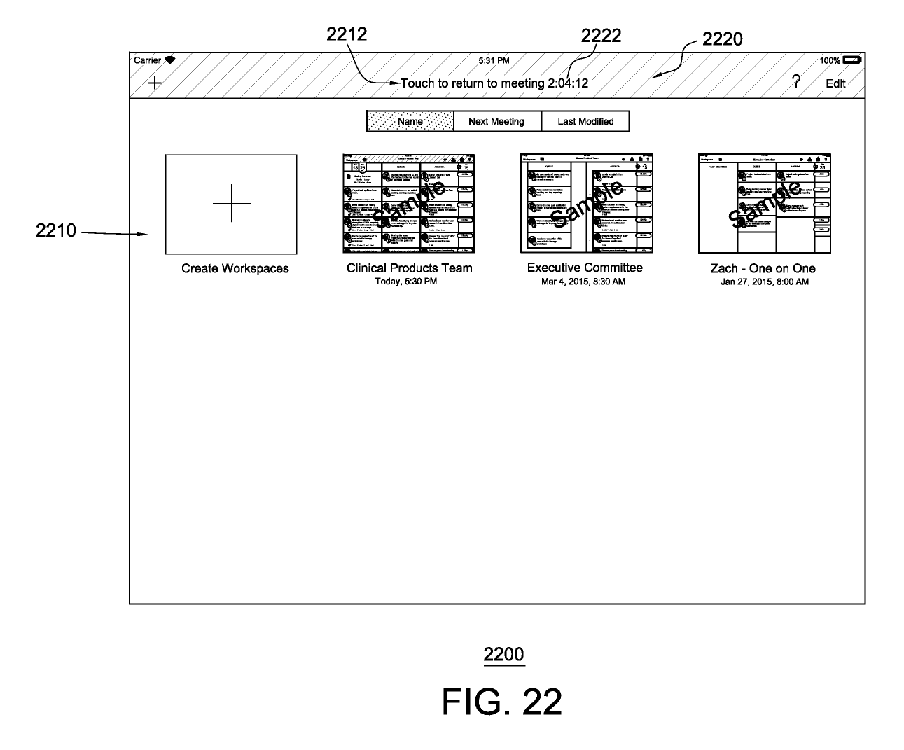

Turning ahead in the drawings, FIG. 22 illustrates an exemplary user interface display 2200 of the meeting management application, including a navigation return bar 2220 for when the user has navigated away from the collaborative planner (e.g., 305 (FIGS. 18A, 18B)) or topic item view (e.g., 1910 (FIG. 19)) in the live meeting mode, as accessed through a user device (e.g., 110-114 (FIG. 1)). User interface display 2200 is merely exemplary, and embodiments of the meeting management application can be employed in many different embodiments or examples not specifically depicted or described herein. In many embodiments, a user can navigate away from the meeting during the live meeting mode, such as by leaving collaborative planner (e.g., 305 (FIGS. 18A, 18B)) or topic item view (e.g., 1910 (FIG. 19)) in the live meeting mode to view another display in the meeting management application, such as workspace listing 2210. Workspace list 2210 can be similar to workspace listing 210 (FIG. 2). Upon navigating away from the live meeting mode, the meeting management application can adjust the navigation bar of the user's device (e.g., 110-114 (FIG. 1)) to provide navigation return bar 2220. Navigation return bar 2220 can be configured to allow the user to quickly return to the live meeting (e.g., collaborative planner (e.g., 305 (FIGS. 18A, 18B)) or topic item view (e.g., 1910 (FIG. 19)) by selecting navigation return bar 2220. In a number of embodiments, navigation return bar 2220 can include information 2212 about the returning to the meeting, such as “Touch to return to the meeting,” and/or can include a timer 2222 to show the amount of time remaining in the meeting. Navigation return bar 2220 can advantageously provide a reminder to users who have left the live meeting to return to the live meeting and beneficially provide a simple way to quickly return to the live meeting.

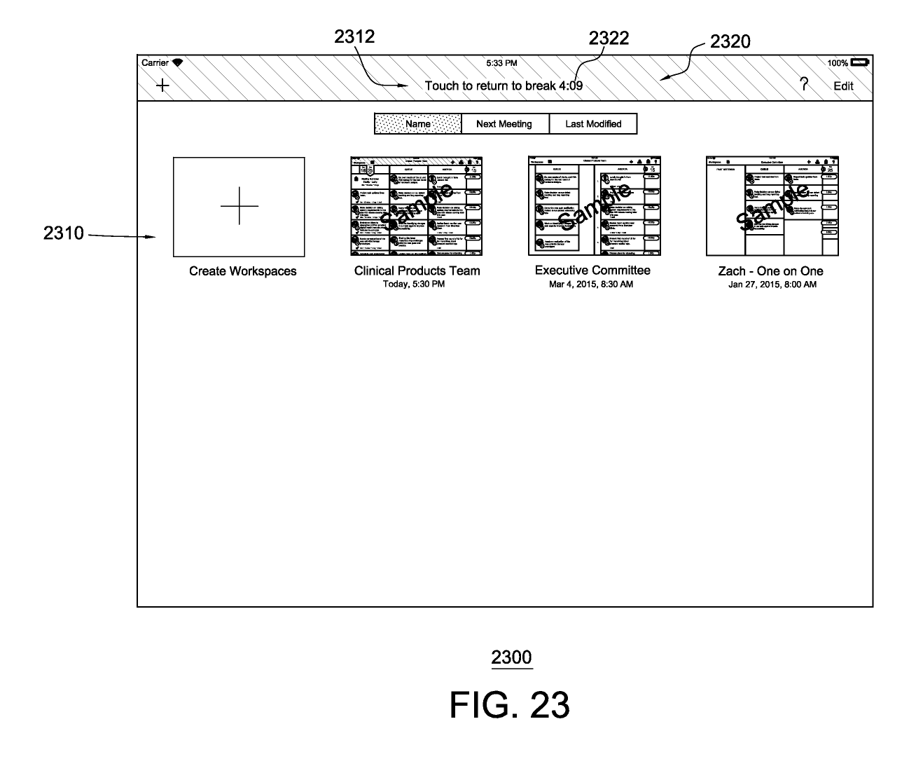

Turning ahead in the drawings, FIG. 23 illustrates an exemplary user interface display 2300 of the meeting management application, including a navigation return bar 2320 for when the user has navigated away from the collaborative planner (e.g., 305 (FIGS. 18A, 18B)) or topic item view (e.g., 1910 (FIG. 19)) in the live meeting mode during a break, as accessed through a user device (e.g., 110-114 (FIG. 1)). User interface display 2300 is merely exemplary, and embodiments of the meeting management application can be employed in many different embodiments or examples not specifically depicted or described herein. In many embodiments, a user can navigate away from the meeting during a break during the live meeting mode, such as by leaving a break item view (e.g., for break item 1831) during a break, such as a break that was added such as through new break item form 1710 (FIG. 17). For example, the user can navigate away to view another display in the meeting management application, such as workspace listing 2310. Workspace list 2310 can be similar or identical to to workspace listing 210 (FIG. 2) and/or workspace list 2210 (FIG. 22). Upon navigating away from the live meeting mode during the break, the meeting management application can adjust the navigation bar of the user's device (e.g., 110-114 (FIG. 1)) to provide navigation return bar 2320. Navigation return bar 2320 can be similar or identical to navigation return bar 2220. Navigation return bar 2320 can be configured to allow the user to quickly return to the live meeting in the break item view by selecting navigation return bar 2320. In a number of embodiments, navigation return bar 2320 can include information 2312 about the returning to the break, such as “Touch to return to break,” and/or can include a timer 2322 to show the amount of time remaining in the break. Navigation return bar 2320 can advantageously provide a reminder to users who have left the live meeting during a break to return to the live meeting and beneficially provide a simple way to quickly return to the live meeting.

Turning ahead in the drawings, FIG. 24 illustrates an exemplary user interface display 2400 of the meeting management application including a preview of a formatted document 2420 and a content settings list 2410, as accessed through a user device (e.g., 110-114 (FIG. 1)), according to an embodiment. User interface display 2400 is merely exemplary, and embodiments of the meeting management application can be employed in many different embodiments or examples not specifically depicted or described herein. In many embodiments, the meeting management application can provide the ability for the user to generate a formatted document from system and/or user generated data contained within the meeting management application according to content settings selected by the user. For example, formatted document 2420 can be a past meeting document that summarizes and/or provides details of a past meeting. In several embodiments, user interface display 2400 can include a document file name identifier 2403 to display the file name of the formatted document.

In several embodiments, user interface display 2400 can include a settings button 2401, which can be used to access content settings list 2410. In many embodiments, content settings list 2410 can allow the user to select whether to display various content as part of formatted document 2420. For example, content settings list 2410 can include a schedule setting 2411, a notes setting 2412, a tools setting 2413, a tags setting 2414, and a team setting 2415, and/or other suitable settings. Schedule setting 2411 can be toggled to include in or exclude from formatted document 2420 information such as when meetings in the workspace have been held or are scheduled to be held. Notes setting 2414 can toggled to include in or exclude from formatted document 2420 information such as group notes (e.g., 721-723 (FIG. 7), 1921-1924 (FIG. 19)) that are included in each of the topic items discussed in the specific past meeting. In a number of embodiments, the group notes can be limited to those group notes that were discussed just before, during, or just after the specific past meeting. Tools setting 2413 can be toggled to include in or exclude from formatted document 2420 information such as the information regarding the meeting tools (e.g., the meeting tools shown in FIGS. 7-14B) that were used and/or the results from the meeting tools used in topic items discussed during the specific past meeting. In a number of embodiments, the meeting tools can be limited to those meeting tools that were used during the specific past meeting. Tags setting 2414 can be toggled to include in or exclude from formatted document 2420 information such as tags (e.g., hashtags) that were included in the topic items, such as in the group notes (e.g., 721-723 (FIG. 7), 1921-1924 (FIG. 19)) in the topic items, that were discussed in the past meeting. In a number of embodiments, the tags can be limited to those tags that were added just before, during, or just after the specific past meeting. Team setting 2415 can be toggled to include in or exclude from formatted document 2420 information such as the team members in the workspace. In a number of embodiments, the team members can be limited to those team members that were present during the specific past meeting.

In many embodiments, as the settings (e.g., 2411-2415) of content settings list 2410 are adjusted, the preview of formatted document 2420 can be adjusted to match the selected content settings. In several embodiments, user interface display 2400 can include a document size identifier 2416, which can display information regarding the size of formatted document 2420, such as the number of pages or the file size. In many embodiments, user interface display 2400 can include a share button 2402, which can be used to send formatted document 2420, as defined by the settings (e.g., 2411-2415) of content settings list 2410, to other individuals, groups, or applications. For example, the share button 2402 can be used to send formatted document 2420 to others individuals or groups who do not use the meeting management application, such as by email, text message, print, or device-to-device direct transfer. As another example, the share button 2402 can be used to export formatted document 2420 to be opened in another software application.

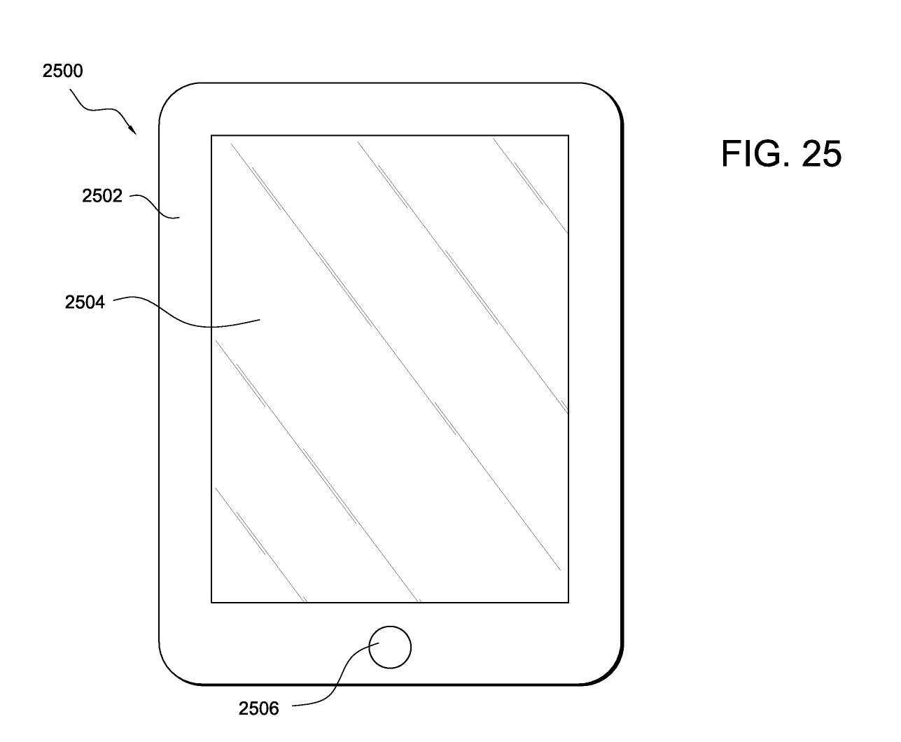

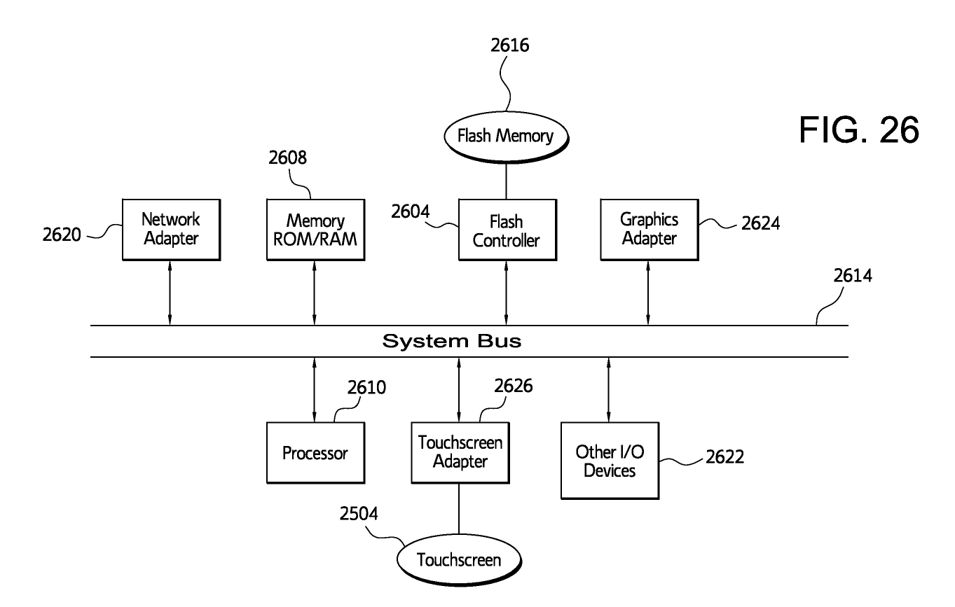

Turning ahead in the drawings, FIG. 25 illustrates a tablet computing device 2500 that is suitable for implementing an embodiment of at least a portion of user devices 110-114 (FIG. 1) and/or server 120 (FIG. 1). Tablet computing device 2500 can include a chassis 2502 containing one or more circuit boards (not shown), a touchscreen display 2504, and a button 2506. A representative block diagram of the elements included on the circuit boards inside chassis 2502 is shown in FIG. 26. A processor 2610 in FIG. 26 is coupled to a system bus 2614 in FIG. 26. In various embodiments, the architecture of processor 2610 can be compliant with any of a variety of commercially distributed architecture families.

System bus 2614 can be coupled to memory 2608, which can include both read only memory (ROM) and random access memory (RAM). In the depicted embodiment of FIG. 26, various I/O devices such as a flash controller 2604, a graphics adapter 2624, a touchscreen adapter 2626, a network adapter 2620, and other I/O devices 2622 can be coupled to system bus 2614. Touchscreen adapter 2626 can be coupled to touchscreen 2504 (FIGS. 25-26). Flash controller 2604 can control flash memory 2616.

Although many other components of tablet computing device 2500 (FIG. 25) are not shown, such components and their interconnection are well known to those of ordinary skill in the art. Accordingly, further details concerning the construction and composition of tablet computing device 2500 and the circuit boards inside chassis 2502 (FIG. 25) need not be discussed herein.

When tablet computing device 2500 in FIG. 25 is running, program instructions stored in non-transitory memory, such as in flash memory 2616 (FIG. 26) or in non-volatile memory 2608 (FIG. 26) can be executed by processor 2610 (FIG. 26). A portion of the program instructions, stored on these devices, can be suitable for carrying out the methods and/or implementing the user interface described herein.

Implementing user device 110-114 (FIG. 1) as a tablet computing device, such as tablet computing device 2500, can advantageously provide numerous benefits for conducting meetings with the meeting management application. For example, tablet computing devices (e.g., 2500) can be small, portable, and easy to use while holding in one hand and operating with the other hand. In addition, tablet computing devices (e.g., 2500) are generally very quiet, which can beneficially eliminate undesirable noise in meetings. Tablet computing devices (e.g., 2500) can also provide long battery life, which can be ideal for long meetings, such as all-day meetings. Moreover, tablet computing devices (e.g., 2500) can generally be turned on rapidly for use, which can prevent undesirable delays during meetings. In addition, the touchscreen (e.g., 2504) of tablet computing devices (e.g., 2500) can beneficially allow for rapid, straightforward, and precise pointing, selection, and/or drag-and- drop functionality. In many embodiments, the operating system of the touchscreen can run software applications in a full-screen, non-windowed environment, which can advantageously facilitate keeping the attention of meeting participants on the current topic of discussion.

Although tablet computing device 2500 is illustrated as a tablet computing device in FIG. 25, in many embodiments 110-114 (FIG. 1) and/or server 120 (FIG. 1) may take a different form factor (e.g., a mobile smartphone, a laptop computer, etc.) while still having functional elements similar to those described for tablet computing device 2500. In some embodiments, tablet computing device 2500 may comprise a single computer, a single server, or a cluster or collection of computers or servers, or a cloud of computers or servers. Typically, a cluster or collection of servers can be used when the demand on tablet computing device 2500 exceeds the reasonable capability of a single server or computer.

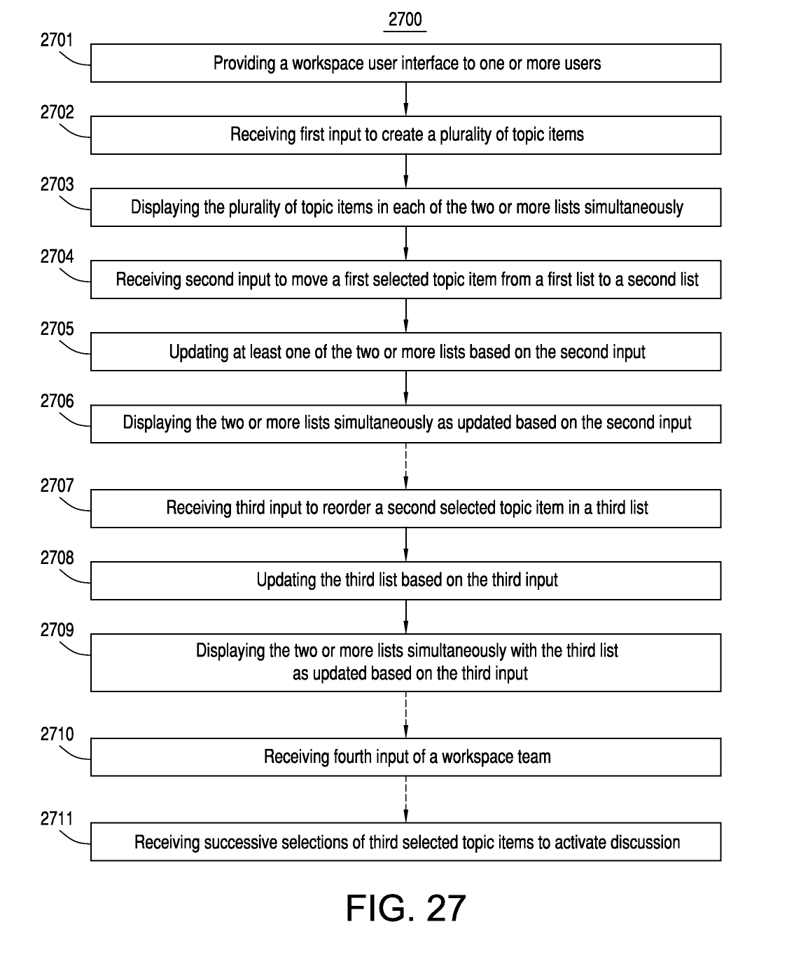

Turning ahead in the drawings, FIG. 27 illustrates a flow chart for a method 2700 of collaboratively planning a meeting, according to an embodiment. Method 2700 is merely exemplary and is not limited to the embodiments presented herein. Method 2700 can be employed in many different embodiments or examples not specifically depicted or described herein. In some embodiments, the procedures, the processes, and/or the activities of method 2700 can be performed in the order presented. In other embodiments, the procedures, the processes, and/or the activities of method 2700 can be performed in any suitable order. In still other embodiments, one or more of the procedures, the processes, and/or the activities of method 2700 can be combined or skipped.

Referring to FIG. 27, method 2700 can include a block 2701 of providing a workspace user interface to one or more users for the meeting. In a number of embodiments, the workspace user interface can be similar or identical to user interface displays 200 (FIG. 2), 300 (FIG. 3A), 301 (FIG. 3B), 400 (FIG. 4), 500 (FIG. 5), 600 (FIG. 6), 700 (FIG. 7), 800 (FIG. 8), 900 (FIG. 9), 1000 (FIG. 10), 1100 (FIG. 11), 1200 (FIG. 12), 1300 (FIG. 13), 1400 (FIG. 14A), 1401 (FIG. 14B), 1500 (FIG. 15), 1600 (FIG. 16), 1700 (FIG. 17), 1800 (FIG. 18A), 1801 (FIG. 18B), 1900 (FIG. 19), 2000 (FIG. 20), 2100 (FIG. 21), 2200 (FIG. 22), 2300 (FIG. 23), 2400 (FIG. 24), and/or collaborative planner 305 (FIGS. 3A, 3B, 4, 6, 15, 16, 18A, 18B, 21). In some embodiments, the workspace user interface can be configured to be used in planning the meeting prior to the meeting, in conducting the meeting during the meeting, and in reviewing the meeting after the meeting. In a number of embodiments, the workspace user interface can include two or more lists. The two or more lists can include a queue and an agenda list. The queue can be similar or identical to queue 320 (FIGS. 3A, 3B, 6, 16, 18A, 18B, 21). The agenda list can be similar or identical to agenda list 330 (FIGS. 3A, 3B, 6, 16, 18A, 18B, 21). In some embodiments, the two or more lists can further include a past meeting list. The past meeting list can be similar or identical to past meeting list 310 (FIGS. 3B, 6, 18B, 21). In a number of embodiments, the workspace user interface can be configured to allow the one or more users to selectively toggle between displaying or hiding the past meeting list on the workspace user interface, such as through past meeting list display button 302 (FIGS. 3A, 3B, 18A, 18B). In some embodiments, the plurality of topic items that are in the past meeting list can include a record of topics discussed and/or skipped in one or more past meetings.

In several embodiments, the one or more users can be similar or identical to user 414 (FIG. 4) and can use user devices, such as user devices 110-114 (FIG. 1). In some embodiments, providing the workspace user interface to the one or more users can include providing the workspace user interface to each of two or more users. In a number of embodiments, communication between the two or more users can be provided through a central server in data communication with devices for the two or more users. The central server can be similar or identical to server 120 (FIG. 1). The devices can be similar or identical to user devices 110-114 (FIG. 1). In several embodiments, the workspace user interfaces for the two or more users can run on the devices.

In many embodiments, method 2700 additionally can include a block 2702 of receiving from the one or more users a first input though the workspace user interface to create a plurality of topic items in the two or more lists. The topic items can be similar or identical to topic items 311-313 (FIGS. 3A, 3B), topic items 650 (FIG. 6), break item 1831 (FIGS. 18A, 18B)), and/or topic items 1832-1835 (FIGS. 18A, 18B). In a number of embodiments, each of the plurality of topic items can include a topic description for a meeting topic. The topic description can be similar or identical to topic description 314. In several embodiments, each of the plurality of topic items can be in at least one of the two or more lists. In certain embodiments, receiving from the one or more users the first input can include receiving from a first user of the two or more users the first input through the workspace user interface of the first user to create the plurality of topic items in the two or more lists. In a number of embodiments, the first input to create the plurality of topic items can include, for each of the plurality of topic items, a click or gesture to add a new topic and the topic description. For example, the user can click on or selected new queue topic item button 327 (FIGS. 3A, 3B) and/or new agenda item button 1637 (FIG. 16). In some embodiments, one or more of the plurality of topic items can each further include a designated presenter and a designated time budget. The designated presenter can be similar or identical to topic presenter 316 (FIG. 3A). The designated time budget can be similar or identical to topic time budget 315 (FIG. 3A). In a number of embodiments, the first input to the create the plurality of topic items can include, for each of the one or more of the plurality of topics, the designated presenter and the designated time budget. For example, the topic items can be created using new topic item form 510, as shown in FIG. 5 and described above. In some embodiments, the workspace user interface can be configured to display a start time for each of the plurality of topic items that are in the agenda list. For example, the start times can be shown on an agenda status bar, such as agenda status bar 1510 (FIGS. 15, 16, 18A, 18B), which can include start times and/or status indicators, such as status indicators 1811-1815 (FIGS. 18A, 18B).

In several embodiments, method 2700 further can include a block 2703 of displaying on the workspace user interface the plurality of topic items in each of the two or more lists simultaneously. For example, the topic items can be displayed in each of the two lists simultaneously, as shown in FIGS. 3A, 3B, 18A, and 18B. In a number of embodiments, displaying on the workspace user interface the plurality of topic items in each of the two or more lists simultaneously can include displaying on each of the workspace user interfaces of the two or more users the plurality of topic items in each of the two or more lists simultaneously based on the first input.

In many embodiments, method 2700 additionally can include a block 2704 of receiving from the one or more users a second input through the workspace user interface to move a first selected topic item of the plurality of topic items from a first list of the two or more lists to a second list of the two or more lists. For example, the first selected topic item can be similar or identical to topic item 650 and can be moved from a first list of the two or more lists to a second list of the two or more lists, such as shown in FIG. 6 and described above. In many embodiments, the first list can be different from the second list. In a number of embodiments, the second list can be the queue or the agenda list. In some embodiments, receiving from the one or more users the second input can include receiving from a second user of the two or more users the second input through the workspace user interface of the second user to move the first selected topic item of the plurality of topic items from the first list of the two or more lists to the second list of the two or more lists. In various embodiments, the second user can be the same as the first user or different from the first user. In a number of embodiments, the second input to move the first selected topic item can include a drag of the first selected topic item from the first list to the second list.

In several embodiments, method 2700 further can include a block 2705 of updating at least one of the two or more lists based on the second input. In some embodiments, updating the at least one of the two or more lists based on the second input can include, if the first list is one of the queue or the agenda list, removing the first selected topic item from the first list and adding the first selected topic item to the second list, and if the first list is the past meeting list, copying the first selected topic item from the first list and adding the first selected topic item to the second list.

In many embodiments, method 2700 additionally can include a block 2706 of displaying on the workspace user interface the two or more lists simultaneously as updated based on the second input. In some embodiments, displaying on the workspace user interface the two or more lists simultaneously as updated based on the second input can include displaying on each of the workspace user interfaces of the two or more users the two or more lists simultaneously as updated based on the second input

In several embodiments, method 2700 can optionally include a block 2707 of receiving from the one or more users a third input through the workspace user interface to reorder a second selected topic item of the plurality of topic items in a third list of the two or more lists. For example, the second selected topic item can be similar or identical to topic item 650 and can be reordered in the third list, such as shown in FIG. 6 and described above. In certain embodiments, the third input to reorder the second selected topic item can include a drag of the second selected topic item within the third list. In a number of embodiments, the third list can be the queue or the agenda list. In some embodiments, receiving from the one or more users the third input can include receiving from a first user of the two or more users the third input through the workspace user interface to reorder a second selected topic item of the plurality of topic items in the third list of the two or more lists.

In many embodiments, method 2700 additionally can include a block 2708 of updating the third list of the two or more lists based on the third input to reorder the second selected topic item in the third list.

In several embodiments, method 2700 further can include a block 2709 of displaying on the workspace user interface the two or more lists simultaneously with the third list as updated based on the third input. In some embodiments, displaying on the workspace user interface the two or more lists simultaneously with the third list as updated based on the third input can include, if the third list is the agenda list, displaying on each of the workspace user interfaces of the two or more users the two or more lists simultaneously with the third list as updated based on the third input, and if the third list is the queue, displaying only on the workspace user interface of the first user of the two or more users the two or more lists simultaneously with the third list as updated based on the third input. In a number of embodiments, the workspace user interface of a workspace owner can be configured to receive information from the workspace user interfaces of each of the two or more users regarding an ordering of topics on the queue on the workspace user interface of each of the two or more users.

In many embodiments, method 2700 can optionally include a block 2710 of receiving a fourth input of a workspace team for the workspace user interface. The workspace team can be similar or identical to the workspace team listed in team listing 410 (FIG. 4). In a number of embodiments, the fourth input can be received such as through ad user button 412 (FIG. 4). The workspace team can include the one or more users.

In several embodiments, method 2700 can optionally include a block 2711 of receiving during the meeting through the workplace user interface successive selections of third selected topic items from among the plurality of topic items that are in the agenda list to activate discussion regarding the third selected topic items according to an order of the successive selections of the third selected topic items. The third selected topic items can be similar or identical to break item 1831, topic item 1832, and/or topic item 1833, as shown in FIGS. 18A and 18B, and/or the order of the successive selections of the third selected topic items can be the order shown in FIGS. 18A and 18B. In a number of embodiments, selecting each of the third selected topic items in the agenda list to activate discussion can result in displaying the topic item view, such as topic item view 1910 (FIG. 19), so as to facilitate discussion related to each of the third selected topic items. In some embodiments, the workspace user interface can be configured to allow the order of the successive selections of the third selected topic items to be different from a list order of the agenda list. In a number of embodiments, the workspace user interface can be configured to allow a fourth selected topic item in the queue to be moved to the agenda list during the live meeting. The fourth selected topic item can be similar to topic item 650 and can be moved from the queue to the agenda list, such as shown in FIG. 6 and described above. In some embodiments, the workspace user interface can be configured to allow the fourth selected topic item to be selected from among the third selected topic items to activate discussion regarding the fourth selected topic item during the meeting. For example, after the fourth selected topic item has been moved to the agenda list during the meeting, the fourth selected topic item can be selected to activate discussion related to the fourth selected topic item. In a number of embodiments, during the meeting, each of the third selected topic items can include at least one of a record of time budgeted, a budgeted time remaining, or an actual time spent on discussion related to the third selected topic item. For example, the record of time budgeted can be similar or identical to topic time budget field 1914 (FIG. 19). The budgeted time remaining can be similar or identical to topic timer 1950 (FIG. 19). The actual time spend on discussion can be similar or identical to status indicators 1811-1813 (FIGS. 18A, 18B).

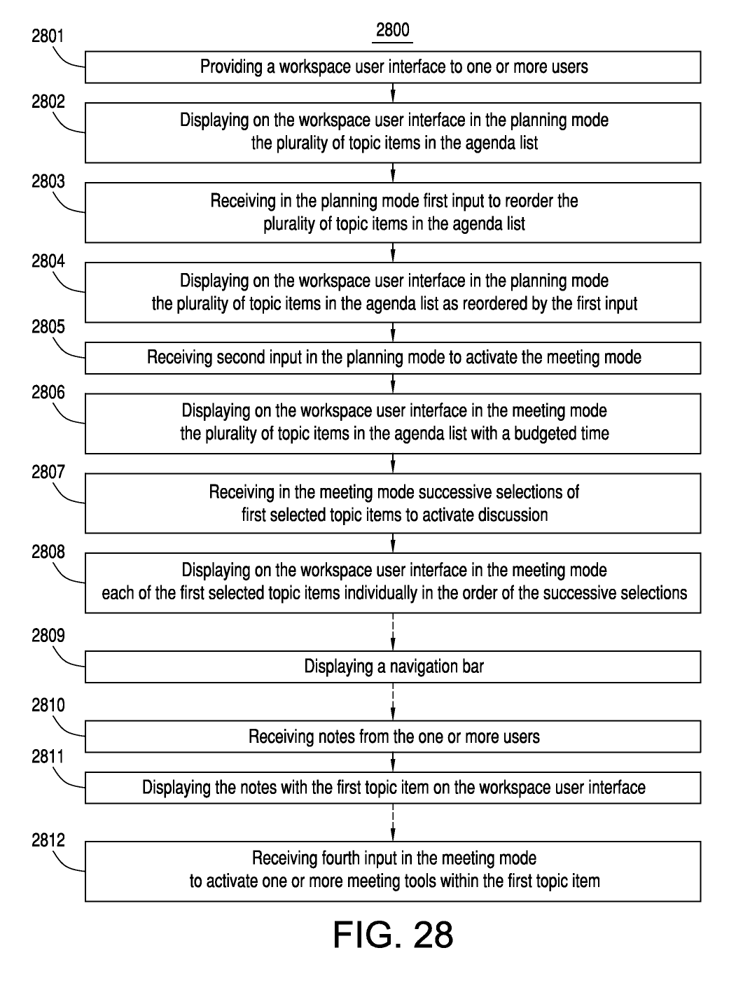

Turning ahead in the drawings, FIG. 28 illustrates a flow chart for a method 2800 of managing a meeting, according to an embodiment. Method 2800 is merely exemplary and is not limited to the embodiments presented herein. Method 2800 can be employed in many different embodiments or examples not specifically depicted or described herein. In some embodiments, the procedures, the processes, and/or the activities of method 2800 can be performed in the order presented. In other embodiments, the procedures, the processes, and/or the activities of method 2800 can be performed in any suitable order. In still other embodiments, one or more of the procedures, the processes, and/or the activities of method 2800 can be combined or skipped.

Referring to FIG. 28, method 2800 can include a block 2801 of providing a workspace user interface to one or more users for the meeting. In a number of embodiments, the workspace user interface can be similar or identical to user interface displays 200 (FIG. 2), 300 (FIG. 3A), 301 (FIG. 3B), 400 (FIG. 4), 500 (FIG. 5), 600 (FIG. 6), 700 (FIG. 7), 800 (FIG. 8), 900 (FIG. 9), 1000 (FIG. 10), 1100 (FIG. 11), 1200 (FIG. 12), 1300 (FIG. 13), 1400 (FIG. 14A), 1401 (FIG. 14B), 1500 (FIG. 15), 1600 (FIG. 16), 1700 (FIG. 17), 1800 (FIG. 18A), 1801 (FIG. 18B), 1900 (FIG. 19), 2000 (FIG. 20), 2100 (FIG. 21), 2200 (FIG. 22), 2300 (FIG. 23), 2400 (FIG. 24), and/or collaborative planner 305 (FIGS. 3A, 3B, 4, 6, 15, 16, 18A, 18B, 21). In some embodiments, the workspace user interface can include a plurality of topic items in an agenda list. The agenda list can be similar or identical to agenda list 330 (FIGS. 3A, 3B, 6, 16, 18A, 18B, 21).

The topic items can be similar or identical to topic items 311-313 (FIGS. 3A, 3B), topic items 650 (FIG. 6), and/or topic items 1832-1835 (FIGS. 18A, 18B). In some embodiments, the plurality of topic items in the agenda list can include at least one break item. The break item can be similar or identical to break item 1831 (FIGS. 18A, 18B)). In a number of embodiments, the at least one break item can include at least one of a restroom break type, a stretch break type, a snack break type, a meal break type, or a drink break type. The restroom break type can be similar or identical to restroom break type 1721 (FIG. 17). The stretch break type can be similar or identical to stretch break type 1722 (FIG. 17). The snack break type can be similar or identical to snack break type 1723 (FIG. 17). The meal break type can be similar or identical to meal break type 1724 (FIG. 17). The drink break type can be similar or identical to drink break type 1725 (FIG. 17).

In a number of embodiments, the workspace user interface can include a planning mode and a meeting mode. The meeting mode can be similar to the live meeting mode shown in FIGS. 18A, 18B, and 19, and described above. The planning mode can be the mode of operation of the workspace user interface when operating other than in the live meeting mode.

In many embodiments, method 2800 additionally can include a block 2802 of displaying on the workspace user interface of each of the one or more users in the planning mode the plurality of topic items in the agenda list. For example, the topic items can be displayed in the agenda list, as shown in FIGS. 3A, 3B, and 6.

In several embodiments, method 2800 further can include a block 2803 of receiving from the one or more users through the workspace user interface in the planning mode a first input to reorder the plurality of topic items in the agenda list. For example, the first input can be similar or identical to selecting topic item 650 to be reordered in the agenda list, similarly as shown in FIG. 6 and described above.

In many embodiments, method 2800 additionally can include a block 2804 of displaying on the workspace user interface of each of the one or more users in the planning mode the plurality of topic items in the agenda list as reordered by the first input.

In several embodiments, method 2800 further can include a block 2805 of receiving from one of the one or more users a second input though the workspace user interface in the planning mode to activate the meeting mode. In some embodiments, the second input can be similar or identical to selecting start button 1540, as shown in FIG. 15, and described above.

In many embodiments, method 2800 additionally can include a block 2806 of displaying on the workspace user interface of each of the one or more users in the meeting mode the plurality of topic items in the agenda list with a budgeted time for each of the plurality of topic items. For example, the budgeted time can be similar or identical to topic time budget 315 (FIG. 3A), and can be shown in the meeting mode, as shown in FIGS. 18A and 18B. In some embodiments, the workspace user interface can be configured to display a start time for each of the plurality of topic items in the agenda list based at least in part on the budgeted time for each of the plurality of topic items in the agenda list. For example, the start time can be shown on an agenda status bar, such as agenda status bar 1510 (FIGS. 15, 16, 18A, 18B), which can include start times and/or status indicators, such as status indicators 1811-1815 (FIGS. 18A, 18B).

In several embodiments, method 2800 further can include a block 2807 of receiving from one of the one or more users through the workplace user interface in the meeting mode successive selections of first selected topic items from among the plurality of topic items in the agenda list to activate discussion regarding the first selected topic items according to an order of the successive selections of the first selected topic items. In some embodiments, the first selected topic items can be similar or identical to break item 1831, topic item 1832, and/or topic item 1833, as shown in FIGS. 18A and 18B, and/or the order of the successive selections of the first selected topic items can be the order shown in FIGS. 18A and 18B. In a number of embodiments, selecting each of the first selected topic items in the agenda list to activate discussion can result in displaying the topic item view, such as topic item view 1910 (FIG. 19), so as to facilitate discussion related to each of the third selected topic items. In various embodiments, the workspace user interface can be configured to allow the order of the successive selections of the first selected topic items to be different from a list order of the agenda list provided by the first input.

In many embodiments, method 2800 additionally can include a block 2808 of displaying on the workspace user interface of each of the one or more users in the meeting mode each of the first selected topic items individually in the order of the successive selections of the first selected topic items along with at least one of an amount of budgeted time remaining or actual times spent on discussions related to each of the first selected topic items. For example, the budgeted time remaining can be similar or identical to topic timer 1950 (FIG. 19). The actual times spent on discussions can be similar or identical to status indicators 1811-1813 (FIGS. 18A, 18B). In a number of embodiments, the workspace user interface can be configured to update the start time for remaining topic items of the plurality of topic items in the agenda list based on the actual time spent on discussion for discussed topic items of the plurality of topic items in the agenda list. For example, discussed item can be similar or identical to break item 1831 (FIGS. 18A, 18B), topic item 1832 (FIGS. 18A, 18B), and/or topic item 1833 (FIGS. 18A, 18B), and/or the updated start times can be shown on the agenda status bar, such as agenda status bar 1510 (FIGS. 15, 16, 18A, 18B), which can include updated start times such as in status indicators 1814-1815 (FIGS. 18A, 18B).

In several embodiments, method 2800 optionally can include a block 2809 of, upon receiving a third input from one of the one or more users to navigate away from the workspace user interface in the meeting mode, displaying a navigation bar that is configured to allow returning to the workspace user interface in the meeting mode with a single action. The navigation bar can be similar or identical to navigation return bar 2220 (FIG. 22) and/or navigation return bar 2230 (FIG. 23).

In many embodiments, method 2800 optionally can include a block 2810 of, while displaying at least a first topic item of the first selected topic items individually, receiving notes from the one or more users. The first topic item can be displayed individually, such as shown in topic item view 710 (FIG. 7) and/or or topic item view 1910 (FIG. 19), as described above. The notes can be received such as by selecting group notes button 715 (FIG. 7).

In several embodiments, method 2800 additionally can include a block 2811 of displaying the notes from the one or more users with the first topic item on the workspace user interface of each of the one or more users as the notes are received from the one or more users. The notes can be similar or identical to group notes 721-723 (FIG. 7) and/or group notes 1921-1924, and can be displayed with the first topic item as shown in FIG. 7 and/or FIG. 19. For example, the notes can be displayed similarly to artifact stream display 720 (FIG. 7). In a number of embodiments, the workspace user interface can be configured to display the notes with a tagging taxonomy. For example, the tagging taxonomy can be a hashtag taxonomy, as described above.

In many embodiments, method 2800 optionally can include a block 2812 of, while displaying a first topic item of the first selected topic items individually, receiving a fourth input from one or more users though the workspace user interface in the meeting mode to activate one or more meeting tools within the first topic item. The meeting tools can be similar or identical to the meeting tools discussed above, such as the browser tool (as can be created through meeting tool selection 811 (FIG. 8)), the Dropbox tool (as can be created through meeting tool selection 812 (FIG. 8)), the go round tool (as can be created through meeting tool selection 813 (FIG. 8) and go round form 1010 (FIG. 10), and deployed as shown in go round event 1110 (FIG. 11)), the presenter notes tool (as can be created through meeting tool selection 814 (FIG. 8) and presenter notes form 910 (FIG. 9)), the pulse tool (as can be created through meeting tool selection 815 (FIG. 8), pulse selection list 1210 (FIG. 12), and pulse form 1310 (FIG. 13), and deployed as shown in pulse event 1410 (FIGS. 14A, 14B)), among others. In a number of embodiments, the workspace user interface can be configured to allow the one or more meeting tools to be created in the first topic item during the planning mode and to allow the one or more meeting tools to be created in the first topic item during the meeting mode.

In several embodiments, the one or more meeting tools can include a presenter notes tool. The presenter notes tool can be similar or identical to the presenter notes tool shown in presenter notes form 910 (FIG. 9). The presenter notes tool can be configured to allow a presenter of the one or more users to record and view presentation notes both in the planning mode and in the meeting mode. The presentation notes can be similar or identical to presentation notes 912 (FIG. 9). In many embodiments, the one or more meeting tools can include a go round tool. The go round tool can be similar or identical to the go round tool shown in go round form 1010 (FIG. 10) and go round event 1110 (FIG. 11). The go round tool can be configured to provide each of the one or more users with a designated amount of time to speak by displaying each of the one or more users successively with an elapsed time for each of the one or more users. The designated amount of time to speak can be similar or identical to speaker time budget field 1013 (FIG. 10). The elapsed time can be similar or identical to timer field 1141 (FIG. 11). The display of the users can be similar or identical to speaker field 1140 (FIG. 11). In several embodiments, the one or more meeting tools can include a pulse tool. The pulse tool can be similar or identical to the pulse tool shown in pulse form 1310 (FIG. 13) and deployed as shown in pulse event 1410 (FIGS. 14A, 14B). The pulse tool can be configured to allow each of the one or more users, in response to a prompt, to select a response from a set of predetermined possible responses. The prompt can be similar or identical to prompt 1312 (FIG. 13) and/or prompt 1412 (FIGS. 14A, 14B). The set of predetermined possible responses can be similar of identical to answer choices 1313 (FIG. 13) and/or answer choices 1413 (FIGS. 14A, 14B). The response can be similar or identical to vote indicators 1441, 1443, 1444, 1445, and/or 1446.

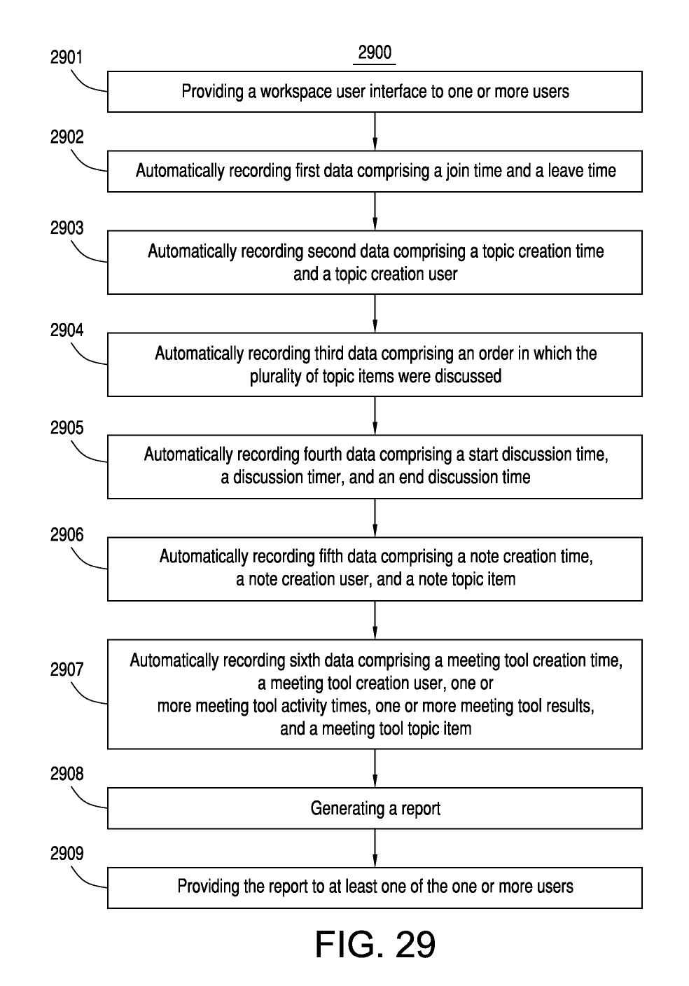

Turning ahead in the drawings, FIG. 29 illustrates a flow chart for a method 2900 of tracking a meeting, according to an embodiment. Method 2900 is merely exemplary and is not limited to the embodiments presented herein. Method 2900 can be employed in many different embodiments or examples not specifically depicted or described herein. In some embodiments, the procedures, the processes, and/or the activities of method 2900 can be performed in the order presented. In other embodiments, the procedures, the processes, and/or the activities of method 2900 can be performed in any suitable order. In still other embodiments, one or more of the procedures, the processes, and/or the activities of method 2900 can be combined or skipped.

Referring to FIG. 29, method 2900 can include a block 2901 of providing a workspace user interface to one or more users for the meeting. In a number of embodiments, the workspace user interface can be similar or identical to user interface displays 200 (FIG. 2), 300 (FIG. 3A), 301 (FIG. 3B), 400 (FIG. 4), 500 (FIG. 5), 600 (FIG. 6), 700 (FIG. 7), 800 (FIG. 8), 900 (FIG. 9), 1000 (FIG. 10), 1100 (FIG. 11), 1200 (FIG. 12), 1300 (FIG. 13), 1400 (FIG. 14A), 1401 (FIG. 14B), 1500 (FIG. 15), 1600 (FIG. 16), 1700 (FIG. 17), 1800 (FIG. 18A), 1801 (FIG. 18B), 1900 (FIG. 19), 2000 (FIG. 20), 2100 (FIG. 21), 2200 (FIG. 22), 2300 (FIG. 23), 2400 (FIG. 24), and/or collaborative planner 305 (FIGS. 3A, 3B, 4, 6, 15, 16, 18A, 18B, 21). In some embodiments, the workspace user interface can include a plurality of topic items in one or more lists. The two or more lists can include a queue, an agenda list, and/or a past meeting list. The queue can be similar or identical to queue 320 (FIGS. 3A, 3B, 6, 16, 18A, 18B, 21). The agenda list can be similar or identical to agenda list 330 (FIGS. 3A, 3B, 6, 16, 18A, 18B, 21). The past meeting list can be similar or identical to past meeting list 310 (FIGS. 3B, 6, 18B, 21).

The topic items can be similar or identical to topic items 311-313 (FIGS. 3A, 3B), topic items 650 (FIG. 6), and/or topic items 1832-1835 (FIGS. 18A, 18B). In some embodiments, the plurality of topic items in the agenda list can include at least one break item. The break item can be similar or identical to break item 1831 (FIGS. 18A, 18B)). In a number of embodiments, the workspace user interface can include a planning mode and a meeting mode. The meeting mode can be similar to the live meeting mode shown in FIGS. 18A, 18B, and 19, and described above. The planning mode can be the mode of operation of the workspace user interface when operating other than in the live meeting mode.

In some embodiments, when each of the plurality of topic items is accessed for discussion at the meeting, the discussion timer can begin after a first predetermined time threshold of at least three seconds. In a number of embodiments, the topic items can be accessed for discussed such as shown in topic item view 1910 (FIG. 19), so as to facilitate discussion related to each of the topic items. In some embodiments, the first predetermined time can be similar or identical to the pre-roll period, as described above. In many embodiments, if a topic item of the plurality of topic items is accessed for discussion at the meeting during a first discussion period that ends within a second predetermined time threshold, a record of the first discussion period can be purged and the discussion timer can revert and as though the first discussion period did not occur. The second predetermined time threshold can be similar or identical to the undo period described above. In various embodiments, the second predetermined time threshold can be greater than the first predetermined time threshold.

In many embodiments, method 2900 additionally can include a block 2902 of automatically recording first data including a join time and a leave time associated with each of the one or more users when the workspace user interface is in the meeting mode. For example, the join time can be the time in which a user joined the meeting during the meeting mode. The leave time can be the time in which a user left the meeting during the meeting mode.

In several embodiments, method 2900 further can include a block 2903 of automatically recording second data including a topic creation time and a topic creation user of the one or more users for each of the plurality of topic items when the workspace user interface is in either the planning mode or the meeting mode. For example, the topic creation time can be the time in which a user create a topic item, such as through topic item form 510. The topic creation time can be logged and/or displayed such as in group note 721, which shows when the topic item displayed in topic item view 710 was created.

In many embodiments, method 2900 additionally can include a block 2904 of automatically recording third data including an order in which the plurality of topic items were discussed when the workspace user interface is in the meeting mode. For example, the order can be similar or identical to the order of break item 1831, topic item 1832, and/or topic item 1833, as shown in FIGS. 18A and 18B.

In several embodiments, method 2900 further can include a block 2905 of automatically recording fourth data including a start discussion time and a discussion timer for each of the plurality of topic items that were discussed when the workspace user interface is in the meeting mode. The start discussion time can be the time in which discussion began, such as shown in topic item view 1910 (FIG. 19). The discussion time can be similar or identical to topic timer 1950 (FIG. 19).

In many embodiments, method 2900 additionally can include a block 2906 of automatically recording fifth data including a note creation time, a note creation user of the one or more users, and a note topic item of the plurality of topic items for each of one or more notes created by the one or more users when the workspace user interface is in either the planning mode or the meeting mode and associated with the note topic item. The notes can be similar or identical to group notes 721-723 (FIG. 7) and/or group notes 1921-1924. The note creation time can be the time in which the note was create. The note creation user can be the user who created the note. The note topic item can be the topic item in which the note was created.

In several embodiments, method 2900 further can include a block 2907 of automatically recording sixth data including a meeting tool creation time, a meeting tool creation user of the one or more users, one or more meeting tool activity times, one or more meeting tool results, and a meeting tool topic item of the plurality of topic items for each of one or more meeting tools created by the one or more users and associated with the meeting tool topic item. The meeting tools can be similar or identical to the meeting tools discussed above, such as the browser tool (as can be created through meeting tool selection 811 (FIG. 8)), the Dropbox tool (as can be created through meeting tool selection 812 (FIG. 8)), the go round tool (as can be created through meeting tool selection 813 (FIG. 8) and go round form 1010 (FIG. 10), and deployed as shown in go round event 1110 (FIG. 11)), the presenter notes tool (as can be created through meeting tool selection 814 (FIG. 8) and presenter notes form 910 (FIG. 9)), the pulse tool (as can be created through meeting tool selection 815 (FIG. 8), pulse selection list 1210 (FIG. 12), and pulse form 1310 (FIG. 13), and deployed as shown in pulse event 1410 (FIGS. 14A, 14B)), among others. The meeting tool creation time can be the time in which the meeting tool was created, such as shown in go round event 1110 (FIG. 11). The meeting tool creation user can be the user that created the meeting tool. The meeting tool activity timers can be similar or identical to timer field 1141 (FIG. 11), as an example. The one or more meeting tool results can be similar or identical to vote indicators 1441, 1443, 1444, 1445, and/or 1446, as an example. The meeting tool topic item can be the topic item in which the meeting tool was created.

In many embodiments, method 2900 additionally can include a block 2908 of generating a report. In some embodiments, the report can be similar or identical to formatted document 2420 (FIG. 24), described above. In a number of embodiments, the report can include at least a portion of the first, second, third, fourth, fifth, and sixth data. In some embodiments, generating the report can include generating a summary of at least a portion of the first, second, third, fourth, fifth, and sixth data. The summary can be similar or identical to summary information 2112 (FIG. 21) and/or the summary of formatted document 2420 (FIG. 24). In some embodiments, generating the report can include generating the report according to report content settings selected by at least one of the one or more users. The report content settings can be the content setting in content settings list 2410 (FIG. 24), such as schedule setting 2411 (FIG. 24), notes setting 2412 (FIG. 24), tools setting 2413 (FIG. 24), tags setting 2414 (FIG. 24), and team setting 2415 (FIG. 24). In certain embodiments, generating the report further can include displaying a preview of the report based on the report content settings. The preview of the report can be similar or identical to the preview of formatted document 2420, as shown in FIG. 24 and described above. In a number of embodiments, generating the report can include displaying the note creation time and the note creation user of the fifth data in context with the note topic item. For example, the note creation time and the note creation user of a note can be shown in the context with displaying the note topic item in which the note was added. In many embodiments, generating the report can include displaying the meeting tool creation time, the meeting tool creation user, the one or more meeting tool activity times, and the one or more meeting tool results of the sixth data in context with the meeting tool topic item. For example, meeting tool creation time, the meeting tool creation user, the one or more meeting tool activity times, and the one or more meeting tool results of a meeting tool can be shown in the context with displaying the meeting tool topic item in which the meeting tool was added. In some embodiments, generating the report can include generating analytical information derived from at least a portion of the first, second, third, fourth, fifth, and sixth data. For example, the analytical information can be derived based on the data recorded. In some embodiments, the analytical information can be derived from information recorded across multiple meetings. In some embodiments, the report further can include the analytical information.

In several embodiments, method 2900 further can include a block 2909 of providing the report to at least one of the one or more users. For example, the report can be provided to other users such as through share button 2402 (FIG. 24).

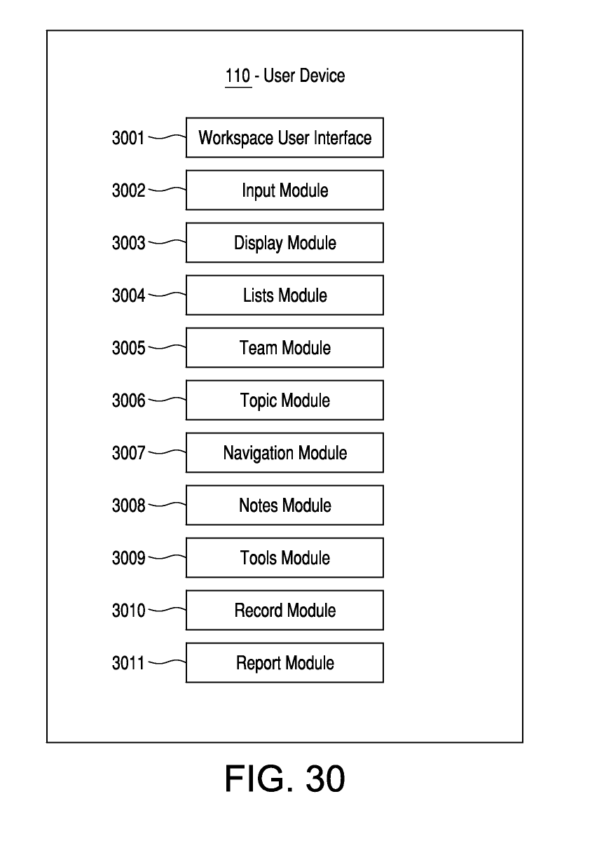

Turning ahead in the drawings, FIG. 30 illustrates a block diagram of user device 110, according to the embodiment shown in FIG. 1. User device 110 and the modules therein are merely exemplary and are not limited to the embodiments presented herein. User device 110 can be employed in many different embodiments or examples not specifically depicted or described herein. In some embodiments, certain elements or modules of user device 110 can perform various procedures, processes, and/or acts. In other embodiments, the procedures, processes, and/or acts can be performed by other suitable elements or modules. User devices 111-114 (FIG. 1) can be similar or identical to user device 110, and can include the elements or modules included in user device 110, as shown in FIG. 30.

In some embodiments, user device 110 can include a workspace user interface 3001. In certain embodiments, the workspace user interface can be similar or identical to user interface displays 200 (FIG. 2), 300 (FIG. 3A), 301 (FIG. 3B), 400 (FIG. 4), 500 (FIG. 5), 600 (FIG. 6), 700 (FIG. 7), 800 (FIG. 8), 900 (FIG. 9), 1000 (FIG. 10), 1100 (FIG. 11), 1200 (FIG. 12), 1300 (FIG. 13), 1400 (FIG. 14A), 1401 (FIG. 14B), 1500 (FIG. 15), 1600 (FIG. 16), 1700 (FIG. 17), 1800 (FIG. 18A), 1801 (FIG. 18B), 1900 (FIG. 19), 2000 (FIG. 20), 2100 (FIG. 21), 2200 (FIG. 22), 2300 (FIG. 23), 2400 (FIG. 24), and/or collaborative planner 305 (FIGS. 3A, 3B, 4, 6, 15, 16, 18A, 18B, 21).

In many embodiments, user device 110 can include an input module 3002. In certain embodiments, input module 3002 can at least partially perform block 2702 (FIG. 27) of receiving from the one or more users a first input though the workspace user interface to create a plurality of topic items in the two or more lists, block 2704 (FIG. 27) of receiving from the one or more users a second input through the workspace user interface to move a first selected topic item of the plurality of topic items from a first list of the two or more lists to a second list of the two or more lists, block 2707 (FIG. 27) of receiving from the one or more users a third input through the workspace user interface to reorder a second selected topic item of the plurality of topic items in a third list of the two or more lists, block 2711 (FIG. 27) of receiving during the meeting through the workplace user interface successive selections of third selected topic items from among the plurality of topic items that are in the agenda list to activate discussion regarding the third selected topic items according to an order of the successive selections of the third selected topic items, block 2803 (FIG. 28) of receiving from the one or more users through the workspace user interface in the planning mode a first input to reorder the plurality of topic items in the agenda list, block 2805 (FIG. 28) of receiving from one of the one or more users a second input though the workspace user interface in the planning mode to activate the meeting mode, block 2807 (FIG. 28) of receiving from one of the one or more users through the workplace user interface in the meeting mode successive selections of first selected topic items from among the plurality of topic items in the agenda list to activate discussion regarding the first selected topic items according to an order of the successive selections of the first selected topic items, block 2809 (FIG. 28) of, upon receiving a third input from one of the one or more users to navigate away from the workspace user interface in the meeting mode, displaying a navigation bar that is configured to allow returning to the workspace user interface in the meeting mode with a single action, block 2810 (FIG. 28) of, while displaying at least a first topic item of the first selected topic items individually, receiving notes from the one or more users, and/or block 2812 (FIG. 28) of, while displaying a first topic item of the first selected topic items individually, receiving a fourth input from one or more users though the workspace user interface in the meeting mode to activate one or more meeting tools within the first topic item.

In a number of embodiments, user device 110 can include a display module 3003. In certain embodiments, display module 3003 can at least partially perform block 2703 (FIG. 27) of displaying on the workspace user interface the plurality of topic items in each of the two or more lists simultaneously, block 2706 (FIG. 27) of displaying on the workspace user interface the two or more lists simultaneously as updated based on the second input, block 2709 (FIG. 27) of displaying on the workspace user interface the two or more lists simultaneously with the third list as updated based on the third input, block 2802 (FIG. 28) of displaying on the workspace user interface of each of the one or more users in the planning mode the plurality of topic items in the agenda list, block 2804 (FIG. 28) of displaying on the workspace user interface of each of the one or more users in the planning mode the plurality of topic items in the agenda list as reordered by the first input, block 2806 (FIG. 28) of displaying on the workspace user interface of each of the one or more users in the meeting mode the plurality of topic items in the agenda list with a budgeted time for each of the plurality of topic items, block 2808 (FIG. 28) of displaying on the workspace user interface of each of the one or more users in the meeting mode each of the first selected topic items individually in the order of the successive selections of the first selected topic items along with at least one of an amount of budgeted time remaining or an actual time spent on discussion related to each of the first selected topic item, block 2811 (FIG. 28) of displaying the notes from the one or more users with the first topic item on the workspace user interface of each of the one or more users as the notes are received from the one or more users, and/or block 2909 (FIG. 29) of providing the report to at least one of the one or more users

In several embodiments, user device 110 can include a lists module 3004. In certain embodiments, lists module 3004 can at least partially perform block 2705 (FIG. 27) of updating at least one of the two or more lists based on the second input, block 2708 (FIG. 28) of updating the third list of the two or more lists based on the third input to reorder the second selected topic item in the third list, block 2803 (FIG. 28) of receiving from the one or more users through the workspace user interface in the planning mode a first input to reorder the plurality of topic items in the agenda list, and/or block 2804 (FIG. 28) of displaying on the workspace user interface of each of the one or more users in the planning mode the plurality of topic items in the agenda list as reordered by the first input.

In various embodiments, user device 110 can include a team module 3005. In certain embodiments, team module 3005 can at least partially perform block 2710 (FIG. 27) of receiving a fourth input of a workspace team for the workspace user interface.

In some embodiments, user device 110 can include a topic module 3006. In certain embodiments, topic module 3006 can at least partially perform block 2711 (FIG. 27) of receiving during the meeting through the workplace user interface successive selections of third selected topic items from among the plurality of topic items that are in the agenda list to activate discussion regarding the third selected topic items according to an order of the successive selections of the third selected topic items, block 2807 (FIG. 28) of receiving from one of the one or more users through the workplace user interface in the meeting mode successive selections of first selected topic items from among the plurality of topic items in the agenda list to activate discussion regarding the first selected topic items according to an order of the successive selections of the first selected topic items, and/or block 2808 (FIG. 28) of displaying on the workspace user interface of each of the one or more users in the meeting mode each of the first selected topic items individually in the order of the successive selections of the first selected topic items along with at least one of an amount of budgeted time remaining or an actual time spent on discussion related to each of the first selected topic item.

In many embodiments, user device 110 can include a navigation module 3007. In certain embodiments, navigation module 3007 can at least partially perform block 2805 (FIG. 28) of receiving from one of the one or more users a second input though the workspace user interface in the planning mode to activate the meeting mode, block 2806 (FIG. 28) of displaying on the workspace user interface of each of the one or more users in the meeting mode the plurality of topic items in the agenda list with a budgeted time for each of the plurality of topic items, and/or block 2809 (FIG. 28) of, upon receiving a third input from one of the one or more users to navigate away from the workspace user interface in the meeting mode, displaying a navigation bar that is configured to allow the one of one or more users to return to the workspace user interface in the meeting mode with a single action.

In several embodiments, user device 110 can include a notes module 3008. In certain embodiments, notes module 3008 can at least partially perform block 2810 (FIG. 28) of, while displaying at least a first topic item of the first selected topic items individually, receiving notes from the one or more users.

In a number of embodiments, user device 110 can include a tools module 3009. In certain embodiments, tools module 3009 can at least partially perform block 2812 (FIG. 28) of, while displaying a first topic item of the first selected topic items individually, receiving a fourth input from one or more users though the workspace user interface in the meeting mode to activate one or more meeting tools within the first topic item.

In various embodiments, user device 110 can include a record module 3010. In certain embodiments, record module 3010 can at least partially perform block 2902 (FIG. 29) of automatically recording first data including a join time and a leave time associated with each of the one or more users when the workspace user interface is in the meeting mode, block 2903 (FIG. 29) of automatically recording second data including a topic creation time and a topic creation user of the one or more users for each of the plurality of topic items when the workspace user interface is in either the planning mode or the meeting mode, block 2904 (FIG. 29) of automatically recording third data including an order in which the plurality of topic items were discussed when the workspace user interface is in the meeting mode, block 2905 (FIG. 29) of automatically recording fourth data including a start discussion time and a discussion timer for each of the plurality of topic items that were discussed when the workspace user interface is in the meeting mode, block 2906 (FIG. 29) of automatically recording fifth data including a note creation time, a note creation user of the one or more users, and a note topic item of the plurality of topic items for each of one or more notes created by the one or more users when the workspace user interface is in either the planning mode or the meeting mode and associated with the note topic item, and/or block 2907 (FIG. 29) of automatically recording sixth data including a meeting tool creation time, a meeting tool creation user of the one or more users, one or more meeting tool activity times, one or more meeting tool results, and a meeting tool topic item of the plurality of topic items for each of one or more meeting tools created by the one or more users and associated with the meeting tool topic item.

In some embodiments, user device 110 can include a report module 3011. In certain embodiments, report module 3011 can include the analytics module described above, and/or can at least partially perform block 2908 of generating a report and/or block 2909 of providing the report to at least one of the one or more users.

Although collaborative meeting planning, meeting management, and meeting tracking have been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-30 may be modified, and that the foregoing discussion of certain of these embodiments does not necessarily represent a complete description of all possible embodiments. For example, one or more of the procedures, processes, or activities of FIGS. 27-29 may include different procedures, processes, and/or activities and be performed by many different modules, in many different orders, and/or one or more of the procedures, processes, or activities of FIGS. 27-29 may include one or more of the procedures, processes, or activities of another different one of FIGS. 27-29.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A method for collaboratively planning a meeting, the method comprising:
providing a workspace user interface to one or more users for the meeting, the workspace user interface comprising two or more lists, the two or more lists comprising a queue and an agenda list;
receiving from the one or more users a first input though the workspace user interface to create a plurality of topic items in the two or more lists, each of the plurality of topic items comprising a topic description for a meeting topic, each of the plurality of topic items being in at least one of the two or more lists;
displaying on the workspace user interface the plurality of topic items in each of the two or more lists simultaneously;
receiving from the one or more users a second input through the workspace user interface to move a first selected topic item of the plurality of topic items from a first list of the two or more lists to a second list of the two or more lists, the first list being different from the second list; the second list being one of the queue or the agenda list;
updating at least one of the two or more lists based on the second input; and
displaying on the workspace user interface the two or more lists simultaneously as updated based on the second input.

2. The method of claim 1, wherein:
the two or more lists further comprise a past meeting list.

3. The method of claim 2, wherein:
the workspace user interface is configured to allow the one or more users to selectively toggle between displaying or hiding the past meeting list on the workspace user interface.

4. The method of claim 2, wherein:
updating the at least one of the two or more lists based on the second input comprises:
if the first list is one of the queue or the agenda list:
removing the first selected topic item from the first list; and
adding the first selected topic item to the second list; and
if the first list is the past meeting list:
copying the first selected topic item from the first list; and
adding the first selected topic item to the second list.

5. The method of claim 2, wherein:
the plurality of topic items that are in the past meeting list comprise a record of topics discussed and skipped in one or more past meetings.

6. The method of claim 1, wherein:
providing the workspace user interface to the one or more users comprises providing the workspace user interface to each of two or more users;
receiving from the one or more users the first input comprises receiving from a first user of the two or more users the first input through the workspace user interface of the first user to create the plurality of topic items in the two or more lists;
displaying on the workspace user interface the plurality of topic items in each of the two or more lists simultaneously comprises displaying on each of the workspace user interfaces of the two or more users the plurality of topic items in each of the two or more lists simultaneously based on the first input;
receiving from the one or more users the second input comprises receiving from a second user of the two or more users the second input through the workspace user interface of the second user to move the first selected topic item of the plurality of topic items from the first list of the two or more lists to the second list of the two or more lists;
displaying on the workspace user interface the two or more lists simultaneously as updated based on the second input comprises displaying on each of the workspace user interfaces of the two or more users the two or more lists simultaneously as updated based on the second input; and
the second user is one of the same as the first user or different from the first user.

7. The method of claim 1, wherein:
communication between the two or more users is provided through a central server in data communication with devices for the two or more users; and
the workspace user interfaces for the two or more users run on the devices.

8. The method of claim 1 further comprising:
receiving from the one or more users a third input through the workspace user interface to reorder a second selected topic item of the plurality of topic items in a third list of the two or more lists, the third list being one of the queue or the agenda list;
updating the third list of the two or more lists based on the third input to reorder the second selected topic item in the third list; and
displaying on the workspace user interface the two or more lists simultaneously with the third list as updated based on the third input.

9. The method of claim 8, wherein:
providing the workspace user interface to the one or more users comprises providing the workspace user interface to each of two or more users;
receiving from the one or more users the third input comprises receiving from a first user of the two or more users the third input through the workspace user interface to reorder the second selected topic item of the plurality of topic items in the third list of the two or more lists;
displaying on the workspace user interface the two or more lists simultaneously with the third list as updated based on the third input comprises:
if the third list is the agenda list:
displaying on each of the workspace user interfaces of the two or more users the two or more lists simultaneously with the third list as updated based on the third input.
if the third list is the queue:
displaying only on the workspace user interface of the first user of the two or more users the two or more lists simultaneously with the third list as updated based on the third input.

10. The method of claim 9, wherein:
the workspace user interface of a workspace owner is configured to receive information from the workspace user interfaces of each of the two or more users regarding an ordering of topics on the queue on the workspace user interface of each of the two or more users.

11. The method of claim 8, wherein:
the first input to create the plurality of topic items comprises, for each of the plurality of topic items, a click or gesture to add a new topic and the topic description;
the second input to move the first selected topic item comprises a drag of the first selected topic item from the first list to the second list; and
the third input to reorder the second selected topic item comprises a drag of the second selected topic item within the third list.

12. The method of claim 1 further comprising:
receiving fourth input of a workspace team for the workspace user interface, the workspace team comprising the one or more users.

13. The method of claim 1, wherein:
one or more of the plurality of topic items each further comprise a designated presenter and a designated time budget; and
the first input to create the plurality of topic items comprises, for each of the one or more of the plurality of topics, the designated presenter and the designated time budget.

14. The method of claim 1, wherein:
the workspace user interface is configured to display a start time for each of the plurality of topic items that are in the agenda list.

15. The method of claim 1, wherein:
the workspace user interface is configured to be used in planning the meeting prior to the meeting, in conducting the meeting during the meeting, and in reviewing the meeting after the meeting;
the method of claim 1 further comprises receiving during the meeting through the workplace user interface successive selections of third selected topic items from among the plurality of topic items that are in the agenda list to activate discussion regarding the third selected topic items according to an order of the successive selections of the third selected topic items;
the workspace user interface is configured to allow the order of the successive selections of the third selected topic items to be different from a list order of the agenda list;
the workspace user interface is configured to allow a fourth selected topic item in the queue to be moved to the agenda list during the meeting; and
the workspace user interface is configured to allow the fourth selected topic item to be selected from among the third selected topic items to activate discussion regarding the fourth selected topic item during the meeting.

16. The method of claim 15, wherein:
during the meeting, each of the third selected topic items comprise at least one of a record of time budgeted, an amount of budgeted time remaining, or an actual time spent on discussion related to the third selected topic item.

17. A system for collaboratively planning a meeting, the system comprising:
one or more processing modules; and
one or more non-transitory memory storage modules storing computing instructions configured to run on the one or more processing modules and perform the acts of:
providing a workspace user interface to one or more users for the meeting, the workspace user interface comprising two or more lists, the two or more lists comprising a queue and an agenda list;
receiving from the one or more users a first input though the workspace user interface to create a plurality of topic items in the two or more lists, each of the plurality of topic items comprising a topic description for a meeting topic, each of the plurality of topic items being in at least one of the two or more lists;
displaying on the workspace user interface the plurality of topic items in each of the two or more lists simultaneously;
receiving from the one or more users a second input through the workspace user interface to move a first selected topic item of the plurality of topic items from a first list of the two or more lists to a second list of the two or more lists, the first list being different from the second list; the second list being one of the queue or the agenda list;
updating at least one of the two or more lists based on the second input; and
displaying on the workspace user interface the two or more lists simultaneously as updated based on the second input.

18. The system of claim 1, wherein:
the two or more lists further comprise a past meeting list.

19. The system of claim 18, wherein:
the workspace user interface is configured to allow the one or more users to selectively toggle between displaying or hiding the past meeting list on the workspace user interface.

20. The system of claim 18, wherein:
updating the at least one of the two or more lists based on the second input comprises:
if the first list is one of the queue or the agenda list:
removing the first selected topic item from the first list; and
adding the first selected topic item to the second list; and
if the first list is the past meeting list:
copying the first selected topic item from the first list; and
adding the first selected topic item to the second list.

21. The system of claim 18, wherein:
the plurality of topic items that are in the past meeting list comprise a record of topics discussed and skipped in one or more past meetings.

22. The system of claim 17, wherein:
providing the workspace user interface to the one or more users comprises providing the workspace user interface to each of two or more users;
receiving from the one or more users the first input comprises receiving from a first user of the two or more users the first input through the workspace user interface of the first user to create the plurality of topic items in the two or more lists;
displaying on the workspace user interface the plurality of topic items in each of the two or more lists simultaneously comprises displaying on each of the workspace user interfaces of the two or more users the plurality of topic items in each of the two or more lists simultaneously based on the first input;
receiving from the one or more users the second input comprises receiving from a second user of the two or more users the second input through the workspace user interface of the second user to move the first selected topic item of the plurality of topic items from the first list of the two or more lists to the second list of the two or more lists;
displaying on the workspace user interface the two or more lists simultaneously as updated based on the second input comprises displaying on each of the workspace user interfaces of the two or more users the two or more lists simultaneously as updated based on the second input; and
the second user is one of the same as the first user or different from the first user.

23. The system of claim 17, wherein:
communication between the two or more users is provided through a central server in data communication with devices for the two or more users;
the workspace user interfaces for the two or more users run on the devices; and
the devices comprise the one or more processing modules and the one or more non-transitory memory storage modules.

24. The system of claim 17, wherein the computing instructions are further configured to perform the acts of:
receiving from the one or more users a third input through the workspace user interface to reorder a second selected topic item of the plurality of topic items in a third list of the two or more lists, the third list being one of the queue or the agenda list;
updating the third list of the two or more lists based on the third input to reorder the second selected topic item in the third list; and
displaying on the workspace user interface the two or more lists simultaneously with the third list as updated based on the third input.

25. The system of claim 24, wherein:
providing the workspace user interface to the one or more users comprises providing the workspace user interface to each of two or more users;
receiving from the one or more users the third input comprises receiving from a first user of the two or more users the third input through the workspace user interface to reorder the second selected topic item of the plurality of topic items in the third list of the two or more lists;
displaying on the workspace user interface the two or more lists simultaneously with the third list as updated based on the third input comprises:
if the third list is the agenda list:
displaying on each of the workspace user interfaces of the two or more users the two or more lists simultaneously with the third list as updated based on the third input.
if the third list is the queue:
displaying only on the workspace user interface of the first user of the two or more users the two or more lists simultaneously with the third list as updated based on the third input.

26. The system of claim 25, wherein:
the workspace user interface of a workspace owner is configured to receive information from the workspace user interfaces of each of the two or more users regarding an ordering of topics on the queue on the workspace user interface of each of the two or more users.

27. The system of claim 24, wherein:
the first input to create the plurality of topic items comprises, for each of the plurality of topic items, a click or gesture to add a new topic and the topic description;
the second input to move the first selected topic item comprises a drag of the first selected topic item from the first list to the second list; and
the third input to reorder the second selected topic item comprises a drag of the second selected topic item within the third list.

28. The system of claim 17, wherein the computing instructions are further configured to perform the act of:
receiving fourth input of a workspace team for the workspace user interface, the workspace team comprising the one or more users.

29. The system of claim 17, wherein:
one or more of the plurality of topic items each further comprise a designated presenter and a designated time budget; and
the first input to create the plurality of topic items comprises, for each of the one or more of the plurality of topics, the designated presenter and the designated time budget.

30. The system of claim 17, wherein:
the workspace user interface is configured to display a start time for each of the plurality of topic items that are in the agenda list.

31. The system of claim 17, wherein:
the workspace user interface is configured to be used in planning the meeting prior to the meeting, in conducting the meeting during the meeting, and in reviewing the meeting after the meeting;
the computing instructions are further configured to perform the act of receiving during the meeting through the workplace user interface successive selections of third selected topic items from among the plurality of topic items that are in the agenda list to activate discussion regarding the third selected topic items according to an order of the successive selections of the third selected topic items;
the workspace user interface is configured to allow the order of the successive selections of the third selected topic items to be different from a list order of the agenda list;
the workspace user interface is configured to allow a fourth selected topic item in the queue to be moved to the agenda list during the meeting; and
the workspace user interface is configured to allow the fourth selected topic item to be selected from among the third selected topic items to activate discussion regarding the fourth selected topic item during the meeting.

32. The system of claim 31, wherein:
during the meeting, each of the third selected topic items comprise at least one of a record of time budgeted, budgeted time remaining, or an actual time spent on discussion related to the third selected topic item.
